(19) United States
(12) Patent Application Publication
(10) Pub. No.: US 2025/0198192 A1
(43) Pub. Date: Jun. 19, 2025

(54) DOOR LATCH ASSEMBLY WITH ALIGNMENT ADJUSTABILITY AND SEAL ARRANGEMENTS

(71) Applicant: Larson Manufacturing Company of South Dakota, LLC, Brookings, SD (US)

(72) Inventors: Bryan P. Zacher, Brookings, SD (US); Scott Eis, Holgate, OH (US); Michael W. Kondratuk, Brookings, SD (US); William S. Losik, Toledo, OH (US); Alan M. Dixon, Arlington, SD (US)

(21) Appl. No.: 18/293,153

(22) PCT Filed: Jul. 26, 2022
(86) PCT No.: PCT/US2022/038359

§ 371 Date: Jan. 29, 2024

Related U.S. Application Data
(60) Provisional application No. 63/235,547, filed on Aug. 20, 2021.
(60) Provisional application No. 63/231,937, filed on Aug. 11, 2021.
(60) Provisional application No. 63/227,817, filed on Jul. 30, 2021.

(51) Int. Cl. E05B 9/08

(52) U.S. Cl. CPC E05B 9/08

(57) ABSTRACT

An improvement in the form of an adjustment that can be advantageously utilized during the installation process of co-mounted doors or single doors that can improve alignment at a stage from which alignment can be set for operation henceforth. For a single door, such an adjustment can be utilized for final alignment of a single handle assembly component parts based upon door opening, or other installation specifications. Also, the present invention provides sealing arrangements that provide effective seals to accommodate the latch tongues of the latch assemblies of co-mounted doors as a door opens and closes so as not to cause unwanted interaction that can wear a seal over time, as well as sealing arrangements to work effectively in situations such as at the hinge assemblies of co-mounted doors where there can be obstruction with the hinge-side door stop surface of a door jamb. In another aspect, security features increase the strength and security of a closed door in an opposite rotational direction from the rotational direction for opening.

### CROSS REFERENCE TO RELATED APPLICATIONS

This application claims priority to and the benefit of U.S. Provisional Patent Application No. 63/227,817, filed Jul. 30, 2021; U.S. Provisional Patent Application No. 63/231,937, filed Aug. 11, 2021; and U.S. Provisional Patent Application No. 63/235,547, filed Aug. 20, 2021, the entire contents of which are incorporated herein by reference in their entireties.

### FIELD OF THE INVENTION

The present invention also relates generally to door latch assemblies including adjustability for alignment of the latch assembly as mounted to a door. The present invention has applicability for adjustability as applied to any single mounted door as well as applied to co-mounted doors for alignment of handleset assemblies to one another.

The present invention also relates generally to weatherstrip seals as arranged for providing an effective air/water seal between at least one door and a door jamb. The present invention has applicability for sealing arrangements as applied to a single mounted door as well as applied to co-mounted doors.

The present invention also relates generally to door assemblies having a swinging door and including security features against the application of a force in the rotational direction of the door closing while the door is closed.

### BACKGROUND

Doors may conventionally be mounted in a doorway of a building, one example of which is a conventional exterior door that may be combined with a conventional secondary door, such as storm door, a screen door, or a security door. Also more recently, a two-door assembly (such as an exterior door and a storm door) can be co-mounted to and within a single door frame of a commercial or residential building. Some such co-mounted doors include handle assemblies configured to be coupled together, e.g., magnetically coupled together via attractive magnetic fields established by magnets carried by each handle assembly, such that the field-coupled handle assemblies operate together as a single handle assembly for both doors.

Such co-mounted doors have been developed and include two doors, such as a prime door and a secondary door like a storm door, that can open and close together as well as independently from one another. In order for two doors to be opened together, mechanisms on both doors are provided that need to be in alignment with one another. Specifically, when one door is moved into close proximity to the other door, interlocking mechanisms on both doors come into contact with one another to secure the doors together. As with any assembly of multiple components, manufacturing tolerances can build or stack up during assembly leading to misalignment issues. Such misalignment may prevent the door/doors from working properly and consistently over time.

Also, with single conventional mounted doors, other issues with installment of a door can lead to misalignment of a latch assembly relative to the door for proper installation and operation of the door.

Providing an arrangement of weatherstrip seals between a door and a door jamb to provide an effective air/water seal around the door is done in many ways with the purpose of better energy efficiencies of a door assembly and long-term integrity of the building structure. Typically, a flexible seal is provided along latch and hinge side edges of the door as well as along the top. Such a seal can comprise continuous lengths of a flexible weatherstrip material as mounted to stop surfaces provided by the jamb around the door opening. The bottom of the door is typically sealed with another type of weatherstrip.

Moreover, co-mounted doors require complex hinge assemblies to accommodate the movement of both doors independently or together as well as an arrangement of strike plates and latch assemblies that allow for both doors to move in the same rotational direction. Such co-mounted door assemblies can provide features that affect the ability to provide an effective and long-lasting seal arrangement along the door stop surfaces.

### SUMMARY

In the case of co-mounted doors, it is understood that alignment of interacting parts of the handlesets or leversets will allow better interlocking of an external and internal door so as to be openable and closeable together in a reliable manner. Certain components are provided with surfaces or other features that facilitate alignment of components once such components are brought into close proximity with one another. Such component alignment also relies on the installation of the co-mounted doors so that the interacting parts of each handle assembly properly align with one another to make an effective interconnection.

In one aspect, the present invention provides an improvement in the form of an adjustment that can be advantageously utilized during the installation process of co-mounted doors or single doors that can improve alignment at a stage from which alignment can be set for operation henceforth. For a single door, such an adjustment can be utilized for final alignment of a single handle assembly component parts based upon door opening, or other installation specifications. For example, a door bore can be off-position or can be in one of multiple specified positions. The adjustments and mechanisms for doing so can accommodate such differences as specified or not. The present invention is applicable to either door or both doors of a co-mounted door system, or to any single door assembly that can include conventional door handles or levers on both sides of a single door.

In another aspect, the present invention provides various embodiments of seal arrangements for creating effective and durable air/water seals including along portions of door latch-side and hinge-side door stop surfaces that are partially obstructed by features of the door assembly. Co-mounted doors can provide certain such obstructions by the manner of install of strike plates, latch assemblies, and hinge assemblies. Moreover, co-mounted doors uniquely can move independently or together is a same rotation direction for opening and closing and such movements can cause unwanted interactions with door assembly components and seal arrangements. The present invention provides sealing arrangements that provide effective seals to accommodate the latch tongues of the latch assemblies of co-mounted doors as a door opens and closes so as not to cause unwanted interaction that can wear a seal over time, as well as sealing arrangements to work effectively in situations such as at the hinge assemblies of co-mounted doors where there can be obstruction with the hinge-side door stop surface of a door jamb.

In yet another aspect, closures that can be conventionally mounted as a single inswing or outswing rotational direction door or as one inswing door of a pair of co-mounted pair of doors, security against an opening of a door in rotational closing direction from the application of a closing force when the door is closed can be an issue. Security features described are intended to increase the strength and security of a closed door in an opposite rotational direction from the rotational direction for opening. In particular, with an inswing door, structural features of the present invention are designed to withstand an outward force in the outswing direction of the door to prevent the inswing door from being significantly damaged or failing from the application of a force in the outswing rotational direction. Such an outswing force may be applied from the inside of the subject inswing door as pushing force or from the outside of the door as a pulling force. A rotationally inswing door means a door that opens about a set of hinges with the hinges mounted to the inside frame portion of a door frame, such that the door or pair of doors swings toward the interior of any building. Likewise, these security features can provide an outswing door with greater ability to withstand an inward force when the door is closed.

### BRIEF DESCRIPTION OF THE DRAWINGS

This disclosure is illustrated by way of example and not by way of limitation in the accompanying Figures. Where considered appropriate, reference labels have been repeated among the Figures to indicate corresponding or analogous elements.

FIG. 1A is a top plan view of an embodiment of a door assembly including a pair of opposing doors that share a common hinge assembly, with the doors shown interlocked and with each in a closed position relative to a door frame.

FIG. 1B is a magnified view of the portion 1B of the door assembly illustrated in FIG. 1A.

FIG. 2A is a top plan view of an embodiment of the hinge assembly illustrated in FIGS. 1A and 1B.

FIG. 2B is a perspective view of the hinge assembly illustrated in FIG. 2A.

FIG. 3A is a top plan view of the door assembly illustrated in FIG. 1A shown with the doors decoupled from each other and with one of the doors in a closed position relative to the door frame and the other door in a partially open position relative to the door frame.

FIG. 3B is a magnified view of the portion 3B of the door assembly illustrated in FIG. 3A.

FIG. 4A is a top plan view of the door assembly illustrated in FIGS. 1A and 3A shown with the doors interlocked and with both in a partially open position relative to the door frame.

FIG. 4B is a magnified view of the portion 4B of the door assembly illustrated in FIG. 4A.

FIG. 5 is an exploded view of an embodiment of a door handle arrangement mounted to the door assembly illustrated in FIGS. 1A, 1B, 3A, 3B, 4A and 4B.

FIG. 6A is a front elevational view of one of the door handle assemblies of the door handle arrangement illustrated in FIG. 5, shown mounted to one of the doors as viewed on a face that opposes the other door.

FIG. 6B is a front elevational view of the other of the door handle assemblies of the door handle arrangement illustrated in FIG. 5, shown mounted to the other door as viewed on a face that opposes the one door.

FIG. 7A is a side elevational view of the two doors of the door assembly of FIGS. 1A, 1B, 3A, 3B, 4A, 4B, 5, 6A and 6B shown with the two door handle assemblies decoupled and moving toward each other.

FIG. 7B is a side elevational view similar to FIG. 7A showing the two door handle assemblies interlocked.

FIG. 8 is a cross-sectional view of the two interlocked door handle assemblies as viewed along section lines 8-8 of FIG. 1A.

FIG. 9A is a perspective view of the door handle assembly illustrated in FIG. 6B shown in a position in which it may be interlocked with the door handle assembly illustrated in FIG. 6A.

FIG. 9B is a perspective view of the door handle assembly of FIG. 9A shown moved to a position in which it may be decoupled from the door handle assembly illustrated in FIG. 6A.

FIG. 9C is a side elevational view of the door handle assembly illustrated in FIG. 9B.

FIG. 10 is a top plan view of another embodiment of a door assembly including a pair of opposing doors that share a common hinge assembly, with the doors shown interlocked and with each in a closed position relative to a door frame.

FIG. 11 is a perspective view of an embodiment of the hinge assembly illustrated in FIG. 10.

FIG. 12 is a perspective view of a portion of the door frame of FIG. 10 to which an embodiment of a latch plate is mounted.

FIG. 13 is a perspective view of the door frame illustrated in FIGS. 10 and 12 with three of the hinge assemblies illustrated in FIG. 11 mounted thereto but with no doors mounted thereto.

FIG. 14A is a cross-sectional view of the door frame of FIG. 13 as viewed along section lines 14B-14B, shown with a corresponding one of the doors illustrated in FIG. 10 mounted thereto in a partially open position relative to the door frame.

FIG. 14B is a magnified view of the portion 14B of the door frame and door shown in FIG. 14A illustrating an embodiment of an adjustable sweep carried by the door.

FIG. 14C is a magnified perspective view of a portion of the door frame and door illustrated in FIGS. 14A and 14B, illustrating an exploded view of additional components of the adjustable sweep.

FIG. 14D is a perspective view of the door frame and door shown in FIGS. 14A-14C illustrating an assembled view of the components shown in exploded view in FIG. 14C.

FIG. 15 is an exploded view of an embodiment of a door handle arrangement mounted to the door assembly illustrated in FIGS. 10-14D.

FIG. 16A is a perspective view of an embodiment of one of the door handle assemblies of the door handle arrangement illustrated in FIGS. 10 and 15.

FIG. 16B is a cross-sectional view of the door handle assembly illustrated in FIG. 16A as viewed along section lines 16B-16B.

FIG. 17A is a perspective view of an embodiment of the other of the door handle assemblies of the door handle arrangement illustrated in FIGS. 10 and 15.

FIG. 17B is a cross-sectional view of the door handle assembly illustrated in FIG. 17A as viewed along section lines 17B-17B.

FIG. 17C is a cross-sectional view similar to that of FIG. 17B and illustrating of a portion of the magnet assembly of the door handle assembly illustrated in FIGS. 17A and 17B.

FIG. 17D is a front elevational view of a back side of the magnet assembly of the door handle assembly illustrated in FIGS. 17A-17C.

FIG. 18A is a view of the two doors of the door assembly of FIGS. 10-17D from a perspective of one of the doors and shown with the two door handle assemblies decoupled.

FIG. 18B is another view of the two doors of the door assembly of FIG. 18A from a perspective of the other of the doors.

FIG. 19 is a cross-sectional view of the two door handle assemblies of FIGS. 18A and 18B interlocked as viewed along section lines 19-19 of FIG. 10.

FIG. 20A is a perspective view of the two doors of the door assembly of FIGS. 10-18B shown with the two door handle assemblies interlocked and illustrating how the two doors may be opened and closed via actuation of either door handle assembly.

FIG. 20B is an elevational view similar to FIG. 17D illustrating operation of the magnet assembly of the door handle assembly of FIGS. 17A-17C during opening and closing of the two doors as shown in FIG. 20A.

FIG. 21A is a perspective view of the two doors of the door assembly of FIGS. 10-20B shown with the two door handle assemblies interlocked and illustrating how the two door handle assemblies are decoupled via actuation of one of the door handle assemblies.

FIG. 21B is a perspective view similar to FIG. 21A shown with the two door handle assemblies decoupled via actuation of one of the door handle assemblies.

FIG. 22A is an elevational view of the door handle assembly of FIGS. 17A-17D illustrating positioning of the interior handle for opening of a corresponding one of the doors.

FIG. 22B is an elevational view similar to FIG. 22A illustrating opening of the door via actuation of the door handle assembly of FIGS. 17A-17D.

FIG. 23 is an exploded perspective view of a handle assembly in accordance with an adjustment aspect of the present invention including a latch assembly with an outer housing and a latch case that are adjustable to one another for alignment of the latch assembly to the door.

FIG. 24 is an exploded perspective view of the latch assembly of FIG. 23 showing the latch case separated from the outer housing and a latch plate for mounting the outer housing to a door.

FIG. 25 is a perspective view of the latch assembly of FIG. 24 with the latch case partially inserted within the outer housing along an adjustment direction.

FIG. 26 is a side view of the latch assembly of FIG. 25 in the partially inserted position.

FIG. 27 is a side view similar to FIG. 26 but with the latch case fully inserted within the outer housing and showing an amount of adjustability of the latch case to the outer housing based on the elongate dimension of openings of the outer housing.

FIG. 28 is a perspective view of another embodiment of a latch assembly as comprising a latch case and an outer housing with the outer housing providing an internal channel, but with less structure of the outer housing.

FIG. 29 is a partial traverse cross-sectional view of handle assemblies that are interconnected as co-mounted doors and with weatherstrip seal arrangements to provide an effective air/water seal along a latch side of a door assembly and showing an interaction of a latch tongue of one door latch assembly with one side of a portion of a seal with both doors partially positioned away from a latch-side stop surface.

FIG. 30 is a partial traverse cross sectional view similar to FIG. 29 but with both doors spaced to a greater distance from the latch-side stop surface and with a latch tongue of one latch assembly positioned on another side of the seal.

FIG. 31 is a partial traverse cross sectional view of a seal arrangement on the latch-side of a door assembly with the cross section taken in the region of plural separate strike plates that are spaced from one another and showing engagement of one door with the seal with the doors both in closed positions.

FIG. 32 is a partial traverse cross sectional view also at the latch-side of a door assembly but different from FIG. 31 in that the cross section is taken at a location spaced higher or lower than the strike plate region.

FIG. 33 is a partial traverse cross sectional view of a second seal arrangement on the latch-side of a door assembly with the cross section taken similarly to FIG. 31 and with doors in similar positions.

FIG. 34 is a partial traverse cross sectional view of another seal arrangement on the latch-side of a door assembly with the cross section taken similarly to FIG. 31 and with doors in similar positions.

FIG. 35 is a partial traverse cross sectional view also at the latch-side of a door assembly but like FIG. 32 in that the cross section is taken at a location spaced higher or lower than the strike plate region.

FIG. 36 is a partial traverse cross sectional view of yet another seal arrangement on the latch-side of a door assembly with the cross section taken similarly to FIG. 31 and with doors in similar positions.

FIG. 37 is a partial traverse cross sectional view of yet another seal arrangement on the latch-side of a door assembly with the cross section taken similarly to FIG. 31 and with doors in similar positions.

FIG. 38 is a partial traverse cross sectional view of a seal arrangement on a hinge side of a door assembly with the cross section taken in the region of a hinge assembly as such is provided to allow rotational movement of plural doors in the same rotational direction but with both doors in closed positions.

FIG. 39 is a partial traverse cross sectional view also at the hinge-side of a door assembly but different from FIG. 38 in that the cross section is taken at a location other than at a hinge assembly region.

FIG. 40 is a perspective view of the seal arrangement and interaction with a hinge assembly as in FIG. 38.

FIG. 41 is a perspective view similar to FIG. 40 but with a hinge plate rotated toward a seal along a hinge-side stop surface.

FIG. 42 is a perspective view similar to FIG. 41 but with a hinge plate rotated further to move a portion of a seal along a hinge-side stop surface.

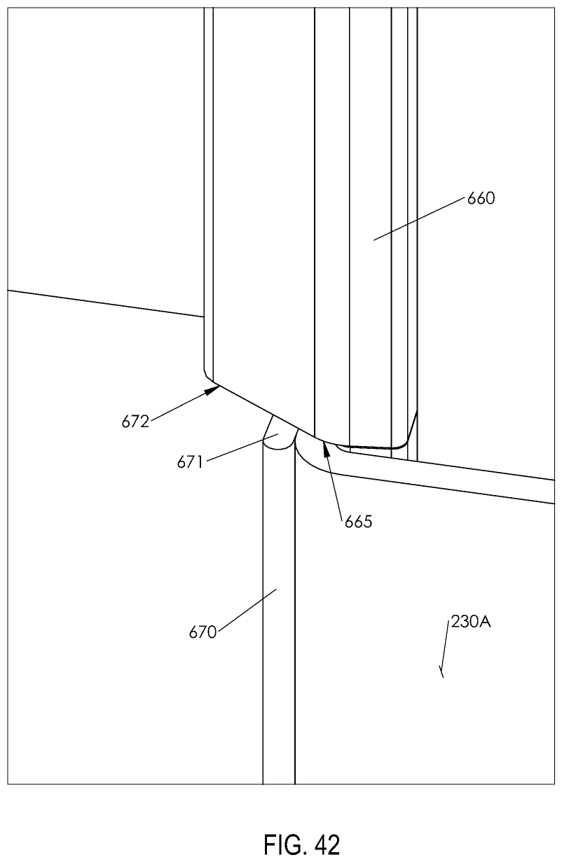

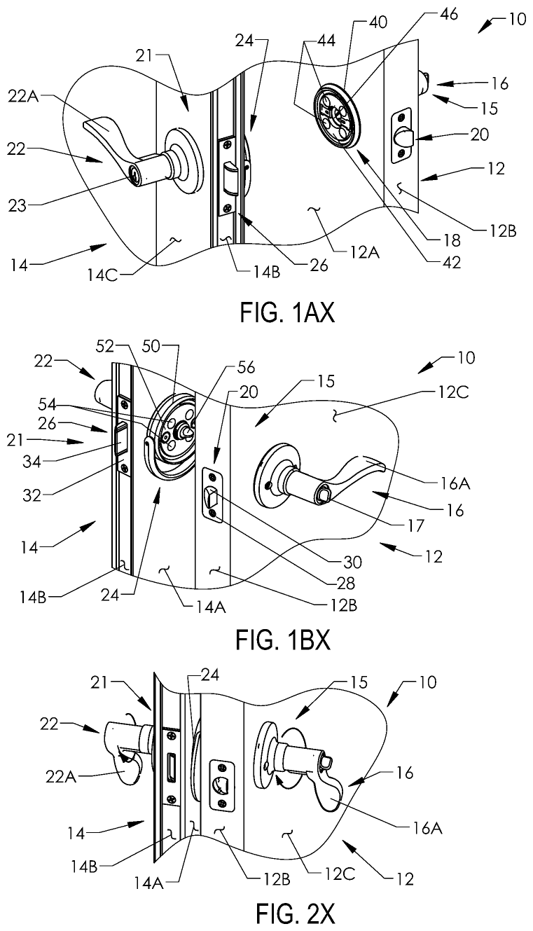

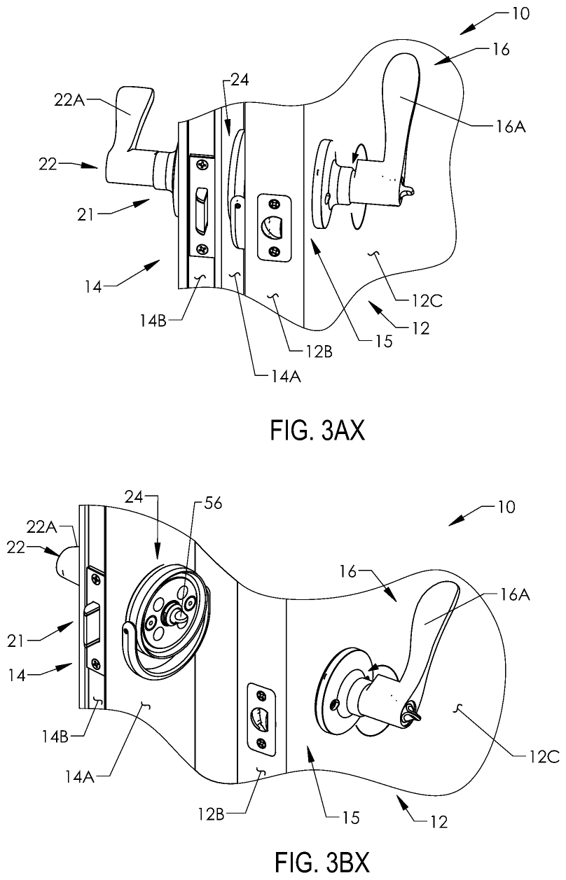

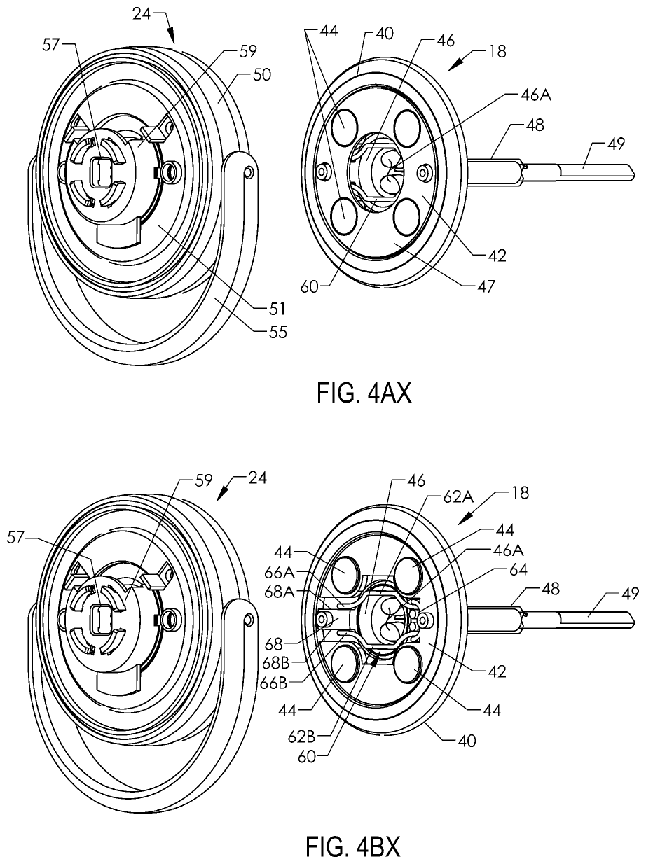

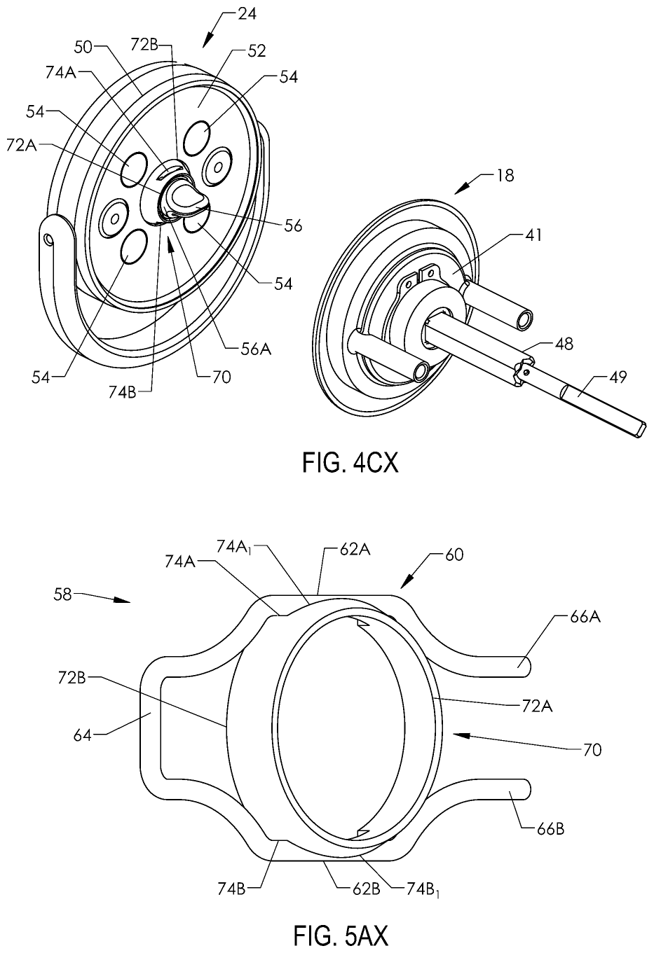

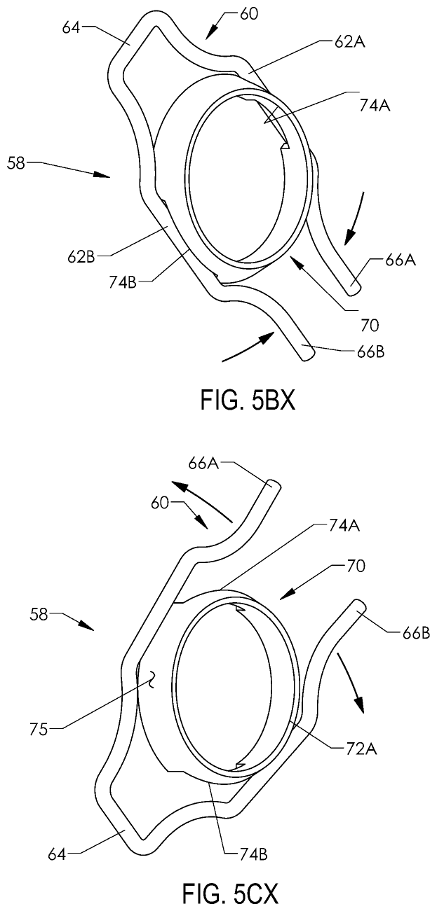

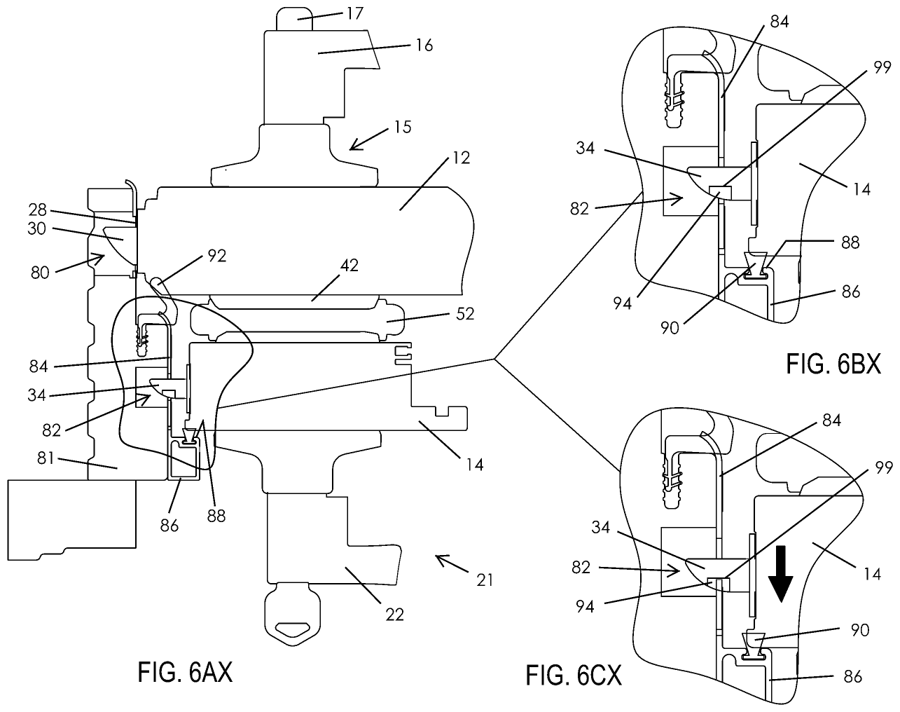

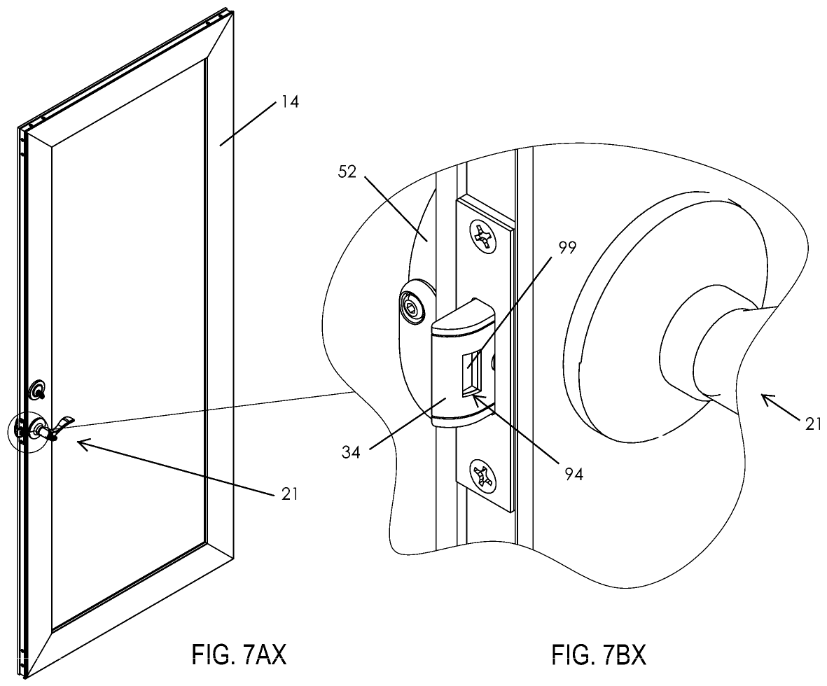

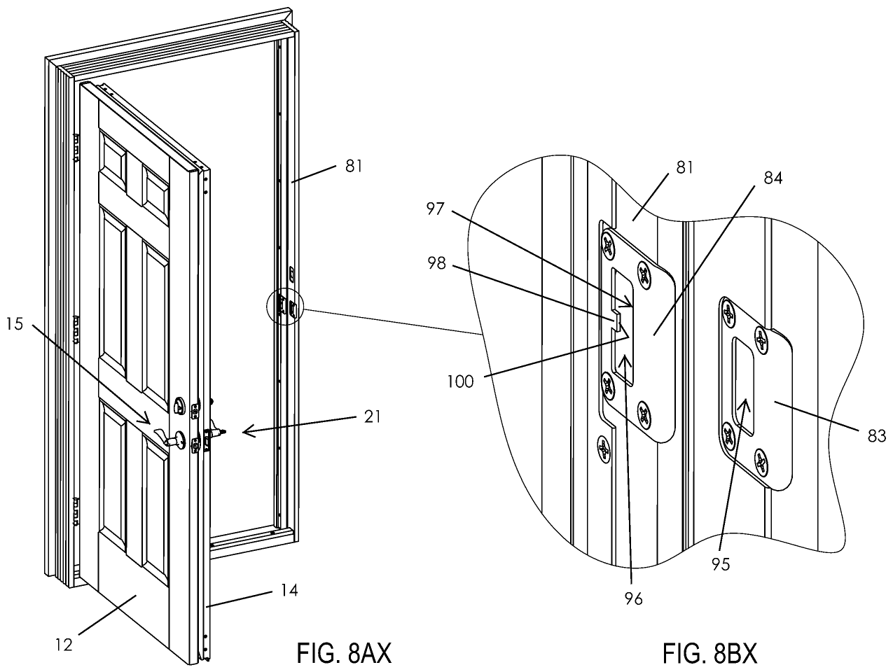

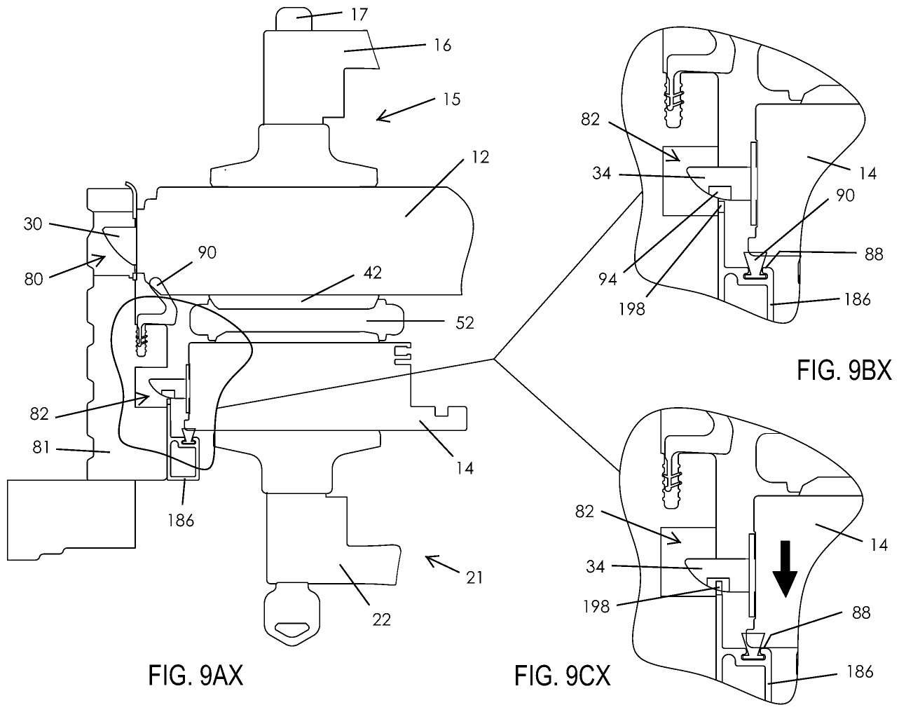

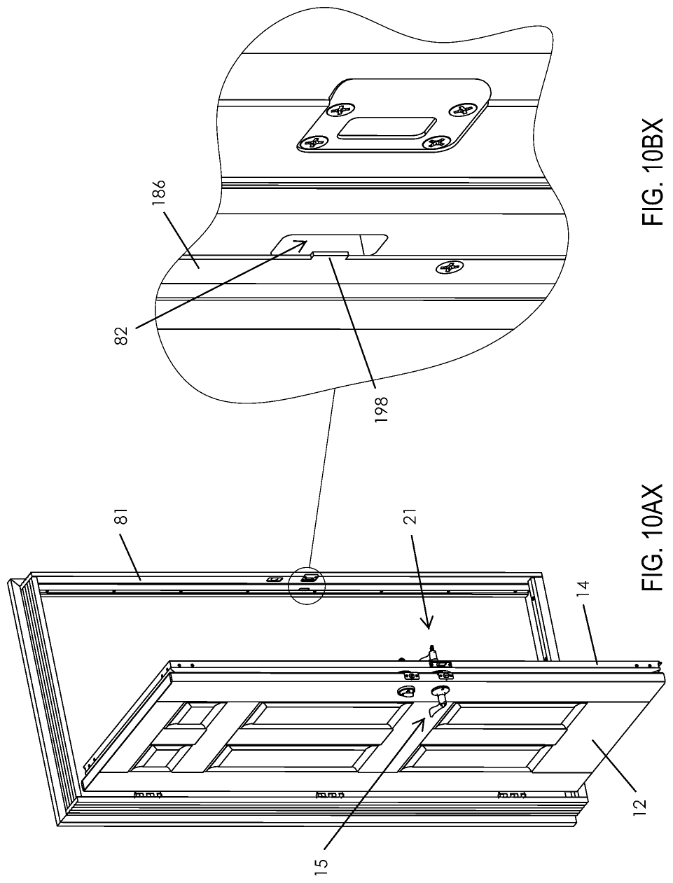

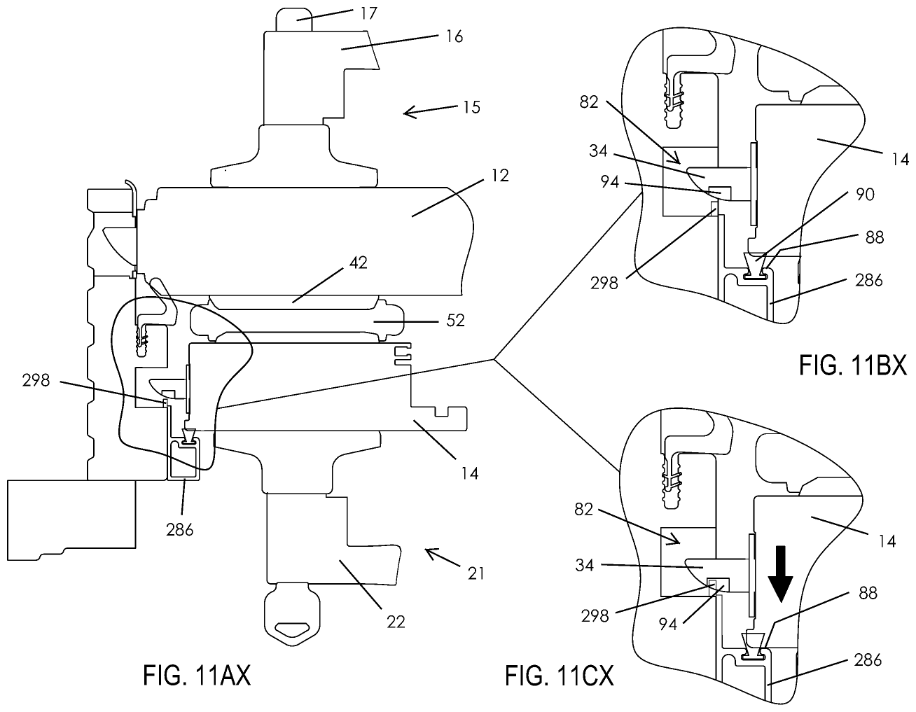

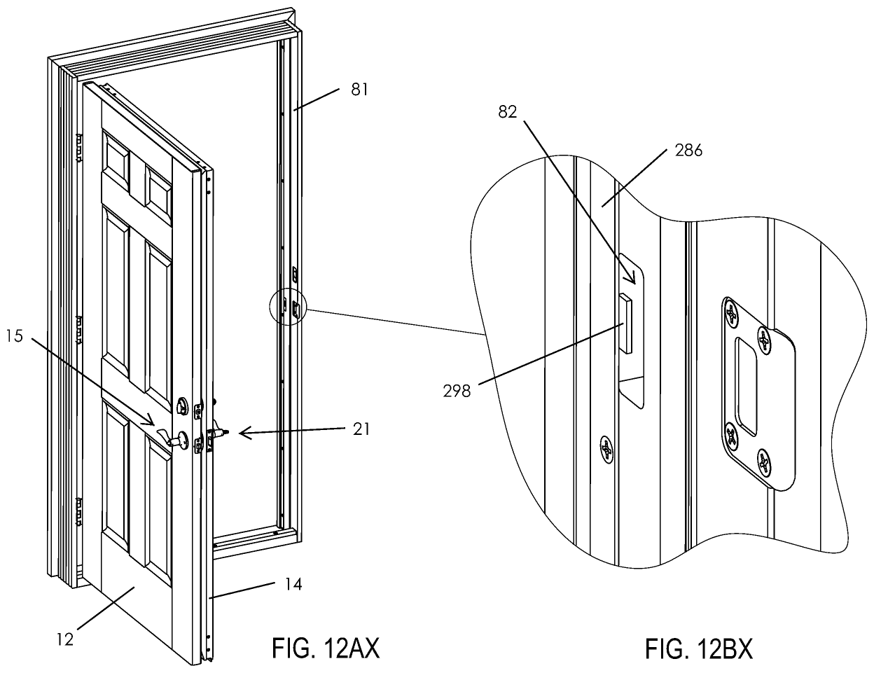

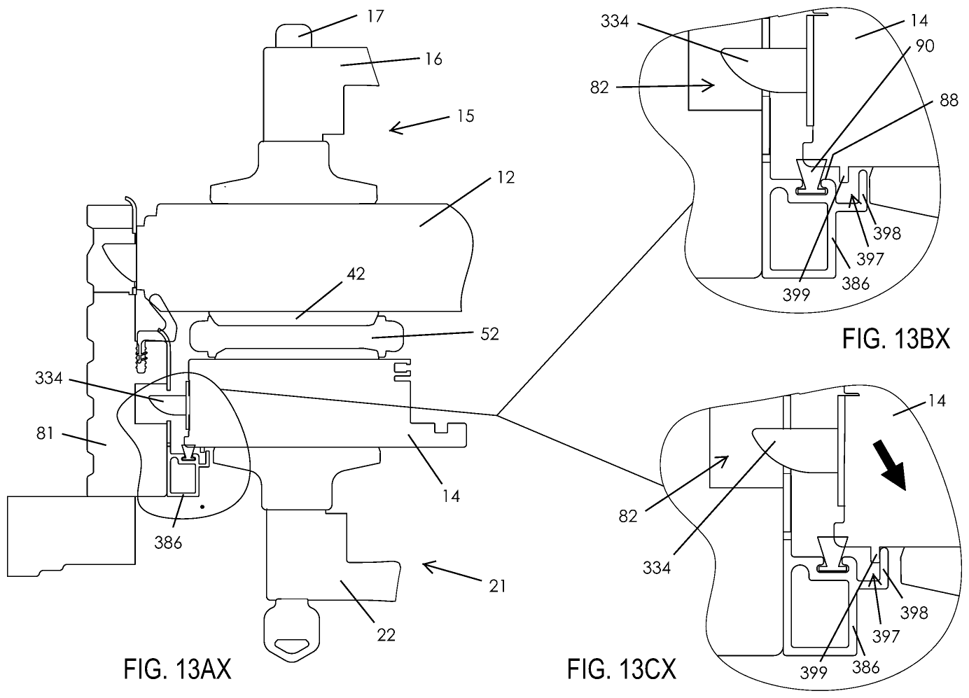

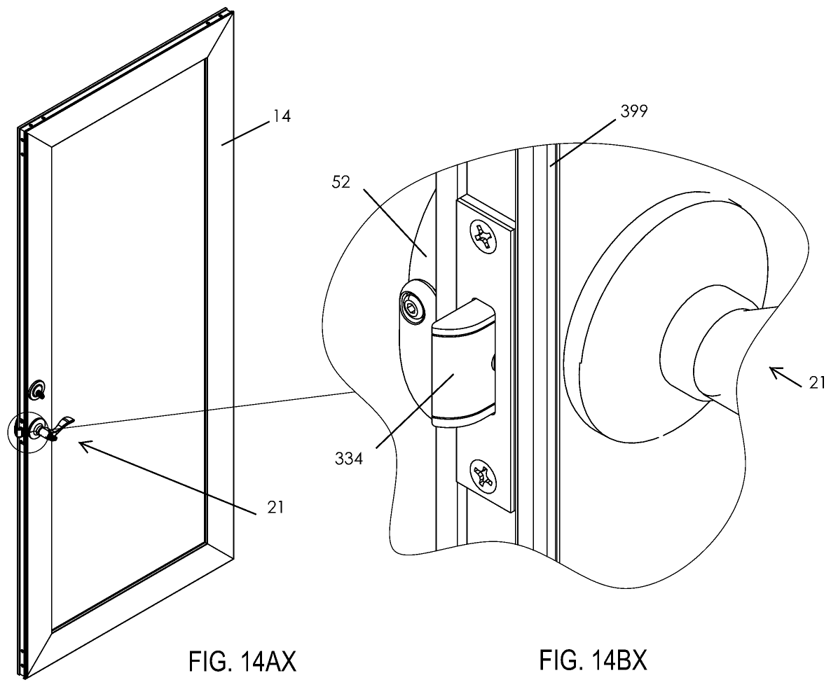

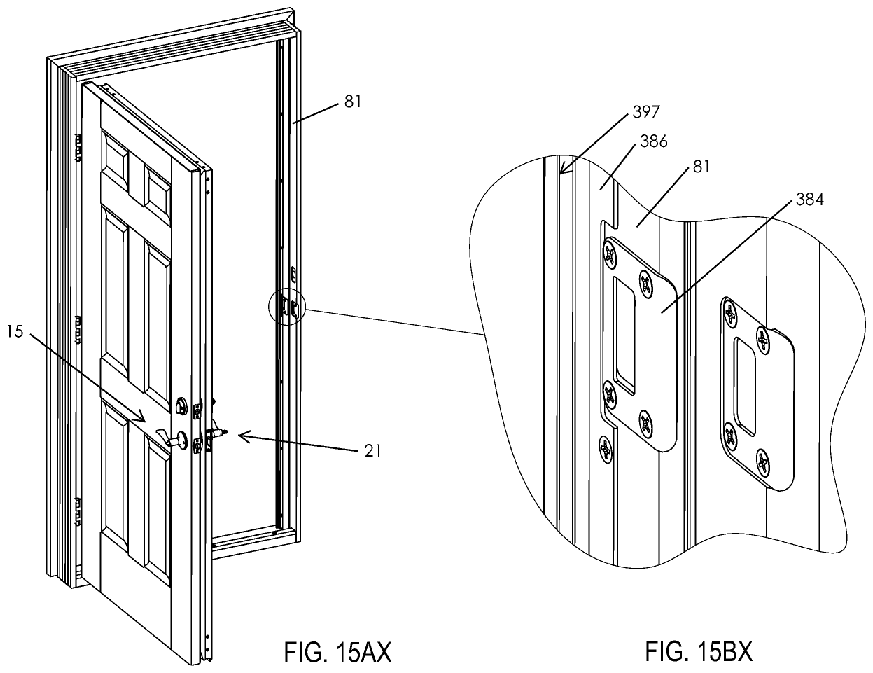

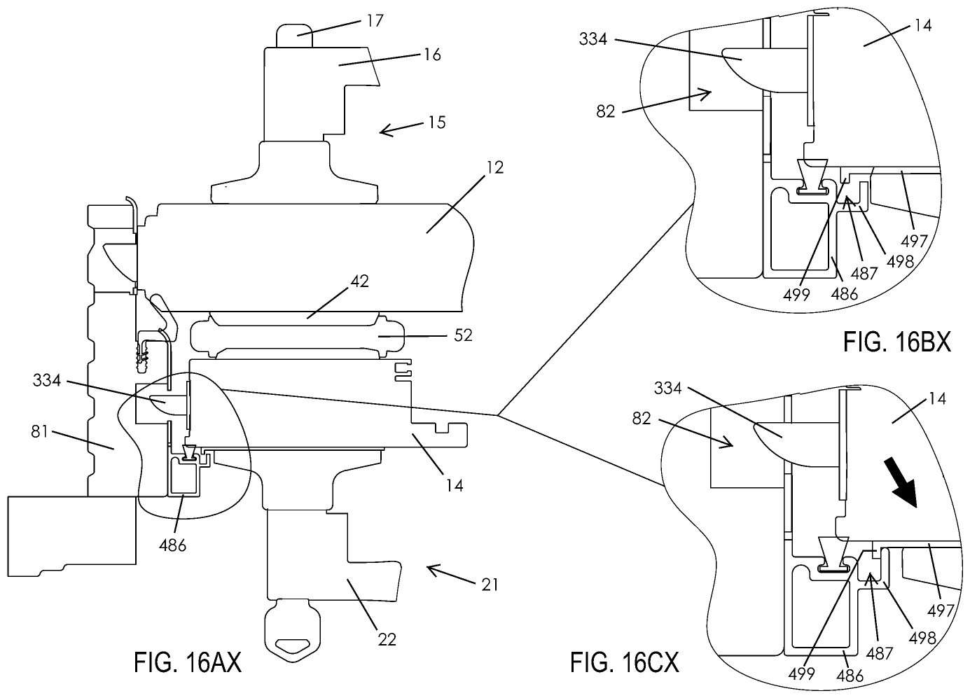

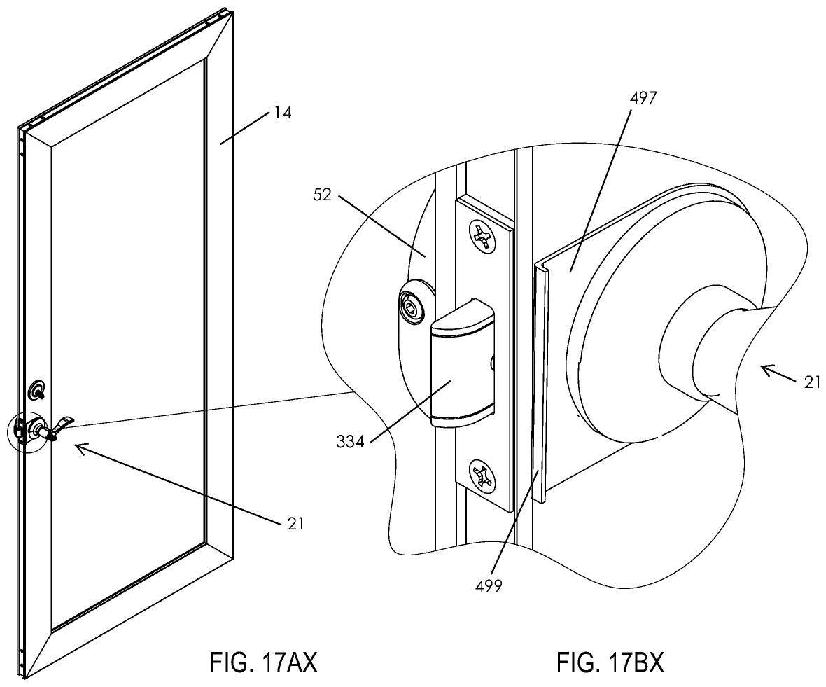

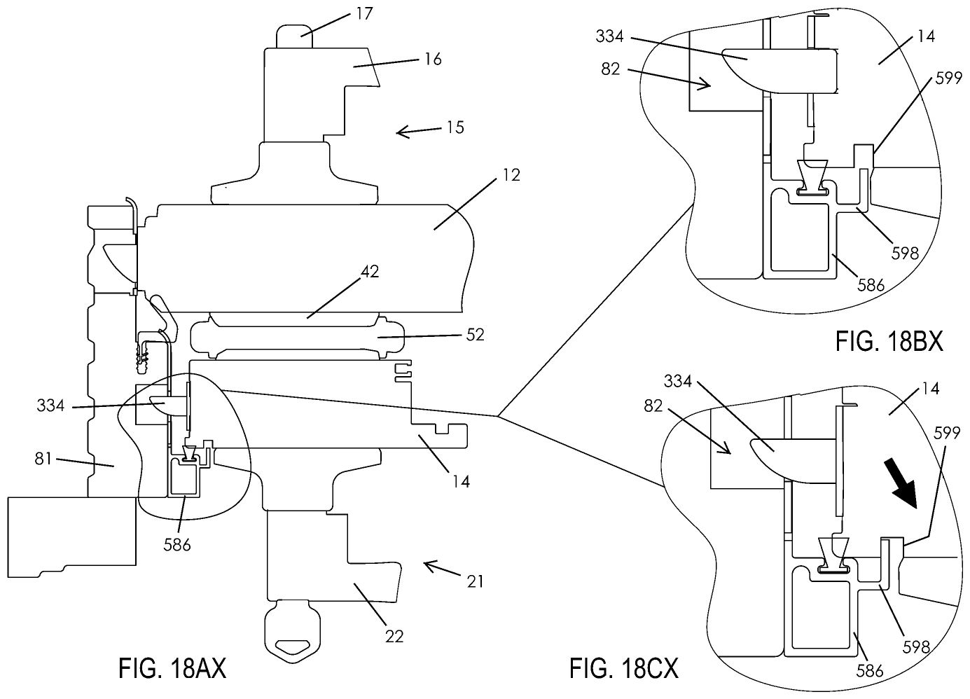

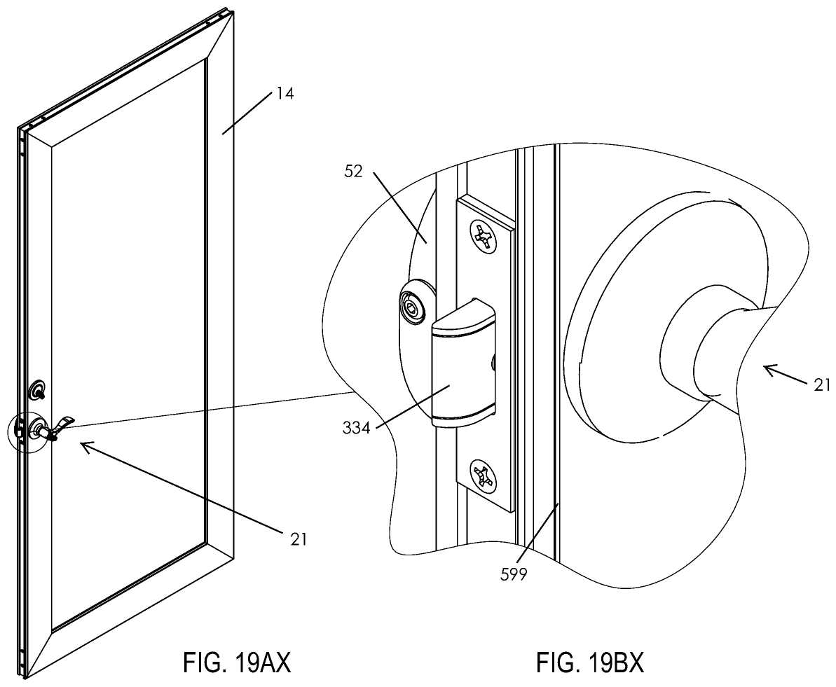

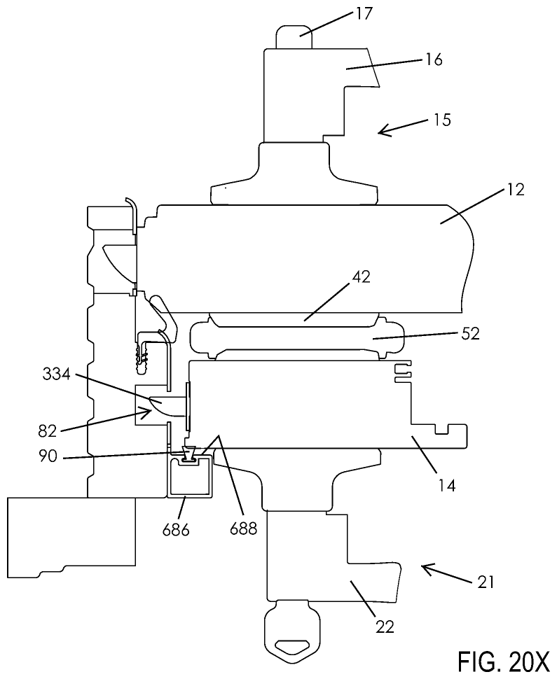

The following brief descriptions of the drawings are directed to an invention of the subject disclosure that is different than the inventions related to the drawings previously set out with brief descriptions. It is understood that similar Fig. numbers and numbers directed to the specific elements of the drawings may include Fig. numbers and element specific numbers that are the same as used in the following description of the subject invention and in the drawings referred to within this Brief Description of the Drawings section. This section as follows and the related detailed description of the following invention below refer to the specific drawings following FIG. 42 in this application as filed and as discussed briefly just above. For clarity, an X is added to the figure numbers of these drawings.

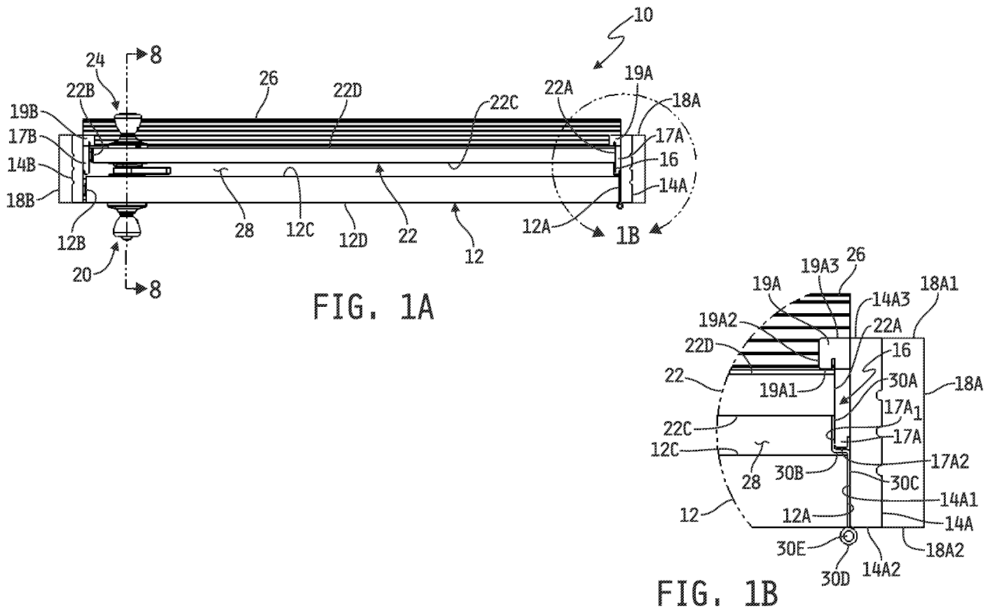

FIG. 1AX is a perspective view of two co-mounted doors each including a handle assembly to be linked or coupled to the other, shown from a perspective of an outer side of one of the doors and with the handle assemblies decoupled from one another.

FIG. 1BX is another perspective view of the co-mounted doors of FIG. 1AX shown from a perspective of an outer side of the other door and with the handle assemblies decoupled from one another.

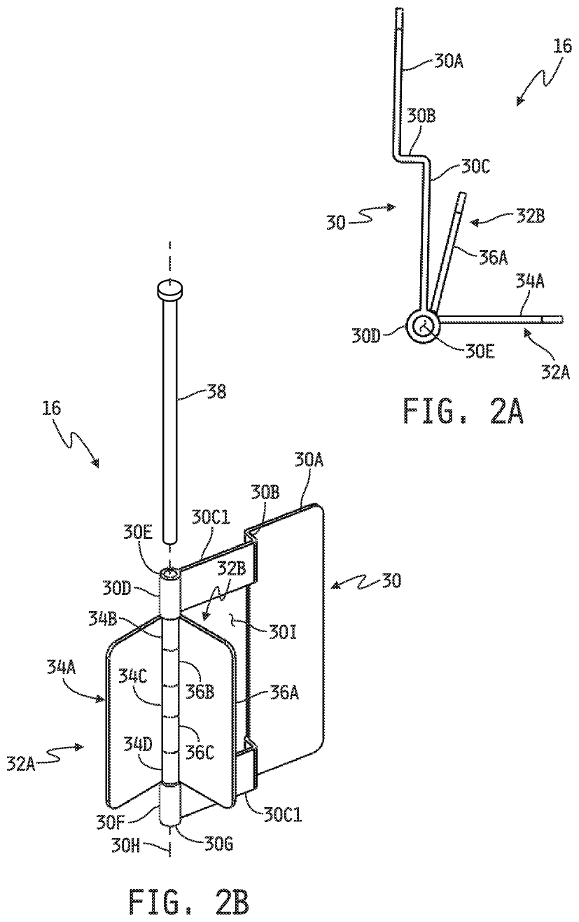

FIG. 2X is a perspective view similar to FIG. 1BX shown with the two handle assemblies coupled to one another and illustrating simultaneous retraction of the latch tongues of each in response to rotational actuation of either outer door handle so that the two doors may be together opened or closed.

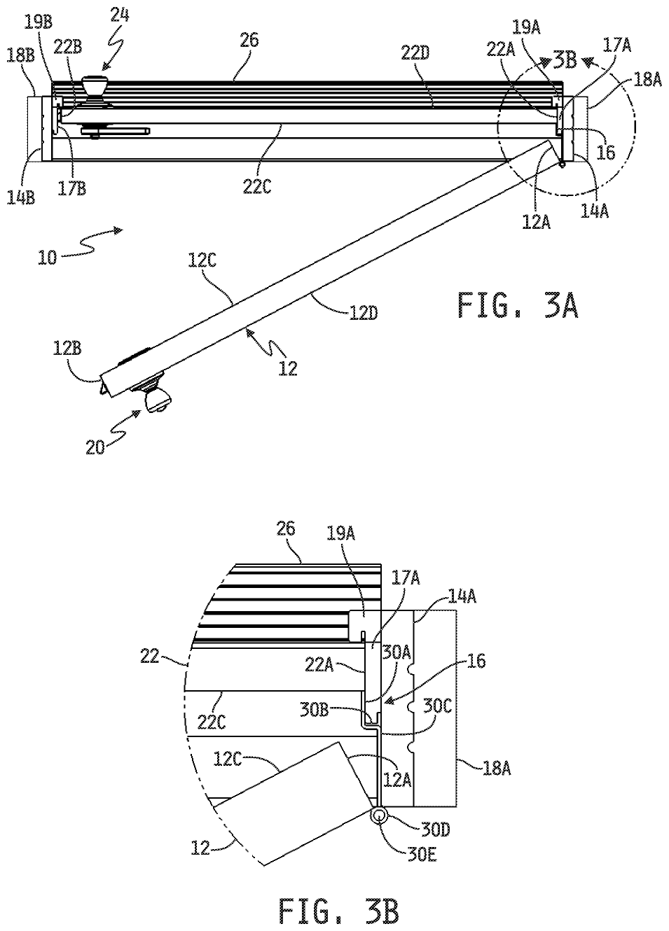

FIG. 3AX is a perspective view similar to FIG. 2X shown with the two handle assemblies coupled to one another and illustrating decoupling of the handle assemblies via actuation of one of the door handles.

FIG. 3BX is a perspective view similar to FIG. 3AX shown with the handle assemblies decoupled from one another as a result of the actuation of the door handle illustrated in FIG. 3A.

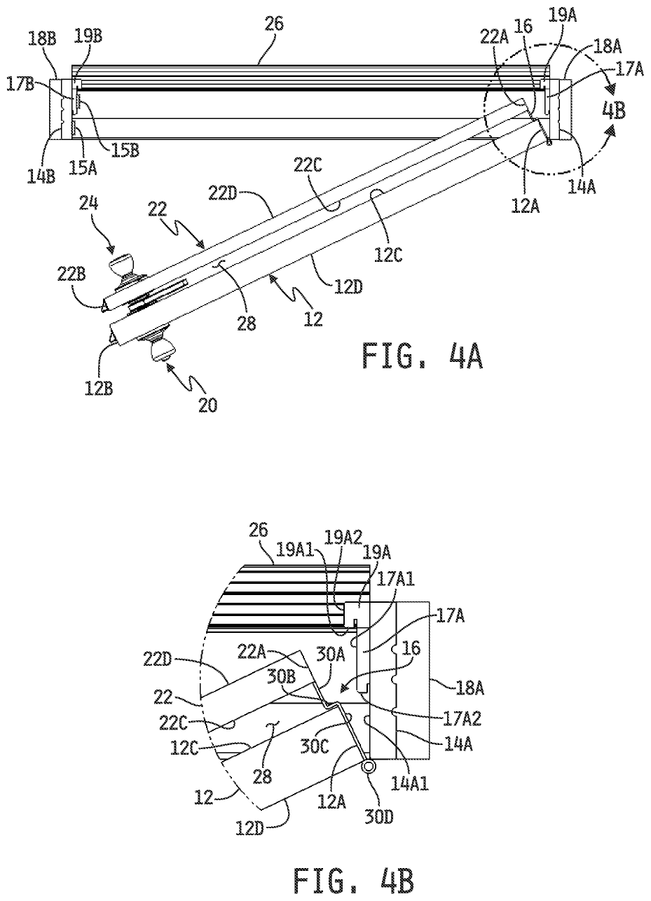

FIG. 4AX is a perspective view of magnet assemblies of the two handle assemblies illustrated in FIGS. 1AX-3BX, shown from a perspective similar to FIG. 1AX and illustrating one component of the retention assembly mounted over the lock receiver pocket of one of the magnet assemblies.

FIG. 4BX is a perspective view similar to FIG. 4AX but with the magnet assembly face plate removed to illustrate mounting of the one component of the retention assembly to the magnet assembly over the lock receiver pocket.

FIG. 4CX is a perspective view of the magnet assemblies of the two handle assemblies illustrated in FIGS. 1AX-3BX, shown from a perspective similar to FIG. 1BX and illustrating another component of the retention assembly mounted over the lock protrusion of the other magnet assembly.

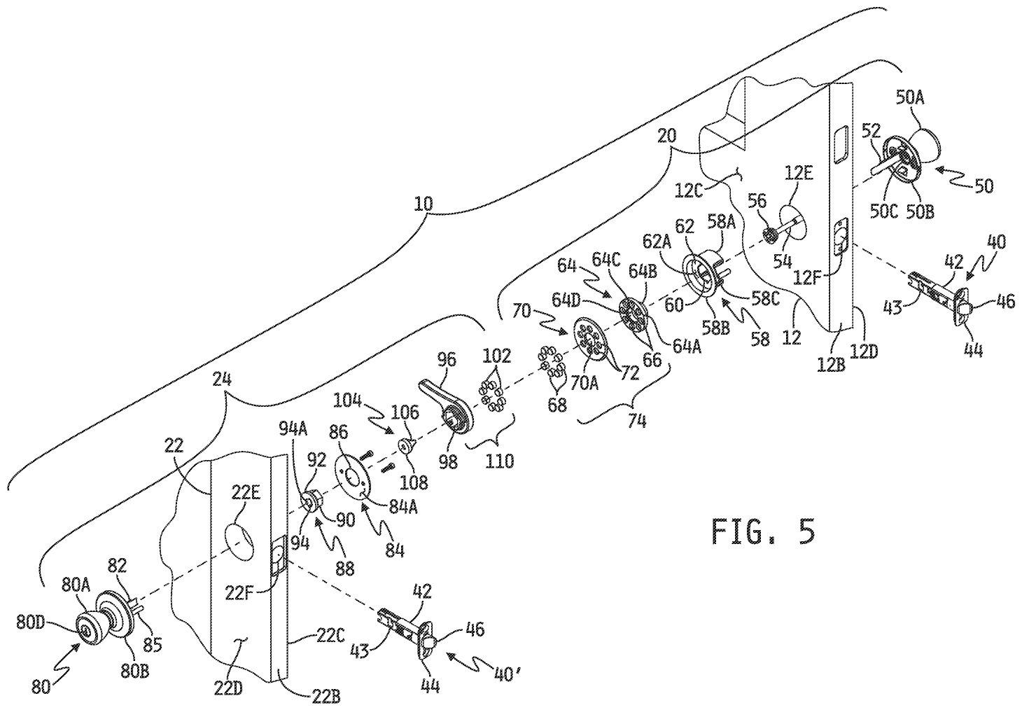

FIG. 5AX is a perspective view of the retention assembly illustrated in parts in FIGS. 4AX-4CX, shown with the two components engaged with and secured to one another resulting from insertion of the lock protrusion of the magnet assembly on the left side of FIG. 4CX into the lock receiver pocket of the magnet assembly on the right sides of FIGS. 4AX and 4BX upon field-coupling the respective door handle assemblies to one another as illustrated in FIG. 2X.

FIG. 5BX is another perspective view of the retention assembly of FIG. 5AX illustrating bias of the two legs of one of the components toward one another to maintain engagement of that component with the other component of the retention assembly.

FIG. 5CX is yet another perspective view of the retention assembly of FIGS. 5AX and 5BX illustrating disengagement of the two components via relative rotation therebetween.

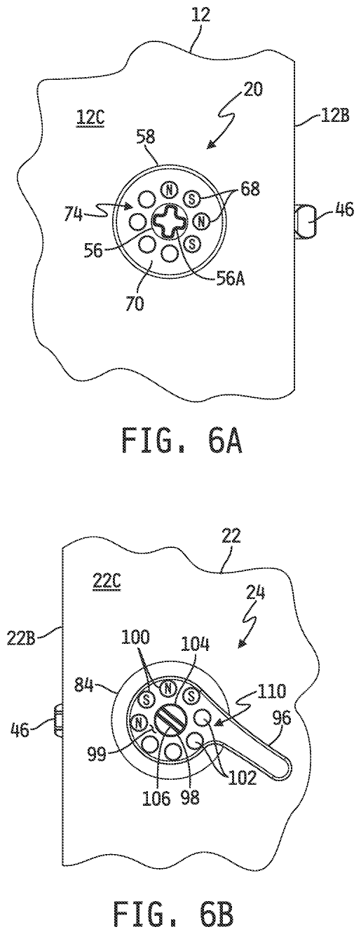

FIG. 6AX is a schematic cross-sectional view of a security feature of the present invention including an interaction between a latch tongue or bolt and the door frame by way of a strike plate, which interaction enhances door integrity when subject to a force in an outward direction.

FIG. 6BX is an enlarged portion of the view of FIG. 6AX showing the latch tongue as having a notch that is arranged facing a tab of the strike plate.

FIG. 6CX is an enlarged view similar to FIG. 6BX with the latch tongue notch moved to a position at least partially engaged with the tab of the strike plate.

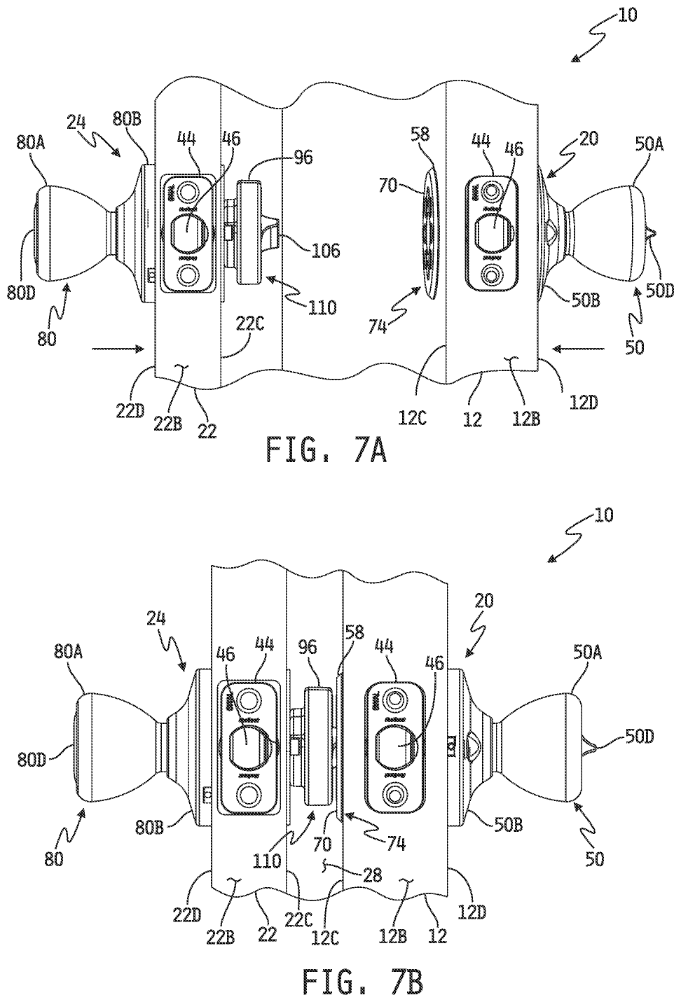

FIG. 7AX is a perspective view of a door showing a latch assembly on one side of the door.

FIG. 7BX is an enlarged portion of the view of FIG. 7AX showing the latch tongue with a notch.

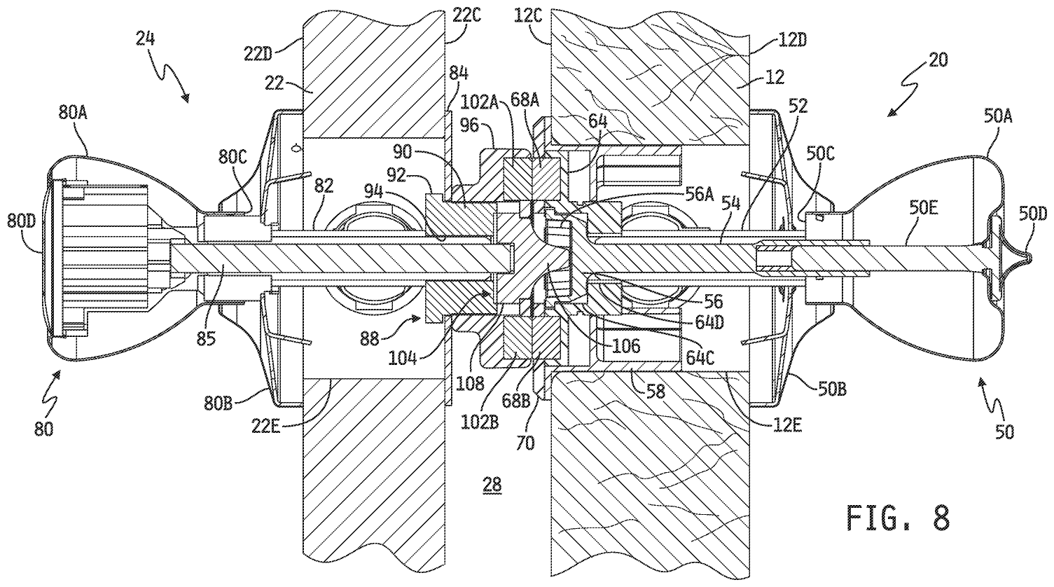

FIG. 8AX is a perspective view of co-mounted doors both opened as coupled together from a hinge assembly side of the co-mounted doors.

FIG. 8BX is an enlarged portion of the view of FIG. 8AX showing two strike plates with the strike plate for the outer door having a tab as part of a security feature of the present invention.

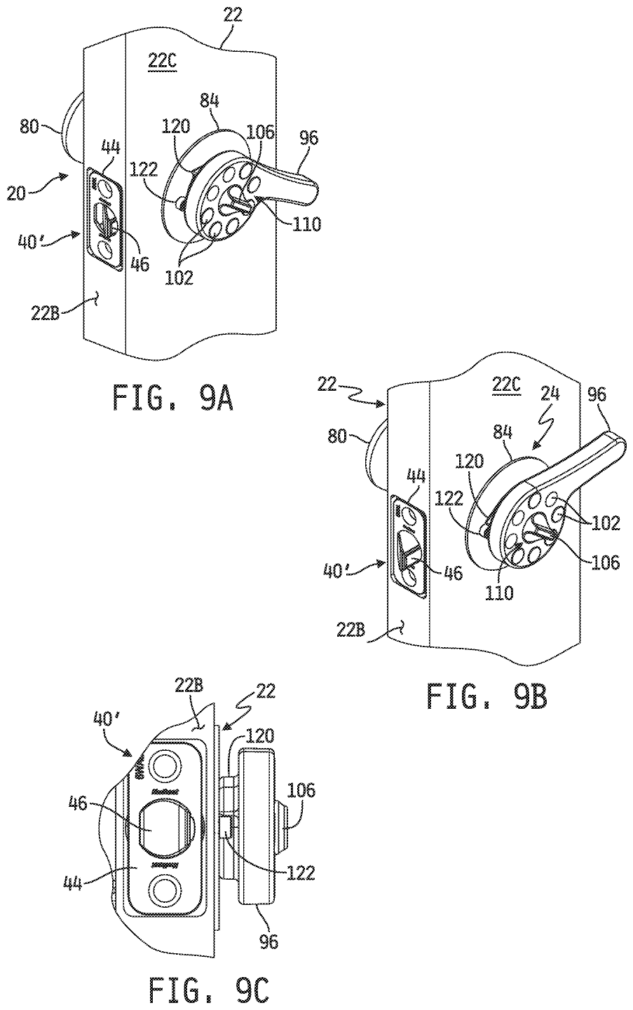

FIG. 9AX is a schematic cross-sectional view of a security feature of the present invention including an interaction between a latch tongue or bolt and the door frame by way of a structural rail member, which interaction enhances door integrity when subject to a force in an outward direction.

FIG. 9BX is an enlarged portion of the view of FIG. 9AX showing the latch tongue as having a notch that is arranged facing a tab of the structural rail member.

FIG. 9CX is an enlarged view similar to FIG. 9BX with the latch tongue notch moved to a position at least partially engaged with the tab of the structural rail member.

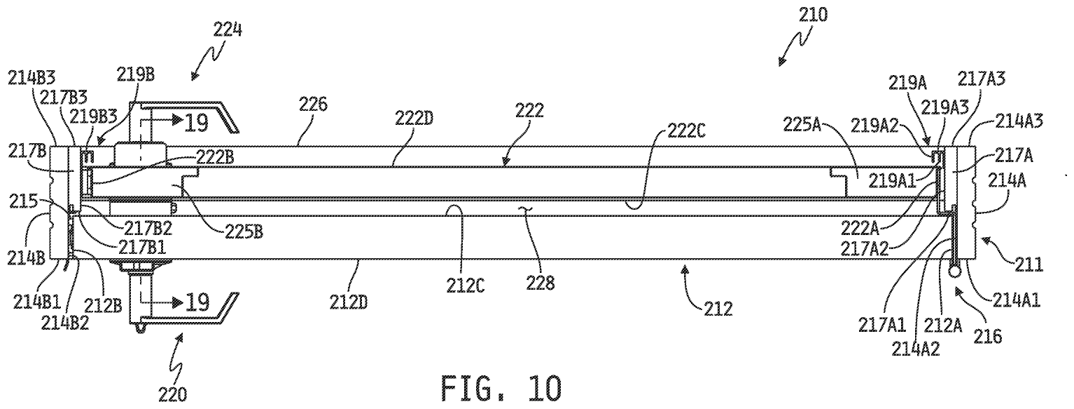

FIG. 10AX is a perspective view of co-mounted doors both opened as coupled together from a hinge assembly side of the co-mounted doors.

FIG. 10BX is an enlarged portion of the view of FIG. 10AX showing the structural rail member as mounted to the door frame and having a tab as part of a security feature of the present invention.

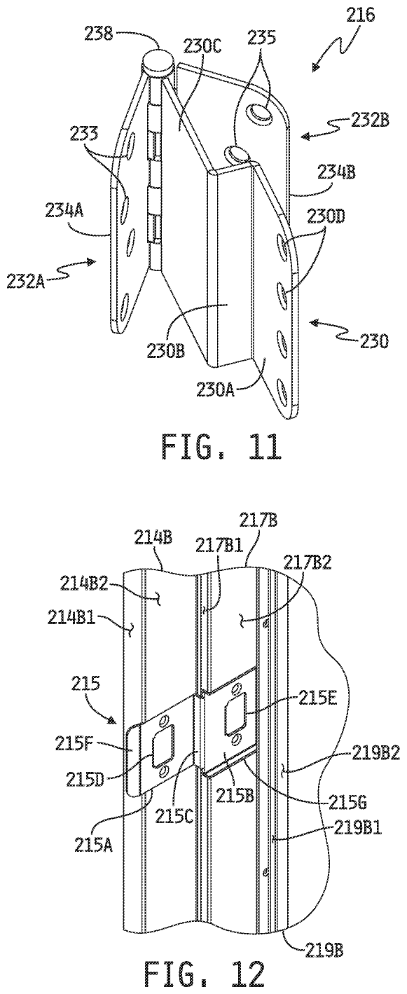

FIG. 11AX is a schematic cross-sectional view of a security feature of the present invention including an interaction between a latch tongue or bolt and the door frame by way of a separately provided tab element, which interaction enhances door integrity when subject to a force in an outward direction.

FIG. 11BX is an enlarged portion of the view of FIG. 11AX showing the latch tongue as having a notch that is arranged facing the tab.

FIG. 11CX is an enlarged view similar to FIG. 11BX with the latch tongue notch moved to a position at least partially engaged with the tab.

FIG. 12AX is a perspective view of co-mounted doors both opened as coupled together from a hinge assembly side of the co-mounted doors.

FIG. 12BX is an enlarged portion of the view of FIG. 12AX showing the tab element as mounted to the door frame as part of a security feature of the present invention.

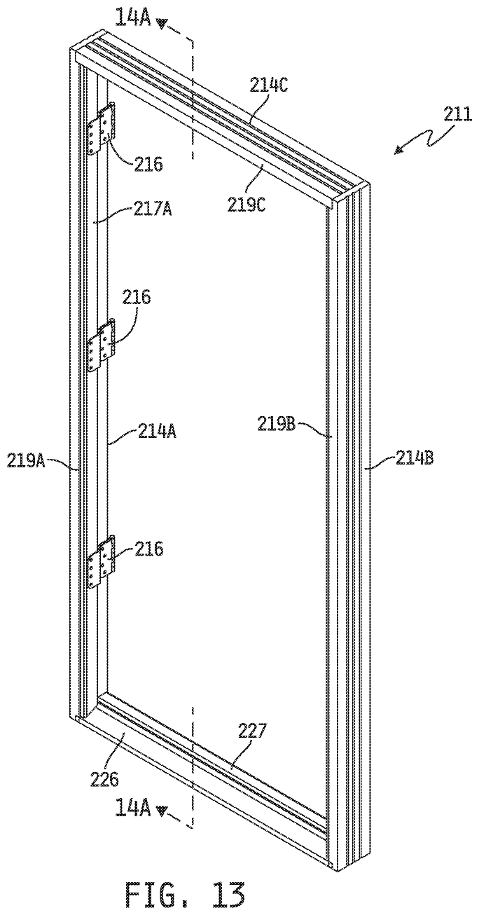

FIG. 13AX is a schematic cross-sectional view of a security feature of the present invention including an interaction between a door portion and the door frame by way of a structural rail member, which interaction enhances door integrity when subject to a force in an outward direction.

FIG. 13BX is an enlarged portion of the view of FIG. 13AX showing the door as having a rib extending at least partially along a surface of the door facing a channel of the structural rail member.

FIG. 13CX is an enlarged view similar to FIG. 13BX with the rib moved to a position at least partially engaged with a portion of the channel.

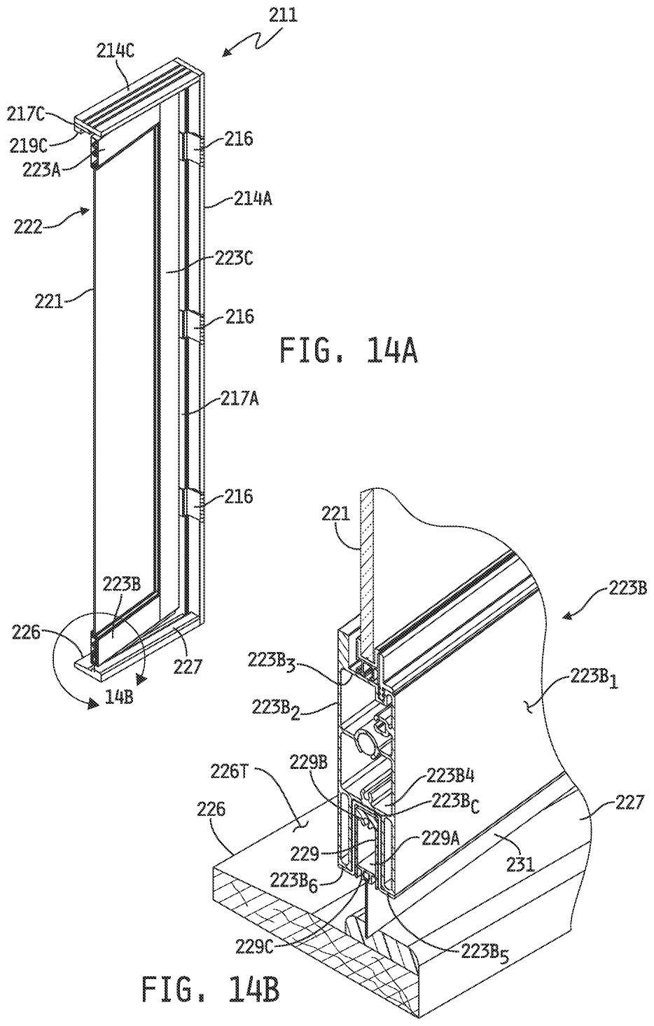

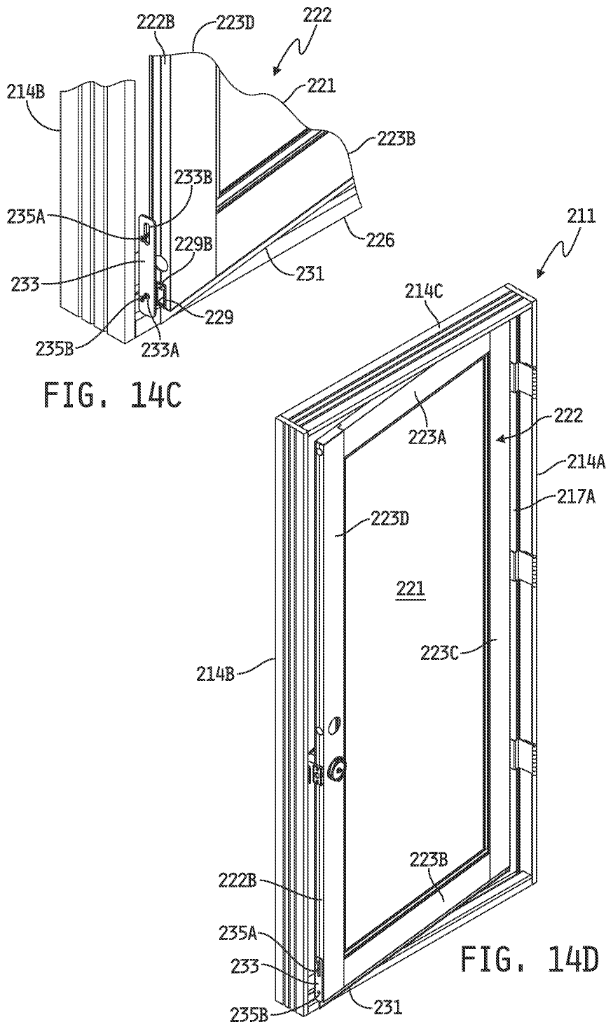

FIG. 14A is a perspective view of a door showing a latch assembly on one side of the door.

FIG. 14BX is an enlarged portion of the view of FIG. 14AX showing an un-notched latch tongue.

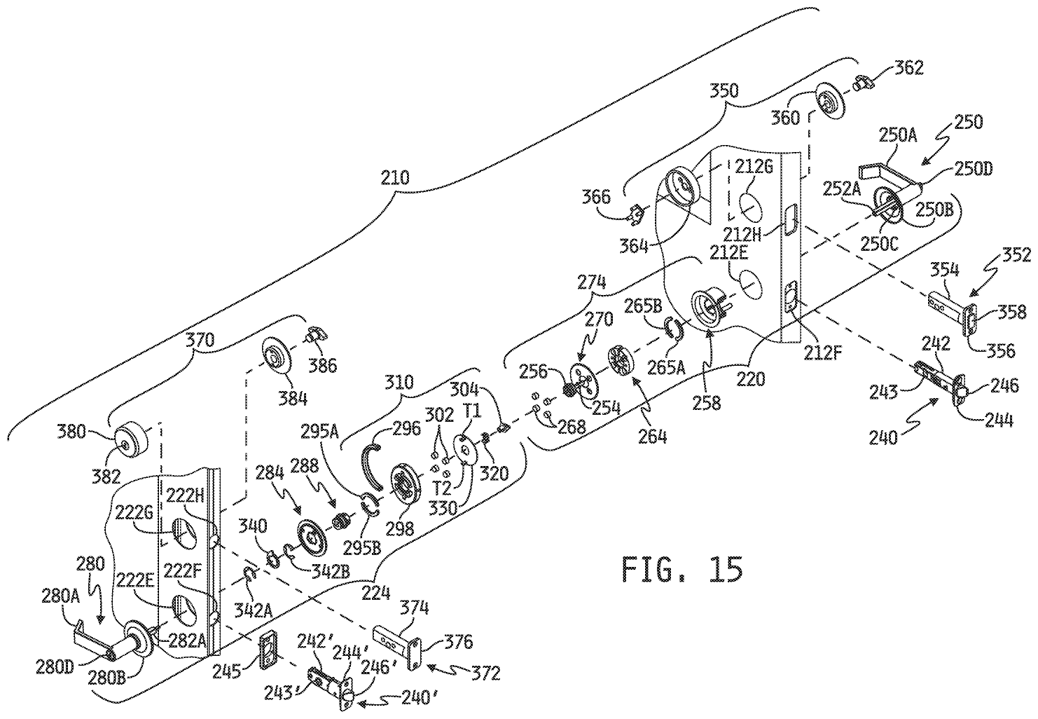

FIG. 15AX is a perspective view of co-mounted doors both opened as coupled together from a hinge assembly side of the co-mounted doors.

FIG. 15B is an enlarged portion of the view of FIG. 15AX showing the channel for receiving the rib on the door as part of a security feature of the present invention.

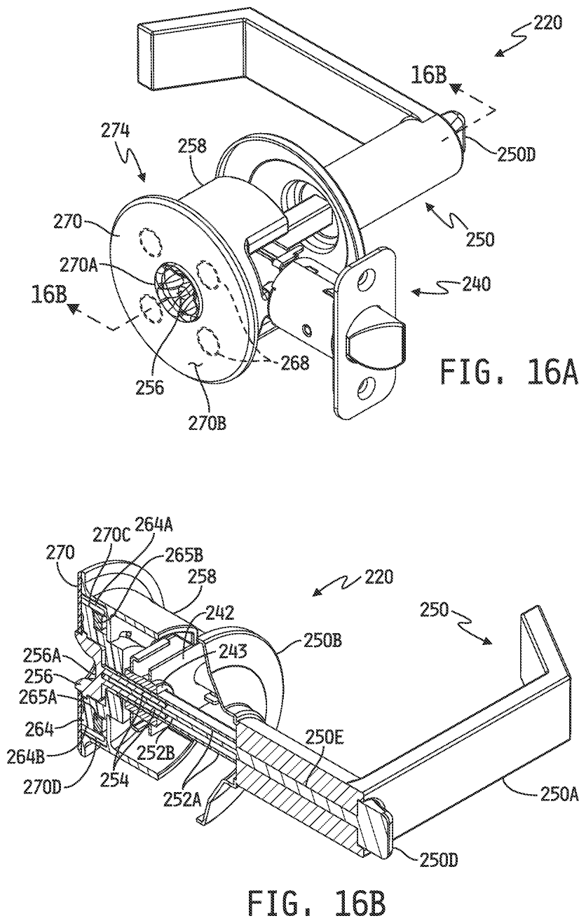

FIG. 16AX is a schematic cross-sectional view of a security feature of the present invention including an interaction between a member connected with a door portion and the door frame by way of a structural rail member, which interaction enhances door integrity when subject to a force in an outward direction.

FIG. 16BX is an enlarged portion of the view of FIG. 16AX showing a plate with a rib connected with the door thereby providing a rib extending at least partially along the door facing a channel of the structural rail member.

FIG. 16CX is an enlarged view similar to FIG. 16BX with the rib moved to a position at least partially engaged with a portion of the channel.

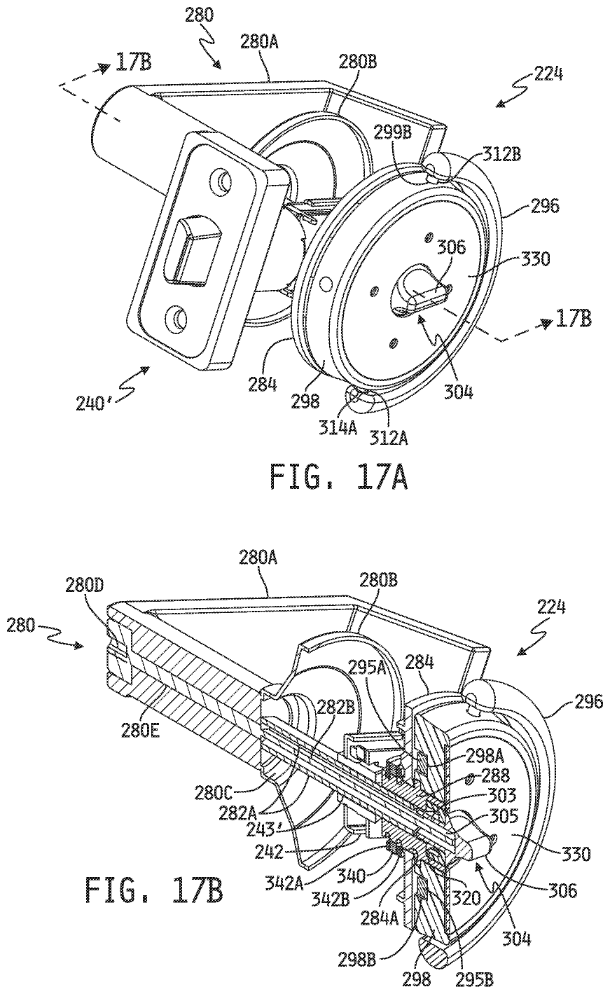

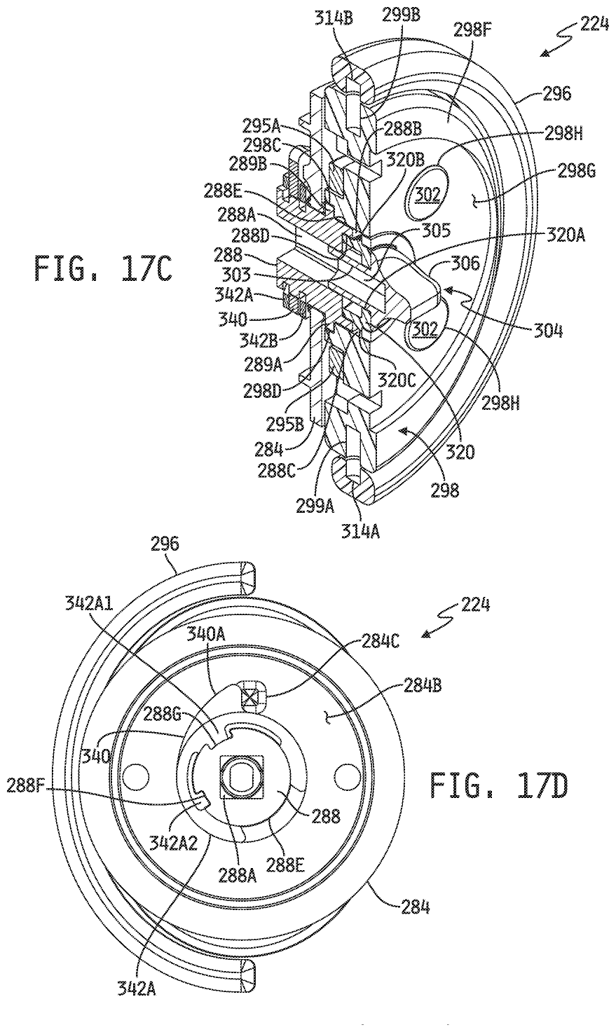

FIG. 17AX is a perspective view of a door showing a latch assembly on one side of the door.

FIG. 17BX is an enlarged portion of the view of FIG. 17AXX showing a plate as mounted to the door, the plate providing a rib as part of a security feature of the present invention.

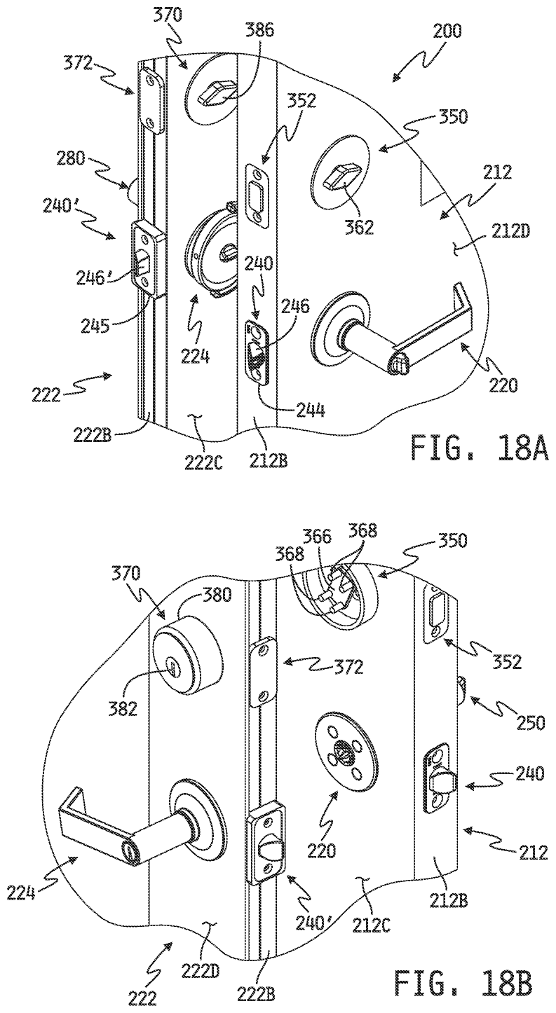

FIG. 18AX is a schematic cross-sectional view of a security feature of the present invention including an interaction between a door portion and the door frame by way of a structural rail member, which interaction enhances door integrity when subject to a force in an outward direction.

FIG. 18BX is an enlarged portion of the view of FIG. 18AX showing a groove or channel provided to a surface of the door and extending at least partially along the door facing an extended portion of the structural rail member.

FIG. 18CX is an enlarged view similar to FIG. 18BX with the groove moved to a position at least partially engaged with a portion of the extended portion of the structural rail member.

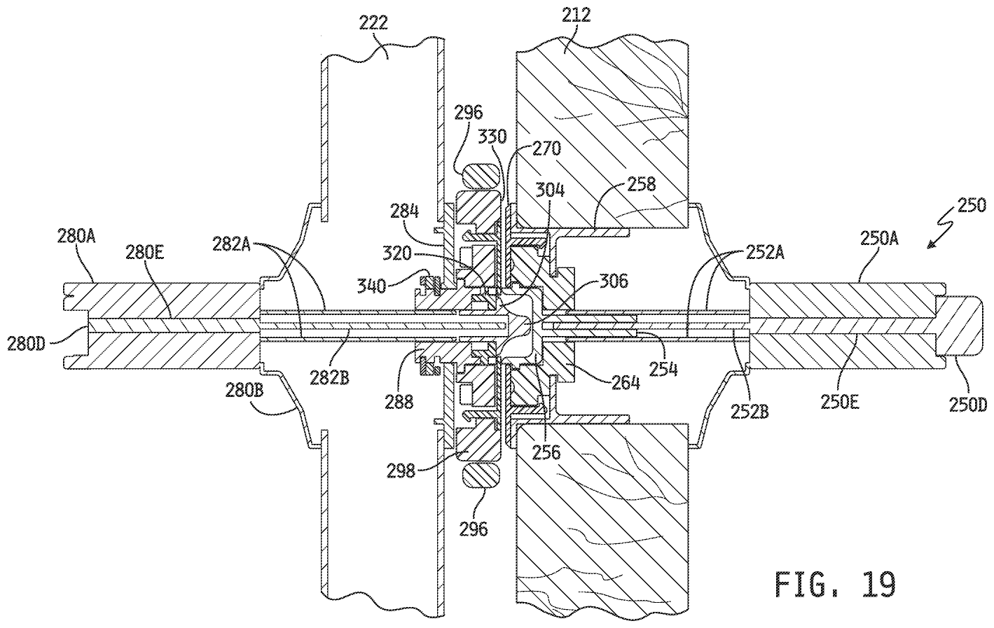

FIG. 19AX is a perspective view of a door showing a latch assembly on one side of the door.

FIG. 19BX is an enlarged portion of the view of FIG. 19AX showing the groove extending at least partially along the door surface as part of a security feature of the present invention.

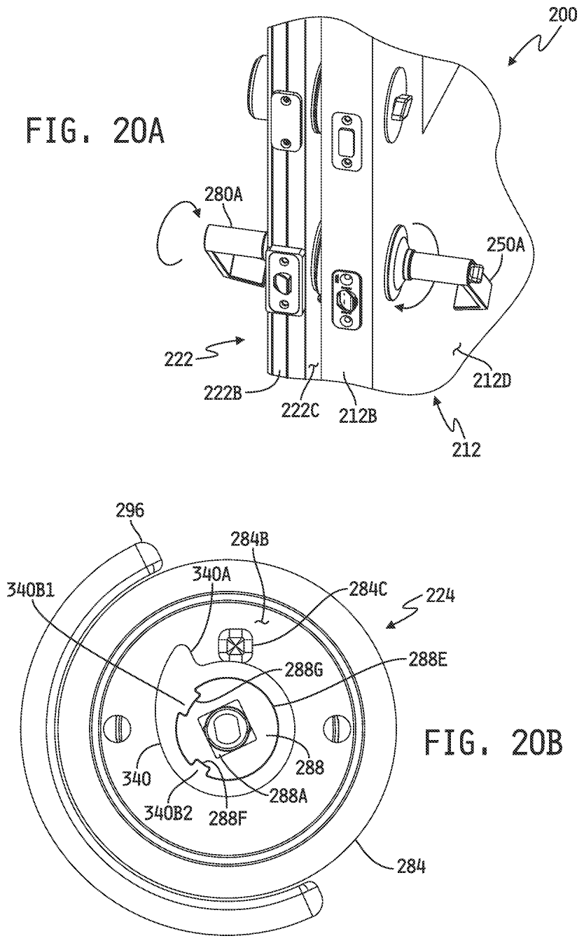

FIG. 20X is a schematic cross-sectional view of a security feature of the present invention including an interaction between a door portion and the door frame by way of a structural rail member, which interaction enhances door integrity when subject to a force in an outward direction.

### DETAILED DESCRIPTION OF THE DRAWINGS

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

Referring now to FIGS. 1A-1B, 3A-3B and 4A-4B, an embodiment is shown of a door assembly 10 including a pair of selectively interlocking, opposing doors 12, 22. In the illustrated embodiment, the doors 12, 22 share one or more common hinge assemblies 16. In one embodiment, the doors 12, 22 share three common hinge assemblies 16 spaced apart along the length of a door jamb 14A in a conventional manner, although in other embodiments the doors 12, 22 may alternatively share more or fewer common hinge assemblies 16. The door 12 includes a handle assembly 20, and the door 22 includes a separate handle assembly 24. The handle assemblies 20, 24 may be selectively interlocked, i.e., selectively coupled to or engaged with each other, such that the doors 12, 22 are together pivotable about the one or more hinge assemblies 16 between closed and open positions as illustrated in FIGS. 1A, 1B and 4A, 4B respectively. The handle assemblies 20, 24 may also be selectively decoupled or disengaged from each other such that the doors 12, 22 may each be separately pivotable about the one or more hinge assemblies 16 so as to be independently openable and closable as illustrated in FIGS. 3A and 3B.

The door assembly 10 includes a door jamb mountable in a conventional manner to a door frame of a building structure. The door jamb illustratively includes a hinge-side jamb and a latch-side jamb both coupled to a top jamb, wherein each such jamb may be a separate from the others with all such jambs coupled together in a conventional manner to form the door jamb or wherein two or more such jambs may be of unitary construction. In the illustrated embodiment, hinge-side and latch-side jambs 14A, 14B of the door jamb are shown, with the hinge-side jamb 14A mounted, attached or otherwise affixed to a stud 18A, e.g., so-called jack stud, which partially defines a doorway of a building structure in and to which the door assembly 10 is mounted, and with the latch-side jamb 14B mounted, attached or otherwise affixed to another stud 18B, e.g., so-called jack stud, which also partially defines the doorway of the building structure in and to which the door assembly 10 is mounted. The top jamb is likewise mounted, attached or otherwise affixed to a conventional header or other door frame structure which also partially defines the doorway of the building structure in and to which the door assembly 10 is mounted. The structure 26 illustratively represents a sill plate coupled to the floor of the building structure or other floor structure that is part of the building structure which, in any case, also partially defines the doorway of the building structure. In some embodiments, the sill plate 26 is coupled to either or both of the jambs 14A, 14B, although in alternate embodiments the sill plate 26 may be separate from either or both of the jambs 14A, 14B. The building structure may be, or may be part of, a residential building, a commercial building, an industrial building or any other conventional building. The door frame is illustratively part of the building structure and may be constructed of one or more framing members, e.g., studs or jack studs 18A, 18B and a header, made from one or more conventional materials, examples of which may include, but are not limited to, wood, composite wood, plastic or plasticized wood substitute, steel or other metal material(s).

In the illustrated embodiment, the door 12 defines a hinge side 12A to which the one or more hinge assemblies 16 is/are mounted, and the door 22 likewise defines a hinge side 22A to which the one or more hinge assemblies 16 is/are mounted. The one or more hinge assemblies 16 is/are also mounted to an inwardly-facing, generally planar, surface 14A1 of the hinge-side jamb 14A. The door 12 further defines a latch side 12B, and at least one conventional door latching component, e.g., at least one latch tongue, of the handle assembly 20 extends therefrom. At least one conventional door latch engaging component, e.g., at least one conventional strike plate 15A (see, e.g., FIG. 4A), is mounted, attached or otherwise affixed to the latch-side jamb 14B, and the at least one door latching component extending from the door 12 and the at least one strike plate 15A are conventionally configured to selectively engage each other when the door 12 is pivoted about the one or more hinge assemblies 16 to a closed position as illustrated in FIG. 1A. Likewise, the door 22 defines a latch side 22B, and at least one conventional door latching component, e.g., at least one latch tongue of the handle assembly 24, extends therefrom. At least another conventional door latch engaging component, e.g., at least another conventional strike plate 15B (see, e.g., FIG. 4A), is mounted, attached or otherwise affixed to a latch-side stop 17B coupled to or integral with the latch-side jamb 14B, and the at least one door latching component extending from the door 22 and the at least another strike plate 15B are conventionally configured to selectively engage each other when the door 22 is pivoted about the one or more hinge assemblies 16 to a closed position as illustrated in FIGS. 1A and 3A. All such door latching components and door latch engaging components are also conventionally configured to selectively disengage from each other, e.g., via conventional actuation of the door handle assemblies 20, 24 respectively, to enable the doors 12, 22 respectively to pivot about the one or more hinge assemblies 16.

The door 12 further defines a first major surface 12C, and a second major surface 12D opposite the first major surface 12C, and the door 22 likewise defines a first major surface 22C and a second major surface 22D opposite the first major surface 22C. The first major surface 12C of the door 12 generally faces the first major surface 22C defined by the door 22, and a space 28 is defined by the door handle assemblies 20, 24 between the first major surfaces 12C, 22C of the doors 12, 22 respectively when the door handle assemblies 20, 24 are interlocked as illustrated in FIGS. 1A, 1B and 4A, 4B. In the illustrated embodiment, the door 12 is a conventional exterior door, the first major surface 12C of which generally faces the door 22 and the second major surface 12D of which faces an interior of the building, and the door 22 is a conventional storm door, the first major surface 22C of which generally faces the door 12 and the second major surface 22D of which faces an exterior of the building. In some alternate embodiments, the door 12 may represent a conventional storm door and the door 22 may represent a conventional exterior door. In other alternate embodiments, the door 12 may represent any conventional interior, exterior, storm, general purpose or special purpose door, and the door 22 may likewise represent any conventional interior, exterior, storm, general purpose or special purpose door. The door 12 may be formed of one or more conventional materials, examples of which may include, but are not limited to, wood, composite, plastic, fiber reinforced plastic, metal, any combination the foregoing, any of the foregoing materials as one or more outer shells or skins with an interior core that is hollow or is formed of a conventional material such as foam, plastic, fiber reinforced plastic, or the like. The door 22 may likewise be formed of one or more conventional materials, examples of which may include, but are not limited to, wood, composite, plastic, fiber reinforced plastic, metal, any combination the foregoing, any of the foregoing materials as one or more outer shells or skins with an interior core that is hollow or is formed of a conventional material such as foam, plastic, fiber reinforced plastic, or the like.

As illustrated most clearly in FIGS. 1B and 4B, the door frame component 18A, e.g., stud or jack stud, has a first generally planar surface 18A1 and a second generally planar surface 18A2 opposite the surface 18A1 with opposing planar side surfaces extending between the surfaces 18A1 and 18A2. An outwardly facing side surface of the hinge-side door jamb 14A opposite the inwardly facing side surface 14A1 illustratively abuts an inwardly facing one of the side surfaces of the door frame component 18A when the hinge-side door jamb 14A is mounted thereto. The hinge-side door jamb 14A defines a generally planar surface 14A2 at one end of the side surface 14A1 and another generally planar surface 14A3 at an opposite end of the side surface 14A1. As illustrated in FIG. 1B, the end surfaces 14A3 and 18A1 of the hinge-side door jamb 14A and the door frame component 18A are illustratively flush with each other as are the end surfaces 14A2 and 18A2, although in other embodiments either or both of the planar surfaces 14A2, 14A3 of the hinge-side door jamb 14A may extend beyond the corresponding surfaces 18A2, 18A1 of the door frame component 18A or vice versa. In any case, the latch-side door jamb 14B and corresponding door frame component 18B are illustratively identically configured as just described, as are the top door jamb and corresponding door frame component.

The door jamb further illustratively includes a conventional door stop mounted to and about an inner periphery of the door jamb which forms a physical stop and, in some embodiments, a sealing surface for the door 12. As further illustrated by example in FIGS. 1B, 3B and 4B, an inner side of a hinge-side door stop 17A is illustratively affixed to the inner-facing surface 14A1 of the hinge-side door jamb 14A along its length, and an inner side of a latch-side door stop 17B is likewise illustratively affixed to an inner-facing surface of the hinge-side door jamb 14B. A generally planar outer side surface 17A1 of the hinge-side door stop 17A faces inwardly toward the door stop 17B, and a generally planar end surface 17A2 extends between the inner side surface and the outer side surface 17A of the stop 17A between, and generally parallel with, the end surfaces 14A2 and 14A3 of the hinge-side jamb 14A. The latch-side door stop 17B and corresponding top-side door stop are illustratively identically configured as just described. The end surface 17A2 of the hinge-side stop 17A, as well as the corresponding end surfaces of the latch-side stop 17B and the corresponding top-side stop, are sized to extend inwardly of the door jamb and over a portion of the major surface 12C of the door 12 along the sides 12A and 12B and the top thereof to act as a conventional physical stop to the door 12 as it is moved from an open position, e.g., as illustrated in FIGS. 3A and 4A, to its closed position, e.g., as illustrated in FIG. 1A. In some embodiments, a conventional sealing material, e.g., foam, plastic, rubber, etc., may be attached or affixed to and along the end surface of the hinge-side stop 17A, as well as the corresponding end surfaces of the latch-side stop 17B and the top-side stop, to form a seal between the major surface 12C of the door 12 and such stop surfaces when the door 12 is closed as illustrated in FIG. 1A. In any case, as illustrated by example in FIGS. 1A and 3A, the door 22 is illustratively sized such that the hinge side 22A abuts, or is at least adjacent to, the inwardly-facing surface of the hinge-side stop 17A, and such that the latch-side 22B and the top end likewise abut, or are at least adjacent to, the inwardly-facing surfaces of the latch-side stop 17B and the top-end stop respectively.

As illustrated in the embodiment depicted in FIGS. 1A, 3A and 4A, the doors 12, 22 pivot in the same direction about the one or more hinges 16, and the doors 12, 22 therefore each open and close in the same direction. In this regard, some embodiments of the door assembly 10 further illustratively include a second door stop mounted to and about an inner periphery of the door jamb to form a physical stop and, in some embodiments, a sealing surface for the door 22. As illustrated by example in FIGS. 1B, 3B and 4B, an inner side of a second hinge-side door stop 19A is illustratively attached or affixed to the inner-facing surface 14A1 of the hinge-side door jamb 14A along its length between the end 14A3 of the door jamb 14A and the stop 17A, and an inner side of a latch-side door stop 17B is likewise illustratively affixed to an inner-facing surface of the hinge-side door jamb 14B. A generally planar outer side surface 19A2 of the hinge-side door stop 19A faces inwardly toward the door stop 19B, and generally planar and opposing end surfaces 19A1 and 19A2 extend between the inner side surface and the outer side surface 19A2 of the stop 19A. In the illustrated embodiment, the end surface 19A3 is generally parallel with the end surface 14A3 of the hinge-side jamb 14A, although in alternate embodiments the end surface 19A3 may extend beyond the end surface 14A3 or vice versa. Also in the illustrated embodiment, a portion of the end surface 19A1 abuts, or is at least adjacent to, a corresponding end surface of the door stop 17A, and another portion extends beyond the outer side surface 17A1 of the stop 17A. In some alternative embodiments, the end of the stop 17A may extend to the end surface 14A3 of the jamb 14A and the stop 19A may be attached or affixed to the inner-facing surface 17A1 of the stop 17A along its length. In any case, the exposed end surface 19A1 of the stop is generally planar and parallel to the end surface 17A2 of the stop 17A. The latch-side door stop 19B and corresponding top-side door stop are illustratively identically configured as just described.

The end surface 19A1 of the hinge-side stop 19A, as well as the corresponding end surfaces of the latch-side stop 19B and the corresponding top-side stop, are sized to extend inwardly of the door jamb and over a portion of the major surface 22D of the door 22 along the sides 22A and 22B and the top thereof to act as a conventional physical stop to the door 22 as it is moved from an open position, e.g., as illustrated in FIG. 4A, to its closed position, e.g., as illustrated in FIGS. 1A and 3A. In some embodiments, a conventional sealing material, e.g., foam, plastic, rubber, etc., may be attached or affixed to and along the end surface of the hinge-side stop 19A, as well as the corresponding end surfaces of the latch-side stop 19B and the top-side stop, to form a seal between the major surface 22D of the door 22 and such stop surfaces when the door 22 is closed as illustrated in FIGS. 1A and 3A.

In some embodiments, as illustrated in FIGS. 1A and 3A-4B, the side jambs 14A, 14B, as well as the corresponding top jamb, are each separate components coupled together in a conventional manner, although in some alternate embodiments at least two such jamb components may be integral and of unitary construction, and in other alternate embodiments all three such jamb components are integral and of a single unitary construction. Likewise, the side stops 17A, 17B, as well as the corresponding top stop, are each separate components coupled together in a conventional manner, although in some alternate embodiments at least two such stop components may be integral and of unitary construction, and in other alternate embodiments all three such stop components are integral and of a single unitary construction. Further still, the side stops 19A, 19B, as well as the corresponding top stop, are likewise each illustratively separate components coupled together in a conventional manner, although in some alternate embodiments at least two such stop components may be integral and of unitary construction, and in other alternate embodiments all three such stop components are integral and of a single unitary construction. In still other alternate embodiments the jamb components and the stop components for the door 12 may be integral and of a single unitary construction, and the stop components for the door 22 may be separate pieces mounted, affixed or otherwise attached to the unitary structure, and in yet further alternate embodiments all jamb and stop components may be integral and of a single unitary construction. In any case, it will be appreciated that the common pivoting direction of the doors 12, 22, along with the door jamb and stop combination just described, advantageously provides for double sealing of the door assembly relative to the door jamb, which feature is generally not attainable in conventional storm door applications in which the storm door opens and closes in directions opposite to the opening and closing directions of the main or exterior door.

Referring now specifically to FIGS. 2A and 2B, an embodiment of one of the one or more hinge assemblies 16 is shown. In the illustrated embodiment, the hinge assembly 16 includes three separate but inter-engaging hinges 30, 32A and 32B. The hinge 30 defines a hinge plate having three integral, planar hinge plate sections or portions 30A, 30B, 30C and a pair of opposing knuckles 30D, 30F at a terminal end of the hinge plate section 30C. Planes defined by the planar hinge plate sections 30A and 30C are illustratively parallel with each other, and a plane defined by the planar hinge section 30B joining the hinge plate sections 30A, 30C is illustratively perpendicular with the planes defined by the planar hinge plate sections 30A, 30C. The dimensions of the hinge plate sections 30A, 30B, 30C are illustratively configured complementarily to corresponding portions of the surfaces 17A1, 17A2 and 14A1 respectively of the hinge-side jamb 14A and stop 17A (see FIG. 4B) such that the hinge plate sections 30A, 30B, 30C contact the surfaces 17A1, 17A2 and 14A1 respectively when the hinge 30 is pivoted into contact with the stop 17A and/or hinge-side jamb 14A (see, e.g., FIGS. 1B and 3B). The knuckles 30D, 30F define bores 30E, 30G centrally therethrough such that the bores 30E, 30G are aligned and define a pivot axis 30H centrally therethrough.

The hinge 32A defines a planar hinge plate 34A and three knuckles 34B, 34C, 34C along one side thereof. The knuckles 34B, 34C, 34D define bores centrally therethrough, and the bores defined through the knuckles 34B, 34C, 34D are aligned such that the pivot axis 30H passes centrally therethrough. The hinge 32B similarly defines a planar hinge plate 36A and two knuckles 36B, 36C along one side thereof. The knuckles 36B, 36C define bores centrally therethrough, and the bores defined through the knuckles 36B, 36C are aligned such that the pivot axis 30H passes centrally therethrough. The knuckles 30D, 30F, 34B, 34C, 34D, 36B, 36C are all arranged to interdigitate in a conventional manner such that the bores defined therethrough all align to define a composite, elongated bore with the pivot axis 30H passing centrally therethrough. A conventional hinge pin 38 is sized to be received within the composite, elongated bore such that each hinge 30, 32A, 32B pivots relative to the pin 38 about the pivot axis 30H. The hinge plate section 30C of the hinge 30 defines an opening 301 therethrough sized to allow each hinge plate 34A, 36A to pass therethrough between upper 30C1 and lower 30C2 hinge plate portions as the hinge plates 34A, 36A pivot about the hinge axis 30H.

As illustrated in FIGS. 1A-1B, 3A-3B and 4A-4B, the hinge plate portion 30A of the hinge 30 is mounted, attached or otherwise affixed to the hinge side 22A of the door 22, e.g., via one or more screws or other conventional fixation members. In some embodiments, the hinge side 22A of the door 22 may illustratively be mortised to receive the hinge plate portion 30A. The hinge plate 36A is mounted, attached or otherwise affixed to the hinge side 12A of the door 12, e.g., via one or more screws or other fixation members. In some embodiments, the hinge side 12A of the door 12 may illustratively be mortised to receive the hinge plate 36A. The hinge plate 34A is mounted, attached or otherwise affixed to the surface 14A1 of the hinge-side jamb 14A, e.g., via one or more screws or other fixation members. In some embodiments, the surface 14A1 of the hinge side jamb 14A may illustratively be mortised to receive the hinge plate 34A.

In the door assembly example illustrated in FIGS. 1A and 1B with the door handle assemblies 20, 24 interlocked and with both doors 12, 22 in their closed positions, the hinge plate portions 30A, 30B and 30C are received in contact with surfaces 17A1, 17A2 and 14A1 respectively of the hinge-side jamb 14A and stop 17A, and the hinge plates 34A, 36A are in contact with each other through the opening 301 defined through the hinge plate portion 30C of the hinge 30. In the door assembly example illustrated in FIGS. 3A and 3B with the door handle assemblies 20, 24 decoupled and with the door 22 in its closed position and the door 12 partially open, the hinge plate portions 30A, 30B and 30C are received in contact with surfaces 17A1, 17A2 and 14A1 respectively of the hinge-side jamb 14A and stop 17A, and the hinge plate 34A is at least partially received within the opening 301 defined through the hinge plate portion 30C of the hinge 30 and the hinge plate 36A mounted to the hinge side 12A of the door 12 is pivoted outwardly away from the hinge plate portion 30C of the hinge 30. In the door assembly example illustrated in FIGS. 4A and 4B with the door handle assemblies 20, 24 interlocked and with both doors 12, 22 in their partially open position, the hinge plate portions 30A, 30B and 30C are pivoted outwardly away from the surfaces 17A1, 17A2 and 14A1 respectively of the hinge-side jamb 14A and stop 17A, the hinge plate 36A is likewise pivoted outwardly away from the hinge side jamb 14A and the hinge plate 34A and is at least partially received within the opening 301 defined through the hinge plate portion 30C of the hinge 30, and the hinge plate 34A is remains secured to the section 14A1 of the hinge side jamb 14A.

Referring now to FIG. 5, an exploded view of the door assembly 10 is shown illustrating embodiments of each of the door handle assemblies 20, 24 as well as embodiments of latch assemblies 40, 40′ mounted to each of the doors 12, 22 respectively. In the illustrated assembly, the door 12 defines a cylindrical opening or face bore 12E therethrough, i.e., defined through the first and second major surfaces 12C, 12D of the door 12, adjacent to the latch side 12B, and another cylindrical opening or side bore 12F therein which opens to the face bore 12E. A conventional latch assembly 40 includes an elongated latch case 42 coupled to a latch plate 44 from which a latch tongue 46 extends. The elongated latch case 42 is illustratively sized to be received within the side bore 12F with at least a portion of the latch case 42 extending into the face bore 12E and the latch plate 44 abutting the latch side 12B of the door 12. In some embodiments, the latch side 12B of the door may be mortised to receive the latch plate 44 therein. The latch case 42 illustratively defines a bore 43 therethrough sized to receive therethrough a cam 52 of the door handle assembly 20. The latch case 42 and/or a handleset 50 of the door handle assembly 20 illustratively carries one or more conventional biasing components such that the latch tongue 46 is normally biased outwardly from the latch plate 44, e.g., as illustrated in FIG. 5, so that it engages and is captured by a conventional strike plate 15A mounted to the latch side jamb 14B of the door assembly 10 (see, e.g., FIG. 4A), and such that axial rotation of the cam 52 causes the latch tongue 46 to be drawn inwardly toward and within the latch case 42 so that it disengages from the strike plate 15A to allow the door 12 to be pivoted via the hinge assembly 16 between open and closed positions thereof. In embodiments in which the handle assembly 20 is lockable, as illustrated in FIG. 5, the bore 43 also receives a spindle 54 of the door handle assembly 20 therethrough. Rotation of the spindle 54 about its longitudinal axis actuates conventional components within the handleset 50 and/or within the latch case 42 between locked and unlocked positions in a conventional manner. For example, when the spindle 54 is rotated to an unlocked position, conventional components within the handleset 50 and/or latch case 42 allow rotation of the cam 52 within the bore 43 to cause the latch tongue 46 to be drawing inwardly within the latch case 42 as described above. When the spindle 54 is rotated to a locked position, conventional components within the handleset 50 and/or latch case 42 prevent rotation of the cam 52, thereby preventing the cam 52 from drawing the latch tongue 46 inwardly within the latch case 42 such that the latch tongue 46 remains engaged with the strike plate 15A. It will be understood that this disclosure contemplates alternate embodiments in which the handle assembly 20 is not lockable, and in such embodiments the spindle 54 may be omitted. In embodiments in which the door handle 20 is lockable as just described, the combination of the door handle assembly 20 and the latch assembly 40 may generally be termed a “lockset.”

The door 22 illustratively likewise defines a cylindrical opening or face bore 22E therethrough, i.e., defined through the first and second major surfaces 22C, 22D of the door 22, adjacent to the latch side 22B, and another cylindrical opening or side bore 22F therein which opens to the face bore 22E. A conventional latch assembly 40′ includes the same components as described above with respect to the latch assembly 40, and the latch case 42 of the latch assembly 40′ is received within the side bore 22F and face bore 22E. The latch assembly 40′ is operable generally as described above with respect to the latch assembly 40 such that the latch tongue 46 of the latch assembly 40′ is normally biased outwardly from the latch plate 44, e.g., as illustrated in FIG. 5, via one or more conventional biasing components carried by the latch case 42 and/or a handleset 80 of the door handle assembly 24 so that it engages and is captured by a conventional strike plate 15B mounted to the latch side jamb 14B of the door assembly 10 (see, e.g., FIG. 4A), and such that axial rotation of a cam 82 received through the bore 43 causes the latch tongue 46 to be drawn inwardly toward and within the latch case 42 so that it disengages from the strike plate 15B to allow the door 22 to be pivoted relative to the hinge assembly 16 between open and closed positions thereof. In embodiments in which the handle assembly 24 is lockable, as illustrated in FIG. 5, the bore 43 also receives a spindle 85 of the door handle assembly 24 therethrough. Rotation of the spindle 85 about its longitudinal axis actuates conventional components within the handleset 80 and/or within the latch case 42 between locked and unlocked positions in a conventional manner as described above. It will be understood that this disclosure contemplates alternate embodiments in which the handle assembly 24 is not lockable, and in such embodiments the spindle 85 may be omitted. In embodiments in which the handle assembly 24 is lockable as just described, the combination of the door handle assembly 24 and the latch assembly 40′ may generally be termed a “lockset.”

Referring generally now to the right sides of FIGS. 5 and 8 respectively, the door handle assembly 20 includes a handleset 50 having handle 50A rotatably coupled to a rosette 50B. Generally, the handle 50A may be or include any structure or combination of structures rotatably coupled to the rosette 50B. In the illustrated embodiment, for example, the handle 50A is provided in the form of a conventional knob rotatable relative to the rosette 50B, and in such embodiments the handleset 50 may be alternately referred to as a “knobset.” In alternate embodiments, the handle 50A may be provided in the form of a lever rotatable relative to the rosette 50B, and in such embodiments the handleset 50 may be alternately referred to as a “leverset.” The handleset 50 further includes a cam 52 rotatably coupled to the handle 50A such that the cam rotates with the handle 50A about a rotational axis. In some embodiments such as that illustrated in FIG. 5, the handle 50A defines a central bore 50C therein sized to receive one end of a spindle 54, and in such embodiments an axis extending centrally through the bore 50C defines the rotational axis of the handle 50A and cam 52. In such embodiments, the received end of the spindle 54 illustratively engages and is coupled to one end of a lock spindle 50E carried by the handle 50A. The opposite end of the lock spindle 50E is coupled to a conventional locking button 50D (see, e.g., FIGS. 7A and 7B) carried by the handle 50A. Rotation of the locking button 50D rotates the lock spindle 50E which, in turn, rotates the spindle 54 and vice versa.

The handleset 50 is mounted to the door 12 with the rosette 50B abutting the major surface 12D of the door 12 about the face bore 12E and with the cam 52 extending into the face bore 12E and through the bore 43 defined through the latch case 42 of the latch assembly 40. In embodiments which include it, the spindle 54 likewise extends into the face bore 12E and further extends through the bore 43 defined through the latch case 42 of the latch assembly 40, as described above. A lock receiver 56 is illustratively affixed to or integral with an opposite end of the spindle 54 such that the lock receiver 56 rotates with the spindle 54, and in such embodiments the locking button 50D, lock spindle 50E, spindle 54 and lock receiver 56 are together rotatable relative to the door handle 50A between an unlocked position in which the spindle 54 cooperates with components within the handleset 50 and/or the latch assembly 40 to allow rotation of the cam 52 via the door handle 50A to operate the latch tongue 46 as described above, and a locked position in which the spindle 54 cooperates with components within the handleset 50 and/or the latch assembly 40 to prevent rotation of the cam 52 such that the handle 50A is prevented from rotating to operate the latch tongue 46. As also described above, the door handle assembly 20 may not include a locking feature in some embodiments, and in such embodiments the locking button 50D and the lock receiver 56 may be omitted along with the spindle 54.

A cylindrical chassis 58 defines an outer periphery 58A sized to be received within the face bore 12E defined through the door 12. The chassis 58 further illustratively defines a lip 58B at one end thereof which abuts the first major surface 12C of the door 12 when the chassis 58 is received within the face bore 12E. The chassis 58 is illustratively affixed to the rosette 50B of the handleset 50 through the face bore 12E, e.g., via one or more conventional fixation members (not shown in FIG. 5 or 8). The chassis 58 and the rosette 50B are thus each fixed in position relative to the door 12 such that neither the rosette 50B nor the chassis 58 rotates with the handle 50A, lock spindle 50E, cam 52 or spindle 54. In the illustrated example, the chassis 58 defines a channel 58C longitudinally along the outer periphery thereof that is sized to receive the latch case 42 transversely therethrough. In some embodiments, the channel 58C is sized to engage the latch case 42 such that the latch case 42 prevents the chassis 58 from rotating within and relative to the face bore 12E.

The chassis 58 further illustratively defines a recessed plate 62 inwardly of the lip 58B, and the plate 62 defines an opening 60 centrally therethrough that is sized to receive the lock receiver 56 and spindle 54 therethrough. Between the end of the chassis 58 adjacent to the lip 58B and the recessed plate 62, the chassis 58 defines a cylindrical pocket 62A sized to receive a cylindrical magnet housing 64 therein. The cylindrical magnet housing 64 defines a cylindrical body portion 64A having a first outer diameter sized to be received within the pocket 62A of the chassis 58 and to be rotatable within the pocket 62A relative to the chassis 58 about the opening 60. A cylindrical shaft 64B extends axially away from the body portion 64A and the shaft 64B has a second outer diameter sized to be received within and through the opening 60 defined through the chassis 58. The body 64A defines a first bore 64C centrally therethrough, and the shaft 64B defines a second bore 64D centrally therethrough, wherein the axes of the bores 64C and 64D are aligned and the diameter of the bore 64D is less than that of 64C. The bore 64C is sized to receive the lock receiver 56 and the spindle 54 therein such that the lock receiver 56 is rotatable relative to the bore 64C, and the bore 64D is sized to receive the spindle 54 but not the lock receiver 56 therein. The bore 64D further illustratively defines a notch in and along a surface thereof that is sized to receive a terminal end of the cam 52, and the cam 52 is thereby affixed or otherwise coupled to the shaft 64B within the bore 64D such that the magnet housing 64 axially rotates with the cam 52 about the opening 60 and bore 64C of the cylindrical pocket 62A defined by the chassis 58.

Distributed about the body portion 64A of the magnet housing 64 between the outer diameter of the body portion 64A and the bore 64C, the body portion 64A defines a plurality of bores 66 therein such that central axes of the bores 66 are parallel with the central axes of the bores 64C, 64D. Each of the bores 66 is illustratively sized to receive therein a different one of a corresponding plurality of cylindrically-shaped magnets 68 each defining a planar face oriented in a direction facing away from the recessed plate 62. A cylindrical cover plate 70 is received over and engages the exposed terminal face of the body portion 64A of the magnet housing 64. In the illustrated embodiment, the cylindrical cover plate 70 has an outer diameter that is substantially equal to the outer diameter of the body portion 64A of the magnet housing 64, although alternate embodiments are contemplated in which the outer diameter of the cover plate 70 is less than or greater than the outer diameter of the body portion 64A of the magnet housing 64. In any case, the cover plate 70 illustratively defines a bore 70A centrally therethrough that aligns with the bores 64C, 64D and the opening 60, and the bore 70A is sized to receive the lock receiver 56 therein. In the illustrated embodiment, the terminal face of the cover plate 70 extends beyond the terminal face of the lock receiver 56 when the door handle assembly 20 is assembled and mounted to the door 12, although alternate embodiments are contemplated in which the terminal face of the lock receiver 56 may extend beyond the terminal face of the cover plate 70 or in which the terminal face of the lock receiver 56 is substantially flush with the terminal face of the cover plate 70. In the illustrated embodiment, the cover plate 70 further defines a plurality of bores 72 therethrough distributed about the bore 70A such that each bore 72 aligns axially with a corresponding one of the bores 66 so that a planar outer face of a corresponding one of the magnets 68 is exposed through each bore 72. In the illustrated embodiment, the diameters of the bores 72 are sized such that the exposed planar faces of the magnets 68 are co-planar with an outer face of the cover plate 70, although this disclosure contemplates alternate embodiments in which the exposed planar faces of the magnets 68 are at least partially recessed within the openings 72. In alternate embodiments, the cover plate 70 may be solid such that the cover plate 70 covers the planar outer faces of the magnets 68. In any case, the magnet housing 64, magnets 66 and cover plate 70 together illustratively define a magnet assembly 74 which is coupled to the door handle 50A via the cam 52 and which rotates with the handle 50A and cam 52 within and relative to the pocket 62A of the chassis 58.

In the illustrated embodiment, the plurality of magnets 68 illustratively include eight magnets 68 equally spaced about the periphery of the axially aligned bores 64C, 64D, 70A of the magnet assembly 74. Alternatively, the magnet assembly 74 may be configured to include more or fewer magnets, e.g., such that the total number of magnets is one or more. In embodiments which include two or more magnets 68, such magnets may be equally or non-equally spaced about the periphery of the axially aligned bores 64C, 64D, 70A, equally or non-equally spaced only partially about the periphery of the axially aligned bores 64C, 64D, 70A, or equally and/or non-equally spaced individually and/or in sub-groups about or partially about the periphery of the axially aligned bores 64C, 64D, 70A. In any of the foregoing embodiments, each of the one or more magnets 68 may be a conventional permanent magnet. Alternatively or additionally, the one or more magnets 68 may be or include one or more conventional programmable magnets each having programmable magnetic polarities and/or magnetic field strengths and/or each having two or more zones in which the magnetic polarity and/or magnetic field strength is programmable in a conventional manner. In one example such embodiment, which should not be considered to be limiting in any way, a single programmable magnet 68 may be used and programmed in a conventional manner to define at least two magnetic zones having opposite magnetic polarities, and in one specific example, a single programmable magnet 68 may be used and programmed in a conventional manner to define multiple magnetic zones distributed radially about an exposed surface thereof with each zone having a magnetic polarity opposite to the magnetic polarities of adjacent zones.

In embodiments that include the lock receiver 56, the locking end 56A of the lock receiver 56 exposed through the opening 70A is illustratively configured, e.g., keyed, to rotatably engage a locking protrusion carried by the door handle assembly 24, i.e., to couple to the locking protrusion carried by the door handle assembly 24 such that the locking protrusion and the lock receiver 56 rotate together in response to rotation of one or the other. An example configuration of the locking end 56A of the lock receiver 56 is illustrated in the front elevational view of FIG. 6A showing the door handle assembly 20 as assembled and mounted to the major surface 12C of the door 12.

As described above, the rosette 50B of the handleset 50 and the chassis 58 of the door handle assembly 20 are illustratively coupled to each other and both fixed in position relative to the door 12, whereas the door handle 50A, cam 52 and magnet assembly 74 are rotatable together relative to the rosette 50B, chassis 58 and door 12. In embodiments that include them, the locking button 50D, lock spindle 50E, spindle 54 and lock receiver 56 are rotatable together relative to the chassis 58, rosette 50B and door 12, as well as relative to the door handle 50A, cam 52 and magnet assembly 74, to lock and unlock the door handle assembly 20 as also described above.

Referring generally now to the left sides of FIGS. 5 and 8 respectively, the door handle assembly 24 includes a handleset 80 having handle 80A rotatably coupled to a rosette 80B. Generally, the handle 80A may be or include any structure or combination of structures rotatably coupled to the rosette 80B. In the illustrated embodiment, for example, the handle 80A is provided in the form of a conventional knob rotatable relative to the rosette 80B, and in such embodiments the handleset 80 may be alternately referred to as a “knobset.” In alternate embodiments, the handle 80A may be provided in the form of a lever rotatable relative to the rosette 80B, and in such embodiments the handleset 80 may be alternately referred to as a “leverset.” The handleset 80 further includes a cam 82 rotatably coupled to the handle 80A such that the cam 82 rotates with the handle 80A about a rotational axis. In some embodiments such as that illustrated in FIG. 5, the handle 80A defines a central bore 80C therein (see, e.g., FIG. 8) sized to receive one end of a spindle 85, and in such embodiments an axis extending centrally through the bore 80C defines the rotational axis of the handle 80A and cam 82. In such embodiments, the received end of the spindle 85 illustratively engages a conventional keyway 80D carried by the handle 80A, and in such embodiments the keyway 80D is rotatable, e.g., via a conventional key configured complementarily to the keyway 80D, between an unlocked position in which the spindle 85 cooperates with components within the handleset 80 and/or within the latch assembly 40′ to allow rotation of the handle 80A to operate the latch tongue 46 extending from the latch assembly 40′, and a locked position in which the spindle 85 cooperates with components within the handleset 80 and/or within the latch assembly 40′ to prevent rotation of the handle 80A such that the handle 80A is prevented from operating the latch tongue 46 extending from the latch assembly 40′. In other embodiments, the door handle assembly 24 may not include a locking feature and in such embodiments the keyway 80D may be omitted along with the spindle 85.

The handleset 80 is mounted to the door 22 with the rosette 80B abutting the major surface 22D of the door 12 about the face bore 22E and with the cam 82 extending into the face bore 22E and through the bore 43 defined through the latch case 42 of the latch assembly 40′. In embodiments which include it, the spindle 85 likewise extends into the face bore 22E and further extends through the bore 43 defined through the latch case 42 of the latch assembly 40′, as described above. A lock member 104 is illustratively affixed to an opposite end of the spindle 85 such that the lock member 104 rotates with the spindle 85, and in such embodiments the keyway 80D, spindle 85 and lock member 104 are together rotatable relative to the door handle 80A between locked and unlocked positions as described above. As also described above, the door handle assembly 24 may not include a locking feature in some embodiments, and in such embodiments the keyway 80D and the lock member 104 may be omitted along with the spindle 85.

A mounting plate 84, e.g., in the form of an annular disk is received in contact with the major surface 22C of the door 22 about the face bore 22D, and a bore 86 defined through the mounting plate 85 is centrally aligned with the face bore 22E. The mounting plate 84 is illustratively affixed to the rosette 80B of the handleset 80 through the face bore 22E, e.g., via one or more conventional fixation members. The mounting plate 84 and the rosette 80B are thus each fixed in position relative to the door 22 such that neither the rosette 80B nor the mounting plate 84 rotates with the handle 80A, cam 82 or spindle 85.

A bushing 88 defines an outer periphery 90 sized to be received within the bore 86 defined through the mounting plate 84, and further defines a lip or flange 92 at one end thereof which abuts the inner surface 84A of the mounting plate 84 when the bushing 88 is received through the bore 86. The bushing 88 defines a bore 94 centrally therethrough sized to receive the spindle 95 therein. One end of the bushing 88 is illustratively notched around the bore 94 to receive a distal end of the lock member 104 therein. The bushing 88 further defines a notch or channel 94A adjacent to the bore 94 that is sized to receive therein a terminal end of the cam 82, and the cam 82 is affixed or otherwise coupled to the bushing 88 within the channel 94A such that the bushing 88 axially rotates with the cam 82 about the bore 94. In embodiments in which the door handle assembly 24 is configured to be lockable, the spindle 85 extends through the bore 94 between the handle 80A and the lock member 104.

An interlocking handle 96 defines a bore 98 therethrough that is sized and configured to receive the bushing 88 therein. The outer periphery 90 of the bushing and/or the inner surface of the bore 98 defined through the interlocking handle 96 is/are illustratively configured to rotatably couple to each other such that the interlocking handle 96 rotates with the bushing and vice versa about the axially aligned bores 94 and 98. In the illustrated embodiment, for example, the outer periphery 90 of the bushing 88 and the inner surface of the bore 98 of the interlocking handle each illustratively have piece-wise circular cross-sections defined by a plurality of sequentially joined planar sections. Ridges defined at the junctions of the planar sections of the outer periphery 90 align with corresponding creases defined at the junctions of the planar sections of the bore 98 when the bushing 88 is axially received within the bore 98 of the interlocking handle 96 to rotationally couple the interlocking handle 96 to the bushing 88 such that the bushing 88 rotates with the interlocking handle 96 and vice versa. In the example embodiment illustrated in FIG. 5, the outer periphery 90 and the inner surface of the bore 98 are both hexagonal in cross-section, although other piece-wise circular cross-sections are contemplated by this disclosure.

Distributed about the bore 98, an exposed face 99 of the interlocking handle 96 defines a plurality of bores 100 (see, e.g., FIG. 6B) therein such that central axes of the bores 100 are parallel with the central axis of the bore 98. Each of the bores 100 is illustratively sized to receive therein a different one of a corresponding plurality of cylindrically-shaped magnets 102 each defining a planar face oriented in a direction facing away from the mounting plate 84. In the illustrated embodiment, the bores 100 are sized such that the exposed planar faces of the magnets 102 are co-planar with the exposed face 99 of the mounting plate 84, although this disclosure contemplates alternate embodiments in which the exposed planar faces of the magnets 102 are at least partially recessed within the bores 100. In any case, the interlocking handle 96 and magnets 102 together illustratively define a magnet assembly 110 which is coupled to the door handle 80A via the cam 82 and which rotates with the handle 80A and cam 82 relative to the mounting plate 84.

In the example embodiment illustrated in FIGS. 5 and 6B, the plurality of magnets 102 illustratively includes eight magnets 68 equally spaced about the periphery of the bore 98 of the magnet assembly 110. Alternatively, the magnet assembly 110 may be configured to include more or fewer magnets, e.g., such that the total number of magnets is one or more. In embodiments which include two or more magnets 110, such magnets may be equally or non-equally spaced about the periphery of the bores 98, equally or non-equally spaced only partially about the periphery of the bore 98, or equally and/or non-equally spaced individually and/or in sub-groups about or partially about the periphery of the bore 98. In any of the foregoing embodiments, each of the one or more magnets 102 may be a conventional permanent magnet. Alternatively or additionally, the one or more magnets 102 may be or include one or more conventional programmable magnets each having programmable magnetic polarities and/or magnetic field strengths and/or each having two or more zones in which the magnetic polarity and/or magnetic field strength is programmable in a conventional manner. In one example such embodiment, which should not be considered to be limiting in any way, a single programmable magnet 102 may be used and programmed in a conventional manner to define at least two magnetic zones having opposite magnetic polarities, and in one specific example, a single programmable magnet 102 may be used and programmed in a conventional manner to define multiple magnetic zones distributed radially about an exposed surface thereof with each zone having a magnetic polarity opposite to the magnetic polarities of adjacent zones

One end of a lock member 104 defines an outer periphery 108 sized to be received in the bore 94 at the end of the bushing 88 that extends away from the mounting plate 84 such that the lock member 104 rotates within the bore 94 relative to the bushing 88 and the interlocking handle 96. The lock member 104 is affixed or otherwise coupled to one end of the spindle 85 as described above, and the lock member 104 thus rotates with the spindle 85 and keyway 80D relative to the door handle 80A, rosette 80B, mounting plate 84, bushing 88 and interlocking handle 96.

A locking protrusion 106 extends outwardly away from an opposite end of the lock member 104, and the locking protrusion 106 is illustratively configured complementarily to the locking end 56A of the lock receiver 56 such that the locking protrusion rotatably engages the locking end 56A of the lock receiver when the door handle assemblies 20 and 24 are brought together in contact with each other. An example configuration of the locking protrusion 106 extending from the lock member 104 is illustrated in the front elevational view of FIG. 6B showing the door handle assembly 24 as assembled and mounted to the major surface 22C of the door 22. As shown in the example embodiment illustrated in FIGS. 6A and 6B, the locking end 56A of the lock receiver 56 is illustratively provided in the form of a pair of cross-slotted channels and the locking protrusion 106 of the lock member 104 is illustratively provided in the form of a linear blade or edge sized to be received within either of the cross-slotted channels such that the lock receiver 56 and lock member 104 are rotationally coupled together. It will be understood that the configurations of the locking end 56A of the lock receiver 56 and the locking protrusion 106 extending from the lock member 104 illustrated in FIGS. 5-8 represent only one example configuration. Those skilled in the art will recognize other configurations of the locking end 56A of the lock receiver 56 and/or of the locking protrusion 106 of the lock member 104 that may be implemented to rotationally coupled the lock receiver 56 and the lock member 104 when the door handle assemblies 20 and 24 are brought together in contact with each other, and it will be understood that any such other configurations are contemplated by this disclosure.

As described above, the rosette 80B of the handleset 80 and the mounting plate 84 of the door handle assembly 24 are illustratively affixed to each other and both are fixed in position relative to the door 22, whereas the door handle 80A, cam 82, bushing 88 and magnet assembly 110 are rotatable together relative to the rosette 80B, mounting plate 84 and door 22. In embodiments that include them, the keyway 80D, the spindle 85 and lock member 104 are rotatable together relative to the rosette 50B, mounting plate 84 and door 22, as well as relative to the door handle 80A, cam 82, bushing 88 and magnet assembly 110, to lock and unlock the door handle assembly 24 as also described above.

The door handle assemblies 20, 24 may be selectively interlocked, coupled together or otherwise engage each other such that the doors 12, 22 pivot together about the one or more hinge assemblies 16, e.g., as illustrated in FIGS. 4A and 4B, and may be selectively decoupled or disengaged from each other such that the doors 12, 22 pivot independently from each other about the one or more hinge assemblies 16, e.g., as illustrated in FIGS. 3A and 3B. In the illustrated embodiment, such selective interlocking of the door handle assemblies 20, 24 is illustratively accomplished through selective alignment of the two sets of magnets 68, 102 via appropriate positioning of the interlocking handle 96 relative to the door 22 followed by magnetic coupling of and between the two sets of magnets 68, 102 as the two handle assemblies 20, 24 are subsequently brought into contact with each other. Selective decoupling or disengagement of the interlocked door handle assemblies 20, 24 is illustratively accomplished by rotating the door handle 50A in a release direction, e.g., counterclockwise, until the interlocking handle 96 magnetically coupled to the magnet assembly 74 and rotating therewith has reached a release position at which the interlocking handle 96 is prevented from further rotation in the release direction, and then further rotating the door handle 50A in the release direction with a rotational force that is sufficient to overcome the magnetic coupling force between the two sets of magnets 68, 102, thereby decoupling the two door handle assemblies 20, 24.

Referring now to FIGS. 6A-8, selective interlocking of the door handle assemblies 20, 24 is graphically demonstrated. In the example door assemblies 20, 24 illustrated in FIGS. 6A and 6B respectively, the magnets 68, 102 are illustratively arranged such that the exposed surfaces of the magnets 68 alternate in magnetic polarity about the lock receiver 56 and the exposed surfaces of the magnets 102 likewise alternate in magnetic polarity about the lock member 104. With the interlocking door handle 96 rotated clockwise, e.g., manually, to an interlocking position illustrated in FIG. 6B, the magnetic polarities of the exposed surfaces of the magnets 68 are opposite those of the magnets 102 axially aligned therewith. As the door handle assemblies 20, 24 are brought toward each other by pivoting one door 12 toward the other door 22, or by pivoting both doors 12, 22 toward each other, about the one or more hinge assemblies 16 as illustrated in FIG. 7A, magnetic attractive forces develop between each axially aligned and opposite magnetic polarity pair of magnets in the opposing sets of magnets 68, 102. As the distance between the interlocking door handle 96 and the cover plate 70 decreases, magnetic attractive forces increase between each aligned pair of the opposing sets of magnets 68, 102 about the periphery of the lock receiver 56 and the lock member 104 until magnetic coupling occurs between each of the aligned and opposite magnetic polarity pairs of magnets 68, 102 which draws them into contact with each other, thereby magnetically coupling together the door handle assemblies 20, 24 as illustrated in FIG. 7B.

Such magnetic coupling between the exposed surfaces of two example opposing pairs of magnets 68A, 102A and 68B, 102B is illustrated in FIG. 8. As a result of such magnetic coupling, the door handle assemblies 20, 24, and thus the doors 12, 22 respectively are secured together adjacent to the latch sides 12B, 22B respectively thereof, such that the doors 12, 22 may be pivoted together about the one or more hinge assemblies 16 between common open and closed positions as illustrated in FIGS. 3A and 4A. And because the magnet assembly 74 rotates with the door handle 50A and the interlocking door handle 96 rotates with the door handle 80A, rotating either door handle 50A or 80A simultaneously operates both latch assemblies 40, 40′. By rotating either door handle 50A, 80A with the door handle assemblies 20, 24 interlocked, i.e., magnetically coupled together as illustrated in FIGS. 7B and 8, the latch tongues 46 of both latch assemblies 40, 40′ can thus be selectively and simultaneously engaged/disengaged with/from the strike plates 15A, 15B respectively.

As illustrated in FIGS. 7A, 7B and 8, as the door handle assemblies 20, 24 are brought together and interlocked, the locking protrusion 106 extending from the lock member 104 is received within and rotatably engages the locking end 56A of the lock receiver 56. With the locking protrusion 106 rotatably engaged with the locking end 56A of the lock receiver, the lock member 104 rotates with rotation of the lock receiver 56 and vice versa such that rotation of the locking button 50D to the locked or unlocked position of the door handle 50A is transferred through the rotatably engaged lock receiver 56 and lock member 104 to also lock or unlock, respectively, the door handle 80A via actuation of the keyway 80D. Rotation of the keyway 80D, e.g., via a complementarily configured key, to the locked or unlocked position of the door handle 80A is likewise transferred through the rotatably engaged lock member 104 and lock receiver 56 to lock or unlock, respectively, the door handle 50A via actuation of the locking button 50D. By rotating either the locking button 50D or the keyway 80D with the door handle assemblies 20, 24 interlocked, i.e., magnetically coupled together, as illustrated in FIGS. 7B and 8B, the door handles 50A, 80A can thus be selectively and simultaneously locked/unlocked.

Referring now to FIGS. 9A and 9B, the interlocking handle 96 is shown in its interlocking and release positions respectively. With the door handle assemblies 20, 24 decoupled as illustrated in FIGS. 3A and 7A, the interlocking handle 96 may be manually moved, e.g., rotated, from the interlocking position (FIG. 9A) to the release position (FIG. 9B) by rotating the interlocking handle 96 in the counterclockwise direction, and may be moved from the release position (FIG. 9B) to the interlocking position (FIG. 9A) by rotating the interlocking handle 96 in the clockwise direction. With the door handle assemblies 20, 24 interlocked as illustrated in FIGS. 7B and 8, the interlocking handle 96 may be moved from the interlocking position to the release position to thereby decoupled the door handle assemblies 20, 24 by rotating the door handle 50A in the counterclockwise direction which, through the magnetic coupling between the sets of magnets 68, 102, also rotates the interlocking handle 96 in the counterclockwise direction as described above.

The release position of the interlocking door handle 96 is illustratively defined by a physical stop which prevents further rotation of the interlocking door handle 96 in the counterclockwise direction. In the embodiment illustrated in FIGS. 9A-9C, such a physical stop is illustratively implemented in the form of a protrusion 120 extending away from an inner surface of the interlocking door handle 96 toward the mounting plate 84 and another protrusion 122 extending away from the mounting plate 84 toward the inner surface of the interlocking door handle 96. The positions of the protrusions 120, 122 relative to the interlocking door handle 96 and the mounting plate 84 respectively may be selected to provide any amount of rotational distance between the interlocking and release positions of the interlocking door handle 96 relative to the mounting plate 84. Typically, the rotational distance between the interlocking and release positions of the interlocking door handle 96 will be selected to provide for selective disengagement of the latch tongues 46 of the latch assemblies 40, 40′ from the strike plates 15A, 15B respectively via rotation of the door handle 50A and/or the door handle 80A prior to reaching the physical stop of the interlocking door handle 96 defined by the protrusions 120, 122.

In any case, with the interlocking door handle 96 rotated counterclockwise to the release position illustrated in FIG. 9B in which the protrusion 120 contacts the protrusion 122, the interlocking door handle 96 cannot be further rotated in the counterclockwise direction and the door handle assemblies 20, 24 may be decoupled from each other by further rotating the door handle 50A in the counterclockwise direction with sufficient force to overcome the magnetic coupling between aligned pairs of the magnets 68, 102. With the position of the interlocking door handle 96 fixed in its release position by the abutting protrusions 120, 122, such further rotation of the door handle 50A in the counterclockwise direction with a force greater than the magnetic coupling forces between the aligned pairs of magnets 68, 102 causes the magnet assembly 74 to rotate counterclockwise relative to the exposed face 99 of the interlocking door handle 96, thereby rotationally drawing the magnets 68 away from the previously aligned and opposite polarity magnets 102. As the magnet assembly 74 continues to rotate (with the door handle 50A) counterclockwise relative to the face 99 of the interlocking handle 96, the exposed surfaces of the magnets 68 continue to be drawn away from the exposed surfaces of magnets 102 having opposite magnetic polarity and toward the exposed surfaces of magnets 102 having like polarities. As the exposed surfaces of the magnets 68 rotate sufficiently away from the exposed surfaces of the previously aligned and opposite polarity magnets 102, the door assemblies 20, 24 magnetically decouple from each other so that the doors 12, 22 may be separated from each other. As the exposed surfaces of the magnets 68 move, e.g., with further rotation of the door handle 50A in the counterclockwise direction, into alignment with the exposed surfaces of magnets 102 having like polarity, magnetic repulsive forces develop therebetween. Such magnetic repulsive forces operate to force the magnet assemblies 74, 110 away from each other, thereby magnetically assisting with the decoupling of the door handle assemblies 20, 24 and with the separation of the doors 12, 22 from each other.

In one embodiment, the bushing 88 is configured to form a frictional fit within the bore 86 defined through the mounting plate 84, and such frictional fit illustratively results in the interlocking handle 96 generally remaining in any position to which it is moved until the interlocking handle 96 is subsequently moved. In alternate embodiments, the interlocking handle 96 may be biased, e.g., via one or more conventional springs, to the interlocking position illustrated in FIG. 9A such that the interlocking handle 96 returns under bias to the interlocking position when the door handle assemblies 20, 24 are decoupled.

With the door handle assemblies 20, 24 decoupled from each other as illustrated in FIGS. 3A and 3B, the door handle assembly 24 is operable in a conventional manner, e.g., by rotating the handle 80A and/or the interlocking handle 96, to selectively engage and release the latch tongue 46 with and from the strike plate 15B. Illustratively, the rotational distance between the interlocking and release positions of the interlocking door handle 96 relative to the mounting plate 84 is selected to allow such rotation of the interlocking handle 96 to engage and release the latch tongue 46 before reaching the physical stop that defines the release position of the handle 96. In embodiments in which the door handle assembly 24 is lockable, i.e., to selectively prevent release of the latch tongue 46 from the strike plate 15B, and unlockable, i.e., to selectively allow release of the latch tongue 46 from the strike plate 15B, the door handle assembly 24 is further operable in a conventional manner, e.g., by manually rotating the locking protrusion 106 and/or by actuating the keyway 80D with a complementarily configured key, to lock and unlock the door handle assembly 24.

The door handle assembly 20 is also operable, with the door handle assemblies 20, 24 decoupled from each other, in a conventional manner, e.g., by rotating the handle 50A, to selectively engage and release the latch tongue 46 with and from the strike plate 15A. In embodiments in which the door handle assembly 20 is lockable, i.e., to selectively prevent release of the latch tongue 46 from the strike plate 15A, and unlockable, i.e., to selectively allow release of the latch tongue 46 from the strike plate 15A, the door handle assembly 20 is further operable in a conventional manner, e.g., by manually rotating the lock button 50D to lock and unlock the door handle assembly 20. However, as illustrated in FIGS. 3A and 3B, the door handle assembly 20 need not be operable from the major surface 12C side of the door 12 to selectively engage/release the latch tongue 46 or to lock/unlock the door handle assembly 20 since, with the door handle assemblies 20, 24 decoupled, the doors 12, 22 will typically be separated from each other, in which case the door 12 will typically be at least partially open and an operator of the doors 12, 22 will therefore have access to the major surface 12D side of the door 12 and, in turn, will have access to the handle 50A and lock button 50D.

With the door handle assemblies 20, 24 interlocked and therefore coupled to each other as illustrated in FIGS. 1A, 1B and 4A, 4B, the door handle assemblies 20, 24 are operable together and simultaneously as described above, e.g., by rotating the handle 80A and/or the handle 50A. Rotating only the handle 80A causes the latch assembly 40′ to selectively engage and release the latch tongue 46 with and from the strike plate 15B in a conventional manner. And with the door handle assemblies 20, 24 coupled together, such rotational motion of the handle 80A is transferred through the components of the door handle assemblies 20, 24 as described above to also simultaneously rotate the handle 50A and cause the latch assembly 40 to selectively engage and release the latch tongue 46 with and from the strike plate 15A. Similarly, rotating only the handle 50A causes the latch assembly 40 to selectively engage and release the latch tongue 46 with and from the strike plate 15A in a conventional manner, and such rotational motion of the handle 50A is transferred through the components of the door handle assemblies 20, 24 as described above to also simultaneously rotate the handle 80A and cause the latch assembly 40′ to selectively engage and release the latch tongue 46 with and from the strike plate 15B. As described above, the rotational distance between the interlocking and release positions of the interlocking door handle 96 relative to the mounting plate 84 is illustratively selected to allow such rotation of the door handle assembly 24 to engage and release the latch tongue 46 before reaching the physical stop that defines the release position of the interlocking door handle 96. Further rotation of the door handle 50A, e.g., counterclockwise, after reaching the physical stop that defines the release position of the interlocking door handle 96 causes the door handle assemblies 20, 24 to decouple from each other if the applied rotational force is sufficient to overcome the magnetic coupling force between the aligned sets of magnets 68, 102 as described above.

In embodiments in which the door handle assemblies 20, 24 are lockable, i.e., to selectively prevent release of the latch tongue 46 from the strike plate 15A and to prevent release of the latch tongue 46 from the strike plate 15B, and unlockable, i.e., to selectively allow release of the latch tongues 46 from the strike plates 15A, 15B, the door handle assemblies 20, 24 are each separately operable in a conventional manner, e.g., by manually rotating the lock button 50D or by selectively actuating the keyway 80D with a complementarily configured key, to lock and unlock the respective door handle assemblies 20, 24 as described above. When the door handle assemblies 20, 24 are interlocked as described above, rotation of the lock button 50D to lock or unlock the door handle assembly 20 is transferred, as described above, to the keyway 80D to thereby also simultaneously lock or unlock the door handle assembly 24, and rotation of the keyway 80D to lock or unlock the door handle assembly 24 is likewise transferred to the lock button 50D to thereby simultaneously lock or unlock the door handle assembly 20.

Referring now to FIGS. 10-22B, another embodiment is shown of a door assembly 210 including a pair of selectively interlocking, opposing doors 212, 222. The door assembly 210 is similar in some respects to the door assembly 10 illustrated in FIGS. 1-9C, and like numbers+200 are used to identify like components. In one embodiment, the doors 212, 222 share three common hinge assemblies 216 spaced apart along the length of a door jamb 214A in a conventional manner, although in other embodiments the doors 212, 222 may alternatively share more or fewer common hinge assemblies 216. The door 212 includes a handle assembly 220, and the door 222 includes a separate handle assembly 224. The handle assemblies 220, 224 may be selectively interlocked, i.e., selectively coupled to or engaged with each other, such that the doors 212, 222 are together pivotable about the one or more hinge assemblies 216 between closed and open positions as illustrated by example in the embodiment illustrated in FIGS. 1A, 1B and 4A, 4B respectively and described above. The handle assemblies 220, 224 may also be selectively decoupled or disengaged from each other such that the doors 212, 222 may each be separately pivotable about the one or more hinge assemblies 216 so as to be independently openable and closable as illustrated by example in the embodiment illustrated in FIGS. 3A and 3B and described above.

The door assembly 210, like the door assembly 10 illustrated in FIGS. 1-9C, includes a door jamb mountable in a conventional manner to a door frame of a building structure. The door jamb illustratively includes a hinge-side jamb and a latch-side jamb both coupled to a top jamb, wherein each such jamb may be a separate from the others with all such jambs coupled together in a conventional manner to form the door jamb or wherein two or more such jambs may be of unitary construction. In the embodiment illustrated in FIGS. 10, 12, 13 and 14A-14D, hinge-side and latch-side and top jambs 214A, 214B, 214C respectively of the door jamb are shown coupled together in a conventional manner, and it will be understood that such jambs 214A, 214B, 214 are mountable, affixable or otherwise attachable to conventional door frame components of a building structure as described above with respect to the embodiment 10. The structure 226, like the structure 26 of the embodiment 10 illustrated in the embodiment 10 of FIGS. 1-9C, illustratively represents a sill plate coupled to the floor of the building structure or other floor structure that is part of the building structure which, in any case, also partially defines the doorway of the building structure. In some embodiments, the sill plate 226 is coupled to either or both of the jambs 214A, 214B, although in alternate embodiments the sill plate 226 may be separate from either or both of the jambs 214A, 214B.

In the illustrated embodiment, the door 212 defines a hinge side 212A to which the one or more hinge assemblies 216 is/are mounted, and the door 222 likewise defines a hinge side 222A to which the one or more hinge assemblies 216 is/are mounted. The one or more hinge assemblies 216 is/are also mounted to an inwardly-facing, generally planar, surface 214A2 of the hinge-side jamb 214A. The door 212 further defines a latch side 212B, and at least one conventional door latching component, e.g., at least one latch tongue, of the handle assembly 220 extends therefrom. At least one door latch engaging component, e.g., at least one strike plate 215 (see, e.g., FIG. 12), is mounted, attached or otherwise affixed to at least the latch-side jamb 214B, and the at least one door latching component extending from the door 212 and the at least one strike plate 215 are configured to selectively engage each other in a conventional manner when the door 212 is pivoted about the one or more hinge assemblies 216 to a closed position as illustrated in FIG. 10. Likewise, the door 222 defines a latch side 222B, and at least one conventional door latching component, e.g., at least one latch tongue of the handle assembly 224, extends therefrom. In the illustrated embodiment, the at least one door latch engaging component, e.g., the at least one strike plate 215, is also mounted, attached or otherwise affixed to a latch-side stop 217B coupled to or integral with the latch-side jamb 214B, and the at least one door latching component extending from the door 222 and the at least one strike plate 215 are configured to selectively engage each other in a conventional manner when the door 222 is pivoted about the one or more hinge assemblies 216 to a closed position as illustrated in FIG. 10. All such door latching components and the at least one door latch engaging component are also configured to selectively disengage from each other in a conventional manner, e.g., via conventional actuation of the door handle assemblies 220, 224 respectively, to enable the doors 212, 222 respectively to pivot about the one or more hinge assemblies 216.

The door 212 further defines a first major surface 212C, and a second major surface 212D opposite the first major surface 212C, and the door 222 likewise defines a first major surface 222C and a second major surface 222D opposite the first major surface 222C. The first major surface 212C of the door 212 generally faces the first major surface 222C defined by the door 222, and a space 228 is defined by the door handle assemblies 220, 224 between the first major surfaces 212C, 222C of the doors 212, 222 respectively when the door handle assemblies 220, 224 are interlocked as illustrated in FIGS. 10, 20A and 21A. In the illustrated embodiment, the door 212 is a conventional exterior door, the first major surface 212C of which generally faces the door 222 and the second major surface 212D of which faces an interior of the building, and the door 222 is a conventional storm door, the first major surface 222C of which generally faces the door 212 and the second major surface 222D of which faces an exterior of the building. In some alternate embodiments, the door 212 may represent a conventional storm door and the door 222 may represent a conventional exterior door. In other alternate embodiments, the door 212 may represent any conventional interior, exterior, storm, general purpose or special purpose door, and the door 222 may likewise represent any conventional interior, exterior, storm, general purpose or special purpose door.

The door 212 may be formed of one or more conventional materials, examples of which may include, but are not limited to, wood, composite, plastic, fiber reinforced plastic, metal, any combination the foregoing, any of the foregoing materials as one or more outer shells or skins with an interior core that is hollow or is formed of a conventional material such as foam, plastic, fiber reinforced plastic, or the like. In the illustrated embodiment, which should not be considered limiting in any way, the door 212 is depicted as being a solid-core door made of wood. The door 222 may likewise be formed of one or more conventional materials, examples of which may include, but are not limited to, wood, composite, plastic, fiber reinforced plastic, metal, any combination the foregoing, any of the foregoing materials as one or more outer shells or skins with an interior core that is hollow or is formed of a conventional material such as foam, plastic, fiber reinforced plastic, or the like. As illustrated in FIGS. 14A-14D, which should not be considered limiting in any way, the door 222 is depicted as including a top stile 223A, a bottom stile 223B, a hinge-side stile 223C and a latch-side stile 223D, all coupled together in a conventional manner, wherein the stiles 223A-223D are illustratively hollow-core stiles formed of metal skins. In the illustrated embodiment, the door 222 further illustratively includes a panel 221 surrounded by and coupled to each of the stiles 223A-223D. The panel 223 is illustrated by example as being formed of a transparent material, examples of which may include but are not limited to glass, plexiglass, tempered glass, plastic or the like, although in other embodiments the panel 223 may be or include one or more translucent and/or opaque materials and/or one or more solid and/or other materials which block light or which otherwise does/do not transmit light. It will be understood that while the example door 222 illustrated in FIGS. 14A-14D includes only a single panel 223, alternate embodiments are contemplated which include more or no panels. In some embodiments, as depicted by example in FIG. 10, stile caps 225A and 225B may be mounted, attached or otherwise positioned over the stiles 223C and 223D respectively to prevent moisture ingress into the door 222.

As illustrated most clearly in FIGS. 10, 13, 14A, 14C and 14D, the hinge-side door jamb 214A defines a generally planar surface 214A1 at one end of the side surface 214A2 and another generally planar surface 214A3 at an opposite end of the side surface 214A2, and the latch-side door jamb 214B likewise defines a generally planar surface 214B1 at one end of the side surface 214B2 and another generally planar surface 214B3 at an opposite end of the side surface 214B2. The top door jamb is illustratively identically configured.

The door jamb further illustratively includes a conventional door stop mounted to and about an inner periphery of the door jamb which forms a physical stop and, in some embodiments, a sealing surface for the door 212. As further illustrated by example in FIGS. 10, 13, 14A, 14C and 14D, an inner side of a hinge-side door stop 217A is illustratively affixed to the inner-facing surface 214A2 of the hinge-side door jamb 214A along its length, and an inner side of a latch-side door stop 217B is likewise illustratively affixed to the inner-facing surface 214B2 of the hinge-side door jamb 214B. A generally planar outer side surface 217A2 of the hinge-side door stop 217A faces inwardly toward the door stop 217B, and a generally planar end surface 217A1 extends between the inner side surface and the outer side surface 217A2 of the stop 217A between, and generally parallel with, the end surfaces 214A1 and 214A3 of the hinge-side jamb 214A. A generally planar opposite end surface 217A3 of the hinge-side stop 217A is, in the illustrated embodiment, flush with the end surface 214A3 of the hinge-side jamb 214A, although in alternate embodiments the end surface 217A3 may extend beyond the end surface 214A3 or vice versa. The latch-side door stop 217B is illustratively configured identically to the hinge-side door stop 217A with corresponding surfaces 217B1, 217B2 and 217B3, and a corresponding top-side door stop 217C is illustratively identically configured as just described. The end surfaces 217A1 and 217B1 of the hinge-side stop 217A and the latch-side stop 217B, as well as the corresponding end surface of the top-side stop 217C, are sized to extend inwardly of the door jamb 214A, 214B, 214C and over a portion of the major surface 212C of the door 212 along the sides 212A and 212B and the top thereof to act as a conventional physical stop to the door 212 as it is moved from its open position to its closed position. In some embodiments, a conventional sealing material, e.g., foam, plastic, rubber, etc., may be attached or affixed to and along the end surfaces 217A1, 217B1 of the hinge-side and latch-side stops 217A, 217B respectively, as well as the corresponding end surface of the top-side stop, to form a seal between the major surface 212C of the door 212 and such stop surfaces when the door 212 is closed as illustrated in FIG. 10.

As with the embodiment depicted in FIGS. 1A-9C, the doors 212, 222 pivot in the same direction about the one or more hinges 216, and the doors 212, 222 therefore each open and close in the same direction. In this regard, some embodiments of the door assembly 210 further illustratively include a second door stop mounted to and about an inner periphery of the door jamb to form a physical stop and, in some embodiments, a sealing surface for the door 222. As illustrated by example in FIGS. 10, 13, 14A, 14C and 14D, an inner side of a second hinge-side door stop 219A is illustratively attached or affixed to the inner-facing surface 217A2 of the hinge-side door stop 217A along its length between its two ends 217A1 and 217A3, and an inner side of a latch-side door stop 219B is likewise illustratively affixed to an inner-facing surface 217B2 of the hinge-side door stop 217B along its length between its two ends 217B1 and 217B3. A generally planar outer side surface 219A2 of the hinge-side door stop 219A faces inwardly toward the door stop 219B, and generally planar and opposing end surfaces 219A1 and 219A2 extend between the inner side surface and the outer side surface 219A2 of the stop 219A. The latch-side door stop 219A is illustratively configured identically as just described with corresponding surfaces 219B1, 219B2, 219B3, as is the corresponding top door stop 219C. In the illustrated embodiment, the end surfaces 219A3, 219B3 of the stops 219A, 219B respectively are generally parallel with the end surfaces 214A3, 214B3 of the hinge-side and latch-side jambs 214A, 214B and also with the end surfaces 217A3, 217B3 of the hinge-side and latch-side stops 217A, 217B, as is the corresponding end surface of the top stop 219C, as depicted in FIGS. 13, although in alternate embodiments the end surface 19A3 may extend beyond the end surfaces 214A3 and/or 217A3 or vice versa as depicted in FIG. 10.

The end surface 219A1 of the hinge-side stop 19A, as well as the corresponding end surface 219B1 of the latch-side stop 219B and the corresponding end surface of the top-side stop 219C, are sized to extend inwardly of the door jamb and over a portion of the major surface 222D of the door 222 along the sides 222A and 222B and the top thereof to act as a conventional physical stop to the door 222 as it is moved from an open position to its closed position, e.g., as illustrated in FIG. 10. In some embodiments, a conventional sealing material, e.g., foam, plastic, rubber, etc., may be attached or affixed to and along the end surface 219A1 of the hinge-side stop 219A, as well as the corresponding end surface 219B1 of the latch-side stop 219B and the corresponding end surface of the top-side stop, to form a seal between the major surface 222D of the door 222 and such stop surfaces when the door 222 is closed as illustrated in FIG. 10.

In some embodiments, as illustrated in FIGS. 10, 12-14A, 14C and 14D, the side jambs 214A, 214B and the top jamb 214C, are each separate components coupled together in a conventional manner, although in some alternate embodiments at least two such jamb components may be integral and of unitary construction, and in other alternate embodiments all three such jamb components are integral and of a single unitary construction. Likewise, the side stops 217A, 217B and the top-side stop 217C, are each illustratively separate components coupled together in a conventional manner, although in some alternate embodiments at least two such stop components may be integral and of unitary construction, and in other alternate embodiments all three such stop components are integral and of a single unitary construction. Further still, the side stops 219A, 219B and the top-side stop 219C are likewise each illustratively separate components coupled together in a conventional manner, although in some alternate embodiments at least two such stop components may be integral and of unitary construction, and in other alternate embodiments all three such stop components are integral and of a single unitary construction. In still other alternate embodiments the jamb components 214A-214C and the stop components 217A-217C may be integral and of a single unitary construction, and the stop components 219A-219C may be separate pieces mounted, affixed or otherwise attached to the unitary structure, and in yet further alternate embodiments all jamb components 214A-214C and all stop components 217A-217C and 219A-219C may be integral and of a single unitary construction. In any case, it will be appreciated that the common pivoting direction of the doors 212, 222, along with the door jamb and stop combination just described, advantageously provides for double sealing of the door assembly relative to the door jamb, which feature is generally not attainable in conventional storm door applications in which the storm door opens and closes in directions opposite to the opening and closing directions of the main or exterior door.

Referring now specifically to FIG. 11, an embodiment of one of the one or more hinge assemblies 216 is shown. In the illustrated embodiment, the hinge assembly 216 is identical in many respects to the hinge assembly 16 illustrated in FIGS. 2A-2B, such that the hinge assembly 216 includes three separate butt hinges 230, 232A and 232B inter-engaged by a hinge pin 238 extending through axially aligned knuckles associated with each hinge 230, 232A, 232B. As with the hinge, 30, the hinge 230 has three integral, planar hinge plate sections or portions 30A, 30B, 30C and a number of axially aligned knuckles at a terminal end of the hinge plate section 230C. Planes defined by the planar hinge plate sections 230A and 230C are illustratively parallel with each other, and a plane defined by the planar hinge section 230B joining the hinge plate sections 230A, 230C is illustratively perpendicular with the planes defined by the planar hinge plate sections 230A, 230C. The dimensions of the hinge plate sections 230A, 230B, 230C are illustratively configured complementarily to corresponding portions of the surfaces 217A2, 217A1 and 214A2 respectively of the hinge-side jamb 214A and stop 217A.

The hinge 232A defines a planar hinge plate 234A and a number of axially-aligned knuckles along one side thereof, and the hinge 232B likewise defines a planar hinge plate 234B and a number of axially-aligned knuckles along one side thereof. The axially-aligned knuckles of each hinge 230, 232A, 232B interdigitate as illustrated and the hinge pin 238 extends through each to couple the hinges 230, 232A, 232B together such that they all pivot or rotate about the longitudinal axis defined centrally through the hinge pin 238. The hinges 230, 232A, 232B each define a number of passageways 230D, 233, 235 respectively therethrough via which the hinges 230, 232A, 232B are mounted or attached, e.g., via conventional fixation members such as screws or the like, to the hinge sides of the door, 222, the hinge side of the door 212 and the hinge side 214A2 of the jamb 214A respectively. The hinge plate section 230C, unlike the hinge plate section 30C of the hinge 30, is solid.

As illustrated by example in FIG. 10, and unlike the door assembly 10 illustrated in FIGS. 1A-9C, the door 222 is illustratively sized such that the hinge side 222B is spaced apart from the inwardly-facing surface 217A2 of the door stop 217A. This additional spacing is illustratively provided to accommodate the combined thicknesses of the three hinges 230, 232A, 232B when forced together when both of the doors 212, 222 are closed as shown. In alternate embodiments, the one or more hinge assemblies 16 illustrated in FIGS. 2A and 2B may be used in place of the one or more hinge assemblies 216, and in such embodiments the door 222 may be sized as described above with respect to the door 22. In any case, the doors 212, 222 of the door assembly 210 are illustratively configured to open and close together and separately as described above with respect to the door assembly 10 illustrated in FIGS. 1A-4B.

Referring now to FIG. 12, an embodiment of the at least one door latch engaging component 215 is illustrated. In the embodiment depicted in FIG. 12, the at least one door latch engaging component 215 is illustratively provided in the form of a single, unitary strike plate mountable to the inwardly-facing surface 214B of the latch-side jamb 214B and also to the inwardly-facing surface 217B2 of the door stop 217B. The strike plate 215 illustratively includes a first generally planar plate section 215A defining a latch tongue opening 215D therethrough that is sized to receive the latch tongue 246 of the door handle assembly 220 (see, e.g., FIG. 15). The plate section 215A is illustratively sized and configured to be received on and secured to the inwardly-facing surface 214B2 of the latch-side jamb 214B, e.g., via one or more conventional fixation members passed through one or more corresponding bores defined through the plate section 215A, e.g., two such bores shown in FIG. 12 defined through the plate section 215A above and below the latch tongue opening 215D. Illustratively, the inwardly-facing surface 214B2 of the latch-side jamb 214B is mortised in a conventional manner to provide a guide for mounting and positioning the plate section 215A to and relative to the latch-side jamb 214B, to allow the exposed major surface of the plate section 215A to be mounted flush with the inwardly-facing surface 214B2 of the latch-side jamb 214B and to provide a passageway of sufficient depth to allow for appropriate penetration of the latch tongue 246 through the latch tongue opening 215D. In some embodiments, the latch plate section 215A includes a flange 215F along the end of the plate 215A that is adjacent to the end surface 214B1 of the latch-side jamb 214B to act as a guide for guiding the latch tongue 246 toward the latch tongue opening 215D. In embodiments which include the flange 215F, the flange 215F may illustratively be angled toward the end surface 214B1 of the latch-side door jamb 214B, e.g., at an acute angle relative to the substantially right-angled surfaces 214B1 and 214B2 of the latch-side jamb 214B.

The strike plate 215 further illustratively includes a second generally planar plate section 215B defining a latch tongue opening 215E therethrough that is sized to receive the latch tongue 246′ of the door handle assembly 224 (see, e.g., FIG. 15). The plate section 215B is illustratively sized and configured to be received on and secured to the inwardly-facing surface 217B2 of the latch-side door stop 217B, e.g., via one or more conventional fixation members passed through one or more corresponding bores defined through the plate section 215B, e.g., two such bores shown in FIG. 12 defined through the plate section 215B above and below the latch tongue opening 215E. Illustratively, the inwardly-facing surface 217B2 of the latch-side door stop 217B is mortised in a conventional manner to provide a guide for mounting and positioning the plate section 215B to and relative to the latch-side door stop 217B, to allow the exposed major surface of the plate section 215B to be mounted flush with the inwardly-facing surface 217B2 of the latch-side door stop 217B and to provide a passageway of sufficient depth to allow for appropriate penetration of the latch tongue 246′ through the latch tongue opening 215E. In some embodiments, the latch plate section 215B includes a downwardly extending flange 215G along the lower end of the plate 215B to act as a support for supporting the plate section 215B on the latch-side door stop 217B. In embodiments which include the flange 215G, the flange 215G may illustratively be angled toward the surface 217B2 of the latch-side door stop 217B, e.g., at an oblique angle relative to the exposed major surface of the plate section 215B. In other embodiments, the flange 215G may be omitted.

In the illustrated embodiment, the plate sections 215A, 215B are joined by a generally planar plate section 215C extending between the adjacent ends of the plate sections 215A, 215B and at a substantially right angle relative to each such that, when the plate section 215A is mounted to the latch-side jamb 214B and the plate section 215B is mounted to the latch-side door stop 217B, the plate section 215C abuts the end section 217B1 of the latch-side door stop 217B. In some embodiments, the portion of the surface 217B1 of the latch-side door stop 217 which the plate section 215C abuts may be mortised to accommodate flush mounting thereof, although in other embodiments the portion of the surface 217B1 of the latch-side door stop 217 which the plate section 215C abuts may not be mortised. In the illustrated embodiment, the plate sections 215A, 215B and 215C are integral such that the entire strike plate 215 is of unitary construction. In other embodiments, only one of the plate sections 215A, 215B may be integral and unitarily constructed with the plate section 215C and the remaining plate section may be mounted, affixed or otherwise attached thereto, and in still other embodiments each of the plate sections 215A, 215B, 215C may be separate components which are mounted, affixed or otherwise attached together as illustrated in FIG. 12. In any case, it will be appreciated that such a single latch plate 215 sized to accommodate both latch tongues 246, 246′ and mounted to both of the latch-side jamb 214B and the latch-side door stop 217B advantageously provides a number of advantages over separate latch plates as illustrated in FIG. 4A. For example, such a single latch plate 215 provides for increased strength over such separate latch plates, and thus provides an attendant increase in security of the door assembly 210, e.g., against intruders. As another example, horizontal and vertical alignment of the latch tongue openings 215D, 215E are preset with the single latch plate 215, thereby eliminating or at least reducing manual alignment of the latch tongue openings 215D, 215E with the corresponding latch tongues 246, 246′. Notwithstanding such advantages, it will be understood that, in some alternate embodiments, separate latch plates, e.g., such as the latch plates 15A, 15B illustrated in FIG. 4A, may be used in place of the single latch plate 215 just described.

Referring now to FIGS. 13 and 14A-14D, FIG. 13 depicts a perspective view of the door jamb assembly in its entirety including the door jamb components 214A, 214B and 214C, the door stop components 217A, 217B and 217C, the door stop components 219A, 219B and 219C as described above, as well as three of the hinge assemblies 216 spaced apart and mounted to the latch-side jamb 14A. Whereas the doors 212 and 222 have been omitted from FIG. 13 so as not to obscure the illustrated door jamb assembly, the door 222 is included in the cross-sectional views of FIGS. 14A and 14B, as if it was included in FIG. 13, to illustrate another feature of the door assembly 210. As described above, the door 222 in the embodiment depicted in FIGS. 14A-14D is illustrated as including hollow-core top, bottom, hinge-side and latch-side stiles 223A-223D respectively, all coupled together in a conventional manner with a panel 221 surrounded by and coupled to each of the stiles 223A-223D about its periphery.

Referring now specifically, to FIG. 14B, a magnified view of the bottom stile 223B of the door 222 is shown. In the illustrated embodiment, the bottom stile 223B includes a pair of opposed and spaced-apart sides or skins 223B₁ and 223B₂ joined together at a top of the stile 223B by a top wall or skin 223B₃. A free bottom end 223B₅ of the side 223B₁ and a free bottom end 223B₆ of the side 223B₂ are spaced apart laterally, and in some embodiments a laterally extending wall 223B₄ joins the opposed inner surfaces of the two sides 223B₁, 223B₂ between the top wall or skin 223B₃ and the free ends 223B₅, 223B₆ of the sides 223B₁, 223B₂ respectively to form an elongated channel 223B_{C} between the lateral wall 223B₄ and the free ends 223B₅, 223B₆ of the sides 223B₁, 223B₂ which extends longitudinally along the length of the stile 223B. It other embodiments, the stile 223B may not include the lateral wall 223B₄, and in such embodiments the channel 223B_{C} may be defined between the top wall 223B₃ and the free ends 223B₅, 223B₆ of the sides 223B₁, 223B₂. In any case, an elongated sweep 229 is received within the channel 223B_{C} such that the sweep 229 is vertically movable within and relative to the channel 223B_{C} along the length of the stile 223B. In the illustrated embodiment, the sweep 299 is illustratively a hollow structure bound by opposing side and top walls which are configured complementarily to the shape of the channel 223B_{C}, and illustratively bound by a substantially planar bottom wall 229A. The cross-sectional shape of the channel 223B_{C} is, in the illustrated example, an inverted U-shape with defined corners at the top of the U, and the opposing side and top walls of the elongated sweep are complementarily shaped to be received and vertically movable within and relative to the channel 223B_{C}, although in other embodiments the channel 223B_{C} and the elongated sweep 229 may take on other complementary cross-sectional shapes. In any case, the top wall of the sweep 229 illustratively defines a bore or channel 229B sized to receive and engage a conventional fixation member, e.g., a screw or the like. In some embodiments, the bore or channel 229B runs along the length of the top wall of the sweep 229, although in other embodiments separate bores or channels 229B may be provided only at or adjacent to each end of the stile 223B which defines a portion of a respective side 222A, 222B of the door 222. In the illustrated embodiment, the exposed outer (bottom) surface of the bottom wall 229A defines another bore or channel 229C which runs along the length of the bottom stile 223B. A top surface of an elongated, flexible seal member 231 is configured to be received within and along the channel 229C, and a bottom surface of the flexible seal member 231 is illustratively configured to contact and form at least a partial seal with the top surface 226_{T} of the sill plate 226 when the door 222 is closed. In one embodiment, the flexible sealing member 231 is provided in the form of a conventional fiber brush, although in alternate embodiments the flexible sealing member 231 may be additionally or alternatively formed of one or more other conventional flexible sealing materials.

The sill 226 is illustratively shown in FIG. 14B in the form of a conventional solid wood sill plate 226, which is or will be mounted to the floor of the building structure in which the door assembly 210 is installed, with a conventional elongated plastic dam 227 mounted, affixed or otherwise attached to the top surface 226_{T} of the sill plate 226 along its length such that, when closed, the bottom edge of the door 212 is positioned above the dam 227 along its length. In some embodiments, a conventional sealing material, e.g., foam, plastic, rubber, etc., may be attached or affixed to and along the bottom surface of the door 212 to form a seal between the bottom surface of the door 212 and the top surface of the dam 227.

In some alternate embodiments, the sill plate 226 may be formed of a solid core, e.g., wood or composite material, capped by a metal skin, and in other alternate embodiments the sill plate 226 may be formed of a hollow or filled-core composite material which may or may not be capped by a metal skin. The dam 227 may likewise alternatively be formed of a solid core capped by a metal skin or of a hollow or filled-core composite material which may or may not be capped by a metal skin. In some embodiments, as illustrated in FIG. 14B, the sill plate 226 and the dam 227 are separate components which are subsequently attached, affixed or otherwise joined together in a conventional manner, and in other embodiments the sill plate 226 and the dam 227 may be integral and of unitary construction.

As described above, the flexible seal member 231 is illustratively provided to contact the top surface 226_{T} of the sill 226 and, together with the sweep 229, to form at least a partial seal with and between the bottom surface of the stile 223B and the top surface 226_{T} of the sill 226 when the door 222 is closed. However, as also described above and as illustrated in FIG. 14B, the door 222 is configured to open inwardly, and as such it is desirable that the bottom edge or surface of the stile 223B be positioned relative to the sill 226 such that it clears the dam 227 when the door 222 is opened and also such that the flexible seal member 231 contacts, and illustratively forms at least a partial seal with, the top surface 226_{T} of the sill plate 226 when the door 222 is closed. Moreover, it is contemplated that the door 222 may be implemented with various different sills 226 in which the height of the top surface of the dam 227 above the top surface 226_{T} of the sill plate 226 may vary. In this regard, the vertical position of the elongated sweep 229 within the channel 223B_{C} defined in the bottom stile 223B is configured to be adjustable to a position in which the bottom surface of the sweep 229 and/or the bottom ends 223B₅, 223B₆ of the bottom stile 223B clears the top surface 227 of the dam when and as the door 222 is opened and in which at least the bottom edge of the flexible seal member 231 contacts the top surface 226_{T} of the sill plate 226 when the door 222 is in its closed position so that the flexible seal member 231 forms at least a partial seal with and between the top surface 226_{T} of the sill 226 and the bottom surface of the sweep 229 and/or the bottom surface of the stile 223B.

Referring now to FIGS. 14C and 14D, an elongated sweep position adjustment plate 233 is provided with a through hole 233A at or near one end thereof and an elongated through slot 233B at or near an opposite end thereof, wherein a longitudinal axis of the slot 233B is illustratively parallel with a longitudinal axis of the elongated plate 233. Illustratively the plate 233 is a flat and substantially planar plate sized to be received over and in contact with the side 222B of the door inboard of, or flush with, the major surfaces of the stile 223D. In the illustrated embodiment, it will be understood that the elongated channel 223B_{C}, the elongated sweep 229 and the elongated flexible seal member 231 each run through and along the length of the bottom stile 223B but also in the same direction through the stiles 223C and 223D along the bottom edges thereof. In any case, as illustrated in FIG. 14C, a conventional fixation member 235A, e.g., a screw or the like, is passed through the through hole 233A of the sweep position adjustment plate 233 and into engagement with the channel 229C of the sweep 229 to secure the sweep adjustment plate 233 to the sweep 229. Another conventional fixation element 235B, e.g., a screw or the like, is passed through the slot 233B and into the side 222B of the door 222 but not fully tightened against the plate 233. Another such sweep position adjustment plate 233 is then attached to opposite end of the sweep 229 and to the opposite side 222A of the door 222 as just described. The vertical position of the elongated sweep 229 within the elongated channel 223B_{C} is then manually adjusted by moving the plates 233 along the channels 233B relative to the fixation members 235A to a position in which the bottom edge of the sweep 229 clears the dam 227 when and as the door 222 is opened and in which at least the bottom edge of the flexible seal member 231 contacts the top surface 226_{T} of the sill plate 226 when the door 222 is closed, and the fixation members 235A are then tightened against the plates 233 to secure the plates 233 to the sides 222A, 222B of the door 222 with the elongated sweep 229 in its adjusted position.

Referring now to FIG. 15, an exploded view of the door assembly 210 is shown illustrating embodiments of each of the door handle assemblies 220, 224 as well as embodiments of latch assemblies 240, 240′ and embodiments of interlockable deadbolt assemblies 350, 370 mounted to each of the doors 212, 222 respectively. In the illustrated assembly, the door 212 defines a cylindrical opening or face bore 212E therethrough, i.e., defined through the first and second major surfaces 212C, 212D of the door 212, adjacent to the latch side 212B, and another cylindrical opening or side bore 212F therein which opens to the face bore 212E. A conventional latch assembly 240 includes an elongated latch case 242 coupled to a latch plate 244 from which a latch tongue 246 extends. The elongated latch case 242 is illustratively sized to be received within the side bore 212F with at least a portion of the latch case 242 extending into the face bore 212E and the latch plate 244 abutting the latch side 212B of the door 212. In some embodiments, the latch side 212B of the door may be mortised to receive the latch plate 244 therein. The latch case 242 illustratively defines a bore 243 therethrough sized to receive therethrough a cam 252A of the door handle assembly 220. The latch case 242 and/or a leverset 250 of the door handle assembly 220 illustratively carries one or more conventional biasing components such that the latch tongue 246 is normally biased outwardly from the latch plate 244, e.g., as illustrated in FIG. 15, so that it engages and is captured by the latch tongue opening 215D of the strike plate 215 (see, e.g., FIG. 12), and such that axial rotation of the cam 252A causes the latch tongue 246 to be drawn inwardly toward and within the latch case 242 so that it disengages from the latch tongue opening 215D of the strike plate 215 to allow the door 212 to be pivoted via the hinge assembly 216 between open and closed positions thereof. In embodiments in which the door handle assembly 220 is lockable, as illustrated in FIGS. 16B and 19, the bore 243 also receives therethrough a spindle 252B carried by the cam 252A. Rotation of the spindle 252B about its longitudinal axis actuates conventional components within the leverset 250 between locked and unlocked positions in a conventional manner. For example, when the spindle 252B is rotated to an unlocked position, conventional components within the leverset 250 allow rotation of the cam 252A within the bore 43 to cause the latch tongue 246 to be drawn inwardly within the latch case 242 as described above. When the spindle 252B is rotated to a locked position, conventional components within the leverset 250 prevent rotation of the cam 252A, thereby preventing the cam 252A from drawing the latch tongue 246 inwardly within the latch case 242 such that the latch tongue 246 remains engaged with the strike plate 215. It will be understood that this disclosure contemplates alternate embodiments in which the handle assembly 220 is not lockable, and in such embodiments the spindle 252B may be omitted. In embodiments in which the handle assembly 220 is lockable as just described, the combination of the door handle assembly 220 and the latch assembly 240 may generally be termed a “lockset.”

The door 22 illustratively likewise defines a cylindrical opening or face bore 222E therethrough, i.e., defined through the first and second major surfaces 222C, 222D of the door 222, adjacent to the latch side 222B, and another cylindrical opening or side bore 222F therein which opens to the face bore 222E. A conventional latch assembly 240′ includes the same components as described above with respect to the latch assembly 240, and the latch case 242′ of the latch assembly 240′ is received within the side bore 222F and face bore 222E. In the illustrated embodiment, the latch assembly 240′ further illustratively includes a latch plate extension 245 which receives the latch assembly 240′ therethrough and the latch plate 244′ therein and mounts to the latch side 222B of door 222 to move the position of the latch tongue 246′ toward the strike plate 215. Illustratively, the thickness of the latch plate extension is configured consistently with the width of the door 222 as described above to accommodate and compensate for the thickness of the at least one hinge assembly 216. In any case, the latch assembly 240′ is operable generally as described above with respect to the latch assembly 240 such that the latch tongue 246′ of the latch assembly 40′ is normally biased outwardly from the latch plate 244′ (and the latch plate extension 245), e.g., as illustrated in FIG. 15, via one or more conventional biasing components carried by the latch case 242′ and/or a leverset 280 of the door handle assembly 224 so that it engages and is captured by the latch tongue opening 215E of the strike plate 215 (see, e.g., FIG. 12), and such that axial rotation of a cam 282A received through the bore 243′ causes the latch tongue 246′ to be drawn inwardly toward and within the latch case 242′ so that it disengages from the latch tongue opening 215E of the strike plate 215 to allow the door 222 to be pivoted relative to the hinge assembly 216 between open and closed positions thereof. In embodiments in which the door handle assembly 224 is lockable, as illustrated in FIGS. 17B and 19, the bore 243′ also receives therethrough a spindle 282B carried by the cam 282A. Rotation of the spindle 282B about its longitudinal axis actuates conventional components within the leverset 280 between locked and unlocked positions in a conventional manner as described above. It will be understood that this disclosure contemplates alternate embodiments in which the handle assembly 224 is not lockable, and in such embodiments the spindle 282B may be omitted. In embodiments in which the handle assembly 224 is lockable as just described, the combination of the door handle assembly 224 and the latch assembly 240′ may generally be termed a “lockset.”

Referring generally now to the right sides of FIGS. 15 and 19 and to FIGS. 16A-16B, the door handle assembly 220 includes a leverset 250 having handle 250A rotatably coupled to a rosette 250B. Generally, the handle 250A may be or include any structure or combination of structures rotatably coupled to the rosette 250B. In the illustrated embodiment, for example, the handle 250A is provided in the form of a conventional lever rotatable relative to the rosette 250B. In alternate embodiments, the handle 250A may be provided in the form of a knob or other structure rotatable relative to the rosette 250B, and in such embodiments the leverset 250 may be alternately referred to as a “handleset.” The leverset 250 further includes a cam 252A rotatably coupled to the handle 250A such that the cam 252A rotates with the handle 250A about a rotational axis and such that the cam 252A and the handle 250A rotate together relative to the rosette 250B. In embodiments in which the door handle assembly 220 is lockable, the handle 250A illustratively defines a central bore 250C sized to receive therein a rotatable shaft 250E having one end coupled to a locking button 250D carried by the handle 250A and an opposite end coupled to one end of the spindle 252B, and in such embodiments an axis extending centrally through the bore 250C defines the rotational axis of the handle 250A, cam 252A and spindle 252B. In such embodiments, rotation of the locking button 250D rotates the shaft 250E and spindle 252B relative to and independently of the handle 250A, cam 252B and rosette 250B, and rotation of the spindle 252B likewise rotates the shaft 250E and the locking button 250D relative to and independently of the handle 250A, cam 252B and rosette 250B.

The leverset 250 is mounted to the door 212 with the rosette 250B abutting the major surface 212D of the door 212 about the face bore 212E and with the cam 252A extending into the face bore 212E and through the bore 243 defined through the latch case 242 of the latch assembly 240. In embodiments which include it, the spindle 252B likewise extends with the cam 252A into the face bore 212E and further extends through the bore 243 defined through the latch case 242 of the latch assembly 240, as described above. A lock receiver 256 is illustratively affixed to or integral with one end of a lock receiver spindle 254, and the opposite end of the lock receiver spindle 254 is coupled to the spindle 252B carried by the cam 252A such that the lock receiver 256 rotates with the spindle 252B. In the illustrated embodiment, the cam 252A is illustratively provided in the form of an elongated hollow tube illustratively having a square, rectangular or other cross-sectional shape configured to cause one or more components receiving the cam 252A therein or received within the cam 252A to rotate with the cam 252A and vice versa. The spindle 252B is illustratively provided in the form of an elongated structure having a flat and square or rectangular or other cross-sectional shape configured to cause one or more components receiving the spindle 252B therein to rotate with the spindle 252B and vice versa. In the illustrated embodiment, the lock receiver spindle 254 illustratively defines a channel therein configured complementarily to the shape of the spindle 252B such that the spindle 252B is rotatably coupled to the lock receiver spindle, and thus to the lock receiver 256, when the spindle 252B is received within the channel defined in the lock receiver spindle 254. In such embodiments in which the door handle assembly 220 is lockable, the locking button 250D, rotatable shaft 250E, spindle 252B, lock receiver spindle 254 and lock receiver 256 are together rotatable relative to the door handle 250A between an unlocked position in which the spindle 252B and/or the rotatable shaft 250E and/or the locking button 250D cooperates with components within the leverset 250 to allow rotation of the cam 252A via the door handle 250A to operate the latch tongue 246 as described above, and a locked position in which the spindle 252B and/or the rotatable shaft 250E and/or the locking button 250D cooperates with components within the leverset 250 to prevent rotation of the cam 252A such that the handle 250A is prevented from rotating to operate the latch tongue 246. As also described above, the door handle assembly 220 may not include a locking feature in some embodiments, and in such embodiments the locking button 250D, the rotatable shaft 250E, the spindle 252B, the lock receiver spindle 254 and the lock receiver 56 may be omitted.

The remainder of the handle assembly 220 is similar in many respects to the handle assembly 20 illustrated in FIGS. 1A-9C and described above. For example, a cylindrical chassis 258 is similar to the chassis 58 described above and defines an outer periphery sized to be received within the face bore 212E defined through the door 212. The chassis 258 further illustratively defines a lip at one end thereof which abuts the first major surface 212C of the door 212 when the chassis 258 is received within the face bore 212E. The chassis 258 is illustratively affixed to the rosette 250B of the leverset 250 through the face bore 212E, e.g., via one or more conventional fixation members (not shown in FIG. 15). The chassis 258 and the rosette 250B are thus each fixed in position relative to the door 212 such that neither the rosette 250B nor the chassis 258 rotates with the handle 250A, shaft 250E, cam 252A, lock receiver spindle 254 or lock receiver 256. In the illustrated example, the chassis 258 defines a channel longitudinally along the outer periphery thereof that is sized to receive the latch case 242 transversely therethrough. In some embodiments, the channel is sized to engage the latch case 242 such that the latch case 242 prevents the chassis 258 from rotating within and relative to the face bore 212E.

The chassis 258 further illustratively defines a recessed plate inwardly of the radial lip, and the plate defines an opening centrally therethrough that is sized to receive the lock receiver 256 and lock receiver spindle 254 therethrough. Between the end of the chassis 258 adjacent to the radial lip and the recessed plate, the chassis 258 defines a cylindrical pocket sized to receive a cylindrical magnet housing 264 therein that is similar to the cylindrical magnet housing 64 described above. The cylindrical magnet housing 264 defines a cylindrical body portion having an outer diameter sized to be received within the pocket of the chassis 258 and to be rotatable within the pocket relative to the chassis 58. A cylindrical shaft extends axially away from the body portion and the shaft has an outer diameter sized to be received within and through the opening defined through the chassis. The body defines a bore centrally therethrough, and the shaft likewise defines an aligned bore centrally therethrough, wherein the axes of the two bores are aligned and the diameter of the bore through the shaft is less than that of the bore through the body. The bore through the body of the magnet housing 264 is sized to receive the lock receiver 256 and the lock receiver spindle 254 therein such that the lock receiver 256 is rotatable relative to the bore through the body, and the bore through the shaft is sized to receive the lock receiver spindle 254 but not the lock receiver 256 therein. The bore through the shaft is shaped complementarily to that of the cam 252A to that the magnet housing 264 axially rotates with the cam 252A about the cylindrical pocket defined by the chassis 258 as illustrated in FIG. 16B.

Distributed about the body portion of the magnet housing 264 between the outer diameter of the body portion and the lock receiver 256, the body portion defines a plurality of bores therein such that central axes of such bores are parallel with the central axes of the bores defined centrally through the magnet housing 264. Each of the magnet bores is illustratively sized to receive therein a different one of a corresponding plurality of cylindrically-shaped magnets 268 each defining a planar face oriented in a direction facing away from the magnet housing 264. A rear surface of the body portion of the magnet housing 264 defines a pair of opposing arcuate slots each sized to receive an arcuate-shaped metal plate 265A, 265B therein. The arcuate plates 265A, 265B illustratively operate to hold the magnets 268 within the magnet bores. A cylindrical cover plate 270 is received over and engages the exposed terminal face of the body portion of the magnet housing 264. The cover plate 270 illustratively defines a bore 270A centrally therethrough that aligns with the bores defined centrally through the magnet housing 264 and the chassis 258, and the bore 270A is sized to receive the lock receiver 256 therein and expose the lock receiver 256 therethrough. In the illustrated embodiment, the terminal face of the cover plate 270 is solid such that it covers the faces of the magnets 268, although in alternate embodiments the magnet cover 270 may define openings therethrough aligned with the magnets 268 as described with respect to the embodiment 10 illustrated in FIGS. 1A-9C. In any case, the magnet housing 264, magnets 268, metal plates 265A, 265B and cover plate 270 together illustratively define a magnet assembly 274 which is coupled to the door handle 250A via the cam 252A and which rotates with the handle 250A and cam 252A within and relative to the chassis 258.

In the illustrated embodiment, the plurality of magnets 268 illustratively include four magnets 268 equally spaced about the periphery of the lock receiver 256 as illustrated in FIG. 16A. Alternatively, the magnet assembly 274 may be configured to include more or fewer magnets, e.g., such that the total number of magnets is one or more. In embodiments which include two or more magnets 268, such magnets may be equally or non-equally spaced about the lock receiver 256, equally or non-equally spaced only partially about the lock receiver 256, or equally and/or non-equally spaced individually and/or in sub-groups about or partially about the lock receiver 256. In any of the foregoing embodiments, each of the one or more magnets 268 may be a conventional permanent magnet. Alternatively or additionally, the one or more magnets 268 may be or include one or more conventional programmable magnets each having programmable magnetic polarities and/or magnetic field strengths and/or each having two or more zones in which the magnetic polarity and/or magnetic field strength is programmable in a conventional manner. In one example such embodiment, which should not be considered to be limiting in any way, a single programmable magnet 268 may be used and programmed in a conventional manner to define at least two magnetic zones having opposite magnetic polarities, and in one specific example, a single programmable magnet 268 may be used and programmed in a conventional manner to define multiple magnetic zones distributed radially about an exposed surface thereof with each zone having a magnetic polarity opposite to the magnetic polarities of adjacent zones.

In embodiments that include the lock receiver 256, the locking end 256A of the lock receiver 256 exposed through the opening 270A is illustratively configured, e.g., keyed, to rotatably engage a locking protrusion carried by the door handle assembly 224, i.e., to couple to the locking protrusion carried by the door handle assembly 224 such that the locking protrusion and the lock receiver 256 rotate together in response to rotation of one or the other. An example configuration of the locking end 256A of the lock receiver 256 is illustrated in the perspective view of FIG. 16A and, in some embodiments, is identical to the locking end 56A of the lock receiver 56.

As described above, the rosette 250B of the leverset 250 and the chassis 258 of the door handle assembly 220 are illustratively coupled to each other and both fixed in position relative to the door 212, whereas the door handle 250A, cam 252A and magnet assembly 274 are rotatable together relative to the rosette 250B, chassis 258 and door 212. In embodiments that include them, the locking button 250D, rotatable shaft 250E, spindle 252B, lock receiver spindle 254 and lock receiver 256 are rotatable together relative to the chassis 258, rosette 250B and door 212, as well as relative to the door handle 250A, cam 252A and magnet assembly 274, to lock and unlock the door handle assembly 220 as also described above.

Referring still generally to the right side of FIG. 15, the deadbolt assembly 350 illustratively includes a rosette 360 to which a deadbolt locking lever 362 is rotatably coupled, a lock receiver cup 364 to which a deadbolt lock receiver 366 is rotatably coupled and a conventional deadbolt latch assembly 352. In the illustrated assembly, the door 212 defines another cylindrical opening or face bore 212G therethrough, i.e., defined through the first and second major surfaces 212C, 212D of the door 212, adjacent to the latch side 212B, and another cylindrical opening or side bore or passageway 212H therein which opens to the face bore 212G. The deadbolt latch assembly 352 includes an elongated latch case 354 coupled to a latch plate 356 from which a deadbolt 358 extends. The elongated latch case 354 is illustratively sized to be received within the side bore or passageway 212H with at least a portion of the latch case 354 extending into the face bore 212G and the latch plate 356 abutting the latch side 212B of the door 212. In some embodiments, the latch side 212B of the door may be mortised to receive the latch plate 356 therein. The latch case 354 is illustratively conventional and defines a bore therethrough sized to receive therethrough a cam extending from the deadbolt locking lever 362. The latch case 354 is operable in a conventional manner to extend the deadbolt 358 therefrom and into engagement with a deadbolt opening in a deadbolt strike plate suitable mounted to the latch-side jamb 214A when the deadbolt locking lever 362 is rotate in one direction, and to withdraw the deadbolt 358 from the deadbolt opening in the deadbolt strike plate when the deadbolt locking lever 362 is rotated in the opposite direction.

The rosette 360 is mounted to and through the face bore 212G with at least an outer periphery of the rosette 360 abutting the major surface 212D of the door 212 about the face bore 212G and with the cam of the deadbolt locking lever 362 extending into the face bore 212G and through the bore defined through the latch case 354 of the latch assembly 352. The lock receiver cup 364 is mounted in alignment with the face bore 212G with at least an outer periphery of the cup 364 abutting the major surface 212C of the door 212. The deadbolt lock receiver 366 is positioned centrally within the cup 364 and coupled to the cam of the deadbolt locking lever 362. As illustrated in FIG. 18B, a number of prongs 368 extend outwardly in a pattern from the deadbolt lock receiver 366. The deadbolt lock receiver 364 is thus rotatable with the deadbolt locking lever 362, and rotation of either the deadbolt lock receiver 364 or the deadbolt locking lever 362 operates the deadbolt 358 as described above.

Referring generally now to the left sides of FIGS. 15 and 19 and to FIGS. 17A-17D, the door handle assembly 224 includes a leverset 280 having handle 280A rotatably coupled to a rosette 280B. Generally, the handle 280A may be or include any structure or combination of structures rotatably coupled to the rosette 280B. In the illustrated embodiment, for example, the handle 280A is provided in the form of a conventional lever rotatable relative to the rosette 280B. In alternate embodiments, the handle 280A may be provided in the form of a knob or other structure rotatable relative to the rosette 280B, and in such embodiments the leverset 280 may be alternately referred to as a “handleset.” The leverset 280 further includes a cam 282A rotatably coupled to the handle 280A such that the cam 282A rotates with the handle 280A about a rotational axis and such that the cam 282A and the handle 280A rotate together relative to the rosette 280B. In embodiments in which the door handle assembly 224 is lockable, the handle 280A illustratively defines a central bore 280C sized to receive therein a rotatable shaft 280E having one end coupled to a keyway 280D carried by the handle 280A and an opposite end coupled to one end of the spindle 282B, and in such embodiments an axis extending centrally through the bore 280C defines the rotational axis of the handle 280A, cam 282A and spindle 282B. In such embodiments, rotation of the keyway 280D rotates the shaft 280E and spindle 282B relative to and independently of the handle 280A, cam 282A and rosette 280B, and rotation of the spindle 282B likewise rotates the shaft 280E and the locking button 280D relative to and independently of the handle 280A, cam 282A and rosette 280B.

The leverset 280 is mounted to the door 222 with the rosette 280B abutting the major surface 222D of the door 222 about the face bore 222E and with the cam 282A extending into the face bore 222E and through the bore 243′ defined through the latch case 242′ of the latch assembly 240′. In embodiments which include it, the spindle 282B likewise extends with the cam 282A into the face bore 222E and further extends through the bore 243′ defined through the latch case 242′ of the latch assembly 240′, as described above. A lock member 304 is illustratively affixed to or integral with one end of a lock member spindle 303, and the opposite end of the lock member spindle 303 is coupled to the spindle 282B carried by the cam 282A such that the lock member 304 rotates with the spindle 282B. In the illustrated embodiment, the cam 258A is illustratively provided in the form of an elongated hollow tube illustratively having a square, rectangular or other cross-sectional shape configured to cause one or more components receiving the cam 282A therein or received within the cam 282A to rotate with the cam 282A and vice versa. The spindle 282B is illustratively provided in the form of an elongated structure having a flat and square or rectangular or other cross-sectional shape configured to cause one or more components receiving the spindle 282B therein to rotate with the spindle 282B and vice versa. In the illustrated embodiment, the lock member spindle 303 illustratively defines a channel 305 therein configured complementarily to the shape of the spindle 282B such that the spindle 282B is rotatably coupled to the lock member spindle 303, and thus to the lock member 304, when the spindle 282B is received within the channel 305 defined in the lock member spindle 303. In such embodiments in which the door handle assembly 224 is lockable, the keyway 280D, rotatable shaft 280E, spindle 282B, lock member spindle 303 and lock member 304 are together rotatable relative to the door handle 280A between an unlocked position in which the spindle 282B and/or the rotatable shaft 280E and/or the keyway 280D cooperates with components within the leverset 280 to allow rotation of the cam 282A via the door handle 280A to operate the latch tongue 246′ as described above, and a locked position in which the spindle 282B and/or the rotatable shaft 280E and/or the keyway 280D cooperates with components within the leverset 280 to prevent rotation of the cam 282A such that the handle 280A is prevented from rotating to operate the latch tongue 246′. As also described above, the door handle assembly 224 may not include a locking feature in some embodiments, and in such embodiments the keyway 280D, the rotatable shaft 280E, the spindle 282B, the lock member spindle 303 and the lock member 304 may be omitted.

A mounting plate 284, e.g., in the form of an annular disk defines a bore 284A therethrough that is centrally aligned with the face bore 222E. A bushing 288 defines an outer periphery 288E sized to be received within the bore 284A defined through the mounting plate 284. The mounting plate 284 is illustratively affixed to the rosette 280B of the lockset 280 through the face bore 222E, e.g., via one or more conventional fixation members. The mounting plate 284 and the rosette 280B are thus each fixed in position relative to the door 222 such that neither the rosette 280B nor the mounting plate 284 rotates with the handle 280A, cam 282A or spindle 282B.

The bushing 288 defines a bore 288A centrally therethrough sized and configured to receive the cam 282A therein as illustrated in FIG. 17B such that the bushing 282 rotates with the cam 282A. A recess or bore 288D is defined in one end 288B of the bushing 288, and is sized to receive a lock member receiving bushing 320 therein. The walls of the recess or bore 288D are notched 288B, 288C to receive and engage protrusions 320B, 320C extending from the bushing 320 to thereby retain the bushing 320 within the recess or bore 288D. The lock member spindle 303 of the lock member 304 is received within and engages a bore 320A defined by the bushing 320 such that a lock protrusion 306 defined at the opposite end of the lock member 304 protrudes outwardly from the bushing 320. The spindle 282B is received through the bore 288A of the bushing and into the bore 305 of the lock member spindle 303 to engage the lock member 304 such that the lock member 304 rotates with the spindle 282B.

A magnet housing 298 defines a bore centrally therethrough sized to receive the outer periphery 288E of the bushing therethrough. Notches 298C, 298D are defined in the backside of the magnet housing 298 and engage protrusions 289B and 289A respectively extending from the outer periphery 288E of the bushing to rotatably couple the bushing to the magnet housing 298 such that the magnet housing 298 rotates with the bushing 288 which, in turn, rotates with the cam 282A as described above. The backside of the magnet housing 298 further defines opposing arcuate-shaped channels 298A, 298B therein sized to receive complementarily-shaped arcuate metal plates 295A, 295B. At opposite locations about an outer periphery of the magnet housing 298, the magnet housing 298 defines bores 299A, 299B therein each sized to receive a pin connector 312A, 312B. A C-shaped handle 296 defines complementarily configured bores 314A, 314B therein adjacent to each end of the C, and the pin connectors 312A, 312B are received within the bores 314A, 314B to couple the C-shaped handle 296 to the outer periphery of the magnet housing 298.

A rear portion of the bushing 288 extends rearwardly of the mounting plate 284 and the outer periphery 288E of this portion of the bushing 288 illustratively defines a pair of spaced-apart annular channels therein each sized to lockingly engage one of a pair of retaining rings 342A, 342B. For example, the outer periphery 288E of the bushing is illustratively notched at 288F and 288G to receive tabs 342A2 and 342A1 therein so that the retaining rings 342A, 342B do not rotate relative to the bushing 288. The mounting plate 284 is thus trapped between the protrusions 289A, 289B extending from the outer periphery 288E of the bushing 288 on one side and the retaining ring 342B on the other. In any case, a stop ring 340 is illustratively positioned over the outer periphery 288E of the bushing and held in place by the retaining rings 342A, 342B. In one embodiment, the stop ring is illustratively prevented from rotating relative to the outer periphery 288E of the bushing 288 keyed protrusions 340B1 and 340B2 which extending into the notches 288G and 288F respectively of the bushing as illustrated in FIG. 20B. The stop ring 340 illustratively includes a protrusion 340A which is sized and configured to engage a stop protrusion 284C extending axially away from the back side 288B of the mounting plate 284. In the illustrated embodiment, the protrusion 340A extending from the stop ring 340 and the stop protrusion 284C positioned on the back surface 288B of the mounting plate 284 together act as a rotational stopping mechanism which blocks clockwise rotation of the bushing 288 (and thus the magnet housing 298) but which allows counterclockwise rotation of the bushing 288 and the magnet housing 298.

A front face 298G of the magnet housing illustratively defines a plurality of bores 298H distributed about the lock member 304 such that central axes of the bores 298H are parallel with the central axis of the bore 288A defined through the bushing 288. Each of the bores 298H is illustratively sized to receive therein a different one of a corresponding plurality of cylindrically-shaped magnets 302 each defining a planar face oriented in a direction facing away from the magnet housing 298, and each having an opposite planar face magnetically coupled to one of the metal plates 295A, 295B so as to secure the magnets 302 within the bores 298H. In the illustrated embodiment, the bores 298H are sized such that the exposed planar faces of the magnets 302 are co-planar with the exposed front face 298G of the magnet housing 298, although this disclosure contemplates alternate embodiments in which the exposed planar faces of the magnets 302 are at least partially recessed within the bores 298H. The magnet housing 298 illustratively defines a pair of channels therein each sized to receive one of a pair of engagement tabs T1, T2 extending from a rear surface of a disk-shaped cover plate 330. The magnet housing 298 illustratively defines a flexible lip 298F about its outer periphery, and the cover plate 330 illustratively fits against the front surface 298G of the magnet housing 298 with the flexible lip 298F surrounding the outer periphery of the cover 330. In the illustrated embodiment, the cover 330 is solid, although in alternate embodiments the cover 330 may define passageways therethrough which align with the magnets positioned within the bores 298H. In any case, the metal plates 295a, 295B, the magnet housing 298, the magnets 302, the cover plate 330 and the handle 296 together illustratively define a magnet assembly 110 which is coupled to the door handle 280A via the cam 282A and which rotates with the handle 280A and cam 282A relative to the mounting plate 284.

In the example embodiment illustrated in FIGS. 15, 17B, 17C and 19, the plurality of magnets 302 illustratively includes four magnets 302 equally spaced about the periphery of the lock member 304. Alternatively, the magnet assembly 310 may be configured to include more or fewer magnets, e.g., such that the total number of magnets is one or more. In embodiments which include two or more magnets 302, such magnets may be equally or non-equally spaced about the lock member 304, equally or non-equally spaced only partially about the lock member 304, or equally and/or non-equally spaced individually and/or in sub-groups about or partially about the lock member 304. In any of the foregoing embodiments, each of the one or more magnets 302 may be a conventional permanent magnet. Alternatively or additionally, the one or more magnets 302 may be or include one or more conventional programmable magnets each having programmable magnetic polarities and/or magnetic field strengths and/or each having two or more zones in which the magnetic polarity and/or magnetic field strength is programmable in a conventional manner. In one example such embodiment, which should not be considered to be limiting in any way, a single programmable magnet 302 may be used and programmed in a conventional manner to define at least two magnetic zones having opposite magnetic polarities, and in one specific example, a single programmable magnet 302 may be used and programmed in a conventional manner to define multiple magnetic zones distributed radially about an exposed surface thereof with each zone having a magnetic polarity opposite to the magnetic polarities of adjacent zones.

One end of a lock member 304 is coupled to the spindle 282B as described above, and the lock member 304 thus rotates with the spindle 282B and keyway 280D relative to the door handle 280A, rosette 280B, mounting plate 284, bushing 288, magnet housing 298 and handle 296. A locking protrusion 306 extends outwardly away from the opposite end of the lock member 304, and the locking protrusion 306 is illustratively configured complementarily to the locking end 256A of the lock receiver 256 such that the locking protrusion 306 rotatably engages the locking end 256A of the lock receiver when the door handle assemblies 220 and 224 are brought together in contact with each other. An example configuration of the locking protrusion 306 extending from the lock member 304 is illustratively the same as that of the locking protrusion 106 illustrated in FIG. 6B and described above, and an example configuration of the locking end 256A of the lock receiver 256 is illustratively the same as that of the locking end 56A of the lock receiver 56 illustrated in FIG. 6A, although it will be understood that other configurations of the locking end 256A of the lock receiver 256 and the locking protrusion 306 extending from the lock member 304 are contemplated.

As described above, the rosette 280B of the leverset 280 and the mounting plate 284 of the door handle assembly 224 are illustratively affixed to each other and both are fixed in position relative to the door 222, whereas the door handle 280A, cam 282A, bushing 288 and magnet assembly 310 are rotatable together relative to the rosette 280B, mounting plate 284 and door 222. In embodiments that include them, the keyway 280D, the spindle 282A and lock member 304 are rotatable together relative to the rosette 280B, mounting plate 284 and door 222, as well as relative to the door handle 280A, cam 282A, bushing 288 and magnet assembly 310, to lock and unlock the door handle assembly 224 as also described above.

Referring still generally to the left side of FIG. 15, the deadbolt assembly 370 illustratively includes a rosette 380 in which a keyway 382 is disposed, a rosette 384 to which a deadbolt locking lever 386 is rotatably coupled, and a deadbolt-less latch assembly 372. In the illustrated assembly, the door 222 defines another cylindrical opening or face bore 222G therethrough, i.e., defined through the first and second major surfaces 222C, 222D of the door 222, adjacent to the latch side 222B, and another cylindrical opening or side bore or passageway 222H therein which opens to the face bore 222G. The deadbolt-less latch assembly 372 includes an elongated latch case 374 coupled to a latch plate 376 with a cover extending over and attached to the latch plate 376. The elongated latch case 374 is illustratively sized to be received within the side bore or passageway 222H with at least a portion of the latch case 374 extending into the face bore 222G and the latch plate 376 abutting the latch side 222B of the door 222. In some embodiments, the latch side 222B of the door may be mortised to receive the latch plate 376 therein. In the illustrated embodiment, the latch-side door stop 17B does not include a deadbolt strike plate, and the latch case 374 is therefore illustratively a dummy latch case 374 and serves only as a pass through between the keyway 382 and the locking lever 382.

The rosette 384 is mounted to and through the face bore 222G with at least an outer periphery of the rosette 384 abutting the major surface 222C of the door 222 about the face bore 222G and with the cam of the deadbolt locking lever 386 extending into the face bore 222G and through the bore defined through the latch case 374 of the deadbolt-less latch assembly 372. The rosette 380 is mounted in alignment with the face bore 222G with at least an outer periphery of the rosette 380 abutting the major surface 222D of the door 222, and the keyway 382 carried by the rosette 380 is coupled to the cam of the deadbolt locking lever 386. As illustrated in FIGS. 18A and 18B, the deadbolt locking lever 386 is configured complementarily to the pattern defined by the number of prongs 368 extending outwardly from the deadbolt lock receiver 366 and/or vice versa such that, when the doors 212, 222 are interlocked the deadbolt locking lever 382 is captured between the prongs 368 and is thereby rotatably coupled to the deadbolt locking lever 362. With the doors 212, 222 interlocked, either the keyway 382 or the deadbolt locking lever 362 may be rotated to operate the deadbolt 358 as described above. When the doors 212, 222 are decoupled, either the deadbolt locking lever 362 or the deadbolt lock receiver 366 may be rotated to operate the deadbolt 358 as described above.

The door handle assemblies 220, 224 may be selectively interlocked, coupled together or otherwise engage each other such that the doors 212, 222 pivot together about the one or more hinge assemblies 216 and may be selectively decoupled or disengaged from each other such that the doors 212, 222 pivot independently from each other about the one or more hinge assemblies 216, e.g., as illustrated in FIGS. 3A-4B and described above respect to the door assembly 10. As also described above with respect to the door assembly 10 and illustrated in FIG. 8, such selective interlocking of the door handle assemblies 220, 224 is illustratively accomplished through selective alignment of the two sets of magnets 268, 302 followed by magnetic coupling of and between the two sets of magnets 268, 302 as the two handle assemblies 220, 224 are subsequently brought into contact with each other. As the two door handle assemblies 220, 224 interlock, the two deadbolt assemblies 350, 370 likewise interlock as described above, and when so interlocked the deadbolt 358 may be operated with the door 212 closed to further secure the door 212 to the latch-side jamb 214B as described above. Selective decoupling or disengagement of the interlocked door handle assemblies 220, 224 is illustratively accomplished by rotating the door lever 250A in a release direction, as will be described below, until the stop ring 340 rotatably coupled to the magnet assembly 310 of the door handle assembly 224 has reached a release position at which the lever 280A of the door handle assembly 224 is prevented from further rotation in the release direction, and then further rotating the door lever 250A in the release direction with a rotational force that is sufficient to overcome the magnetic coupling force between the two sets of magnets 268, 302, thereby decoupling the two door handle assemblies 220, 224.

As described above with respect to the embodiment illustrated in FIGS. 1A-9C, the magnets 268, 302 are illustratively arranged such that the exposed surfaces of the magnets 268 alternate in magnetic polarity about the lock receiver 256 and the exposed surfaces of the magnets 302 likewise alternate in magnetic polarity about the lock member 304. With the levers 250A and 280A in their unactuated positions, e.g., both horizontal as illustrated in FIGS. 18A and 18B, the magnetic polarities of the exposed surfaces of the magnets 268 are opposite those of the magnets 302 axially aligned therewith. In the embodiment illustrated in FIGS. 10-22C, the levers 250A and 280A are illustratively each biased to their unactuated or default positions, i.e., positions assumed by the levers 250A, 280A when no external forces outside of the door handle assemblies 220, 224 are acting on them, by the latching assemblies 240, 240′ acting on the cams 252A, 282A respectively, e.g., by one or more conventional biasing members carried by the latching assemblies 240, 240′ and forcing the cams 252A, 282A respectively to rotate to positions at which the levers 250A, 280A are in their default positions, e.g., with each lever 250A, 280A horizontal as illustrated in FIGS. 15, 16A-17B and 18A-18B. In this embodiment, the interlocking position of the door handle assembly 220 is thus with the lever 250A in its default, unactuated position, and the interlocking position of the door handle assembly 224 is that in which the lever 280A is in its default, unactuated position. In some alternate embodiments, the door handle assembly 220 and/or 224 may alternatively or additionally include one or more conventional biasing members acting directly upon the lever 250A and/or the lever 280A respectively and/or acting upon one or more other component(s) that rotate with the lever 250A and/or the lever 280A respectively, to bias the handle assembly 220, and thus the lever 250A, to its default, unactuated and interlocking position and/or to bias the handle assembly 224, and thus the lever 280A, to its default, unactuated and interlocking position. Those skilled in the art will recognize other conventional structures and/or techniques for biasing the door handle assembly 220 and/or the door handle assembly 224 to its default, unactuated and interlocking position, and it will be understood that any such other conventional structures and/or techniques are contemplated by this disclosure.

As the door handle assemblies 220, 224 are brought toward each other by pivoting one door 212 toward the other door 222, or by pivoting both doors 212, 222 toward each other, about the one or more hinge assemblies 216 as illustrated in FIGS. 18A and 18B, magnetic attractive forces develop between each axially aligned and opposite magnetic polarity pair of magnets in the opposing sets of magnets 268, 302 such that, as the distance between the cover plates 270 and 330 decreases, magnetic attractive forces increase between each aligned pair of the opposing sets of magnets 268, 302 until magnetic coupling occurs between each of the aligned and opposite magnetic polarity pairs of magnets 268, 302 which draws them into contact with each other, thereby magnetically coupling together the door handle assemblies 220, 224 as illustrated in FIG. 20A.

As a result of such magnetic coupling, the door handle assemblies 220, 224, and thus the doors 212, 222 respectively, are secured together adjacent to the latch sides 212B, 222B respectively thereof such that the doors 212, 222 may be pivoted together about the one or more hinge assemblies 216 between common open and closed positions. And because the magnet assembly 274 rotates with the door handle 250A and the magnet assembly 310 rotates with the door handle 280A, rotating the door handle 250A in the clockwise direction or rotating the door handle 280A in the counterclockwise direction, as illustrated by example in FIG. 20A, simultaneously operates both latch assemblies 240, 240′ to couple the latch tongues 246, 246′ to, and disengage the latch tongues 246, 246′ from, the latch plate 215 as described above.

FIG. 20B illustratively depicts the operation of the stop ring 340 and the stop protrusion 284C when the door handle 280A is rotated in the counterclockwise direction as depicted in FIG. 20A and as just described. As the door handle 280A is rotated counterclockwise, the stop ring protrusion 340A is drawn rotationally away from the stop protrusion 284C positioned on the back side 284B of the mounting plate 284, and as the door handle 280A is then rotated clockwise the stop ring protrusion 340A is drawn rotationally toward and eventually contacts the mounting plate protrusion 284C, thereby preventing further clockwise rotation of the door handle 280A as illustrated in FIG. 17D. This default and unactuated position of the door handle assembly 224 in which the stop ring protrusion 304A is in contact with the mounting plate protrusion 284C thus defines not only the interlocking position of the door handle assembly but also the release position of the door handle assembly 224, and in this position the lever 280A is illustratively horizontal as illustrated in FIGS. 17A and 17B. The door handle 280A of the door handle assembly 280 is thus configured to operate the latch assembly 240′ to open the door 222 or to operate both of the latch assemblies 240′, 240 to open both of the doors 222, 212 only by rotating the handle 208A counter clockwise to force the stop ring protrusion 340A away from the mounting plate protrusion 284C. It will be appreciated that in some alternate embodiments, the door handle assembly 280 may be alternately configured to operate the latch assembly 240′ to open the door 222 or to operate both of the latch assemblies 240′, 240 to open both of the doors 222, 212 only by rotating the handle 208A clockwise to force the stop ring protrusion 340A away from the mounting plate protrusion 284C. In any case, positioning of the stop ring protrusion 340A and the mounting plate protrusion 284C relative to operation of the latch tongue 246′ of the latch assembly 240′ or relative to operation of the latch tongues 246′, 246 of the latch assemblies 240′, 240 may be as described above with respect to FIGS. 9A-9C.

With the door handle assemblies 220, 224 brought together and interlocked as illustrated in FIGS. 19 and 20A, the locking protrusion 306 extending from the lock member 304 is received within and rotatably engages the locking end 256A of the lock receiver 256. With the locking protrusion 306 rotatably engaged with the locking end 256A of the lock receiver 256, the lock member 304 rotates with rotation of the lock receiver 256 and vice versa such that rotation of the locking button 250D to the locked or unlocked position of the door lever 250A is transferred through the rotatably engaged lock receiver 256 and lock member 304 to also lock or unlock, respectively, the door lever 280A via actuation of the keyway 280D. Rotation of the keyway 280D, e.g., via a complementarily configured key, to the locked or unlocked position of the door lever 280A is likewise transferred through the rotatably engaged lock member 304 and lock receiver 256 to lock or unlock, respectively, the door lever 250A via actuation of the locking button 250D. By rotating either the locking button 250D or the keyway 280D with the door handle assemblies 220, 224 interlocked, i.e., magnetically coupled together, as illustrated in FIGS. 19 and 20A the door levers 250A, 280A can thus be selectively and simultaneously locked/unlocked.

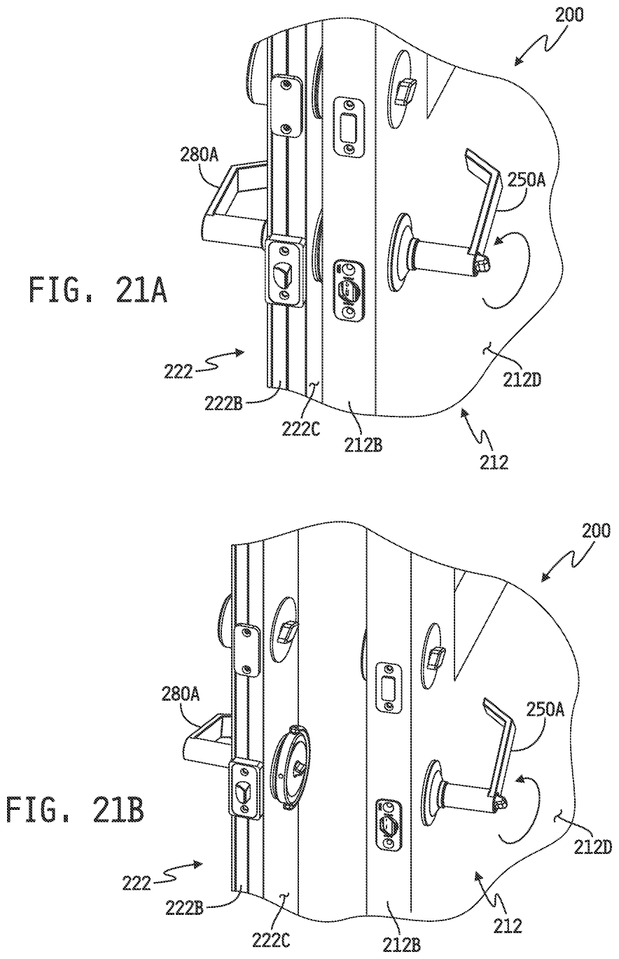

As illustrated in FIGS. 21A and 21B, the door handle assemblies 220, 224 may be decoupled by rotating the door handle 250A in the counterclockwise direction with the door lever 280A in its default, unactuated and release position, e.g., with the lever 280A horizontal. With the door lever 280A in its unactuated, default and release position, and as the door lever 250A is rotated in the counterclockwise direction with a force greater than the magnetic coupling forces between the aligned pairs of magnets 268, 302 as illustrated in FIG. 21A, the magnet assembly 274 is caused by the counterclockwise rotation of the lever 250A to also rotate counterclockwise relative to the magnet assembly 310, thereby rotationally drawing the magnets 268 away from the previously aligned and opposite polarity magnets 302. As the magnet assembly 274 continues to rotate with the counterclockwise rotation of the door lever 250A, the exposed surfaces of the magnets 268 continue to be drawn away from the exposed surfaces of magnets 302 having opposite magnetic polarity and toward the exposed surfaces of magnets 302 having like polarities. As the exposed surfaces of the magnets 268 rotate sufficiently away from the exposed surfaces of the previously aligned and opposite polarity magnets 302, the door assemblies 220, 224 magnetically decouple from each other so that the doors 212, 222 may be separated from each other. As the exposed surfaces of the magnets 268 move, e.g., with further counterclockwise rotation of the door lever 250A in the counterclockwise direction, into alignment with the exposed surfaces of magnets 302 having like polarity, magnetic repulsive forces develop therebetween which operate to force the magnet assemblies 274, 310 away from each other, thereby magnetically assisting with the decoupling of the door handle assemblies 220, 224 and with the separation of the doors 212, 222 from each other as illustrated in FIG. 21B.

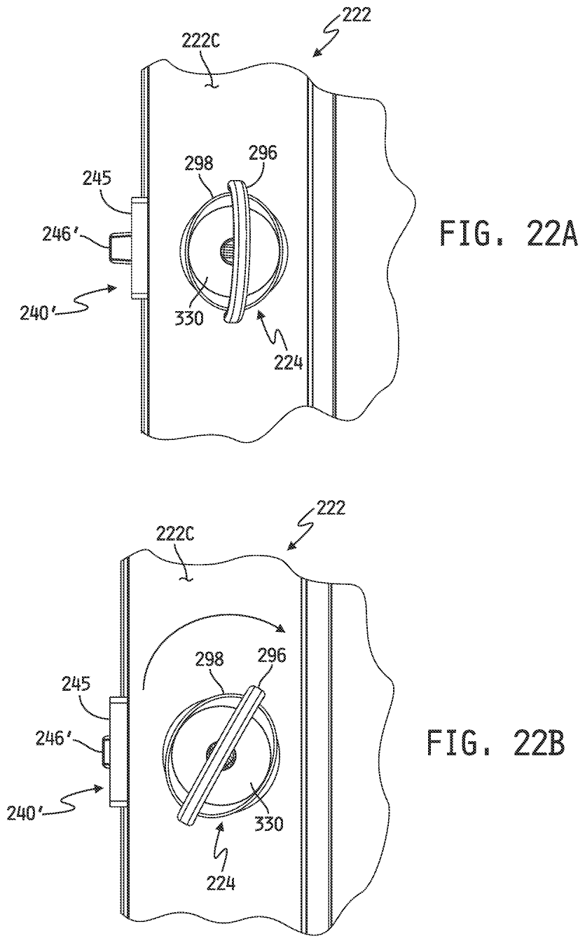

With the door handle assemblies 220, 224 decoupled from each other as illustrated in FIG. 21B, the door handle assembly 224 is operable from either side, e.g., by rotating the lever 280A and/or the handle 296, to selectively engage and release the latch tongue 246′ with and from the strike plate 215. Operation of the door handle 296 is illustrated in FIGS. 22A and 22B. As illustrated in FIG. 21A, the handle 296 is first folded or deployed outwardly from its default position beside the magnet assembly 310, as illustrated in FIGS. 17A and 18A. The handle 296 may then be rotated clockwise as illustrated in FIG. 22B to actuate the latch tongue 246′. In some embodiments, the handle 296 is configured to return to its default position when released.

It will be noted that in the embodiment illustrated in FIGS. 10-22B, the interlocking and release positions of the door handle assembly 224 and therefore the operation and positioning of the door handle assemblies 220, 224 to interlock and release the door handle assemblies 220, 224, are configured differently than in the embodiment illustrated in FIGS. 1A-9C. In the former case, the unactuated, default position of the door handle assembly 224 is both its interlocking and release position such that the door handle assemblies 220, 224 can be interlocked as described above when each of the door handle assemblies 220, 224 are in their unactuated and default positions and, when so interlocked, the latch tongues 246, 246′ of both latch assemblies 240, 240′ may be operated with the door handle assembly 224 by applying an external rotational force to the lever 280A to rotate it counterclockwise (or clockwise in alternate embodiments) from its unactuated, default position, and when the external rotational force is removed from the lever 280A it automatically returns, under bias, to its unactuated, default position. To then decouple the door handle assemblies 220, 224, an external rotational force is applied to the lever 250A to rotate it counterclockwise which, through the magnetic coupling, applies a clockwise rotational force (or a counterclockwise force in alternate embodiments) to the door handle assembly 224 which is initially in its unactuated, default position. Because the stop ring protrusion 340A is in contact with the mounting plate protrusion 284C in the unactuated, default position of the door handle assembly 224, this is also its release position because the clockwise force applied to the door handle assembly 224 via the counterclockwise force applied to the lever 250A of the door handle assembly 220 further forces the stop ring protrusion 340A against the mounting plate protrusion 284C thereby eventually decoupling the door handle assemblies 220, 224. In the embodiment illustrated in FIGS. 1A-9C, in contrast, the door handle assembly 24 has different interlocking and release positions and no unactuated, default position, i.e., the rotational position of the magnet assembly 110 at any instant in time corresponds to the position to which the interlocking lever 96 was most recently moved. The door handle assembly 24 must be manually moved to its interlocking position, e.g., by manually rotating the interlocking lever 96 clockwise as illustrated in FIG. 6B (or counterclockwise in alternate embodiments), and then forcing the door handle assemblies 20, 24 together to interlock them via magnetic coupling as described above. To decouple the door handle assemblies 20, 24, the door handle assembly 20 must be rotated counterclockwise via counterclockwise rotation of the door handle assembly 20 from its interlocking position, e.g., illustrated in FIG. 6B, to its release position, e.g., illustrated in FIGS. 9B and 9C, and then further rotated counterclockwise via further counterclockwise rotation of the door handle assembly 20 to decouple the door handle assemblies 20, 24. In order to thereafter interlock the door handle assemblies, the interlocking handle 96 must first be manually return, via clockwise rotation thereof, to its interlocking position illustrated in FIG. 6B.

This disclosure contemplates providing the door assembly 10, 210 either as an OEM assembly or as an aftermarket assembly. In the latter case, it will be noted that the jambs 14, 214 and door stop 17, 217, the sill 26, 226 and the door 12, 212 need not be supplied as they will already be in place and mounted to and within a building structure, i.e., such structures will preexist. Rather, in this application, only the one or more hinge assemblies 16, 216, the door 22, 222, the door stop components 19, 219, the door handle assemblies 20, 24 or 220, 224, the latch assemblies 40, 40′ or 240, 240′ and, in some cases, the strike plate(s) 15A, 15B or 215 need be supplied and installed. In some such applications, the deadbolt assemblies 250, 370 and corresponding latch assemblies 352, 372 may also be supplied and installed. In some such applications, the door stop components 19, 219 may be keyed to facilitate attachment to the existing, corresponding jamb components 14, 214 and/or to the existing, corresponding door stop components 17, 217.

Embodiments of the interlocking door handle assemblies 20, 24, 220, 224 have been illustrated and described herein as implementing rotatable door handles 50A, 80A, 250A, 280A and in this regard the magnet assemblies 74, 110, 274, 310 the lock receiver 56, 256 and lock member 104, 304, the door handle 96, 296 and the physical stop 120, 122, 340, 284C have all been implemented in the context of such rotatable door handles. It will be understood, however, that this disclosure contemplates alternate embodiments in which either or both of the door handle assemblies include one or more non-rotating door handles, e.g., linearly actuating door handles, non-linearly actuating door handles other than circularly rotating door handles, and the like.

In the case of co-mounted doors, as described above, it is understood that alignment of interacting parts of the handlesets or leversets will allow better interlocking of an external and internal door so as to be openable and closeable together in a reliable manner. Certain components are described above as having surfaces or other features that facilitate alignment of components once such components are brought into close proximity with one another. Such component alignment also relies on the installation of the co-mounted doors so that the interaction sides of each handle assembly (20 and 24 as above) properly align with one another to make an effective interconnection as also described above.

It is noted that manufacturing tolerances as they can build or stack up as such a co-mounted door system is assembled can also lead to alignment inconsistencies. As such, the present invention provides an improvement in the form of an adjustment that can be advantageously utilized during the installation process of co-mounted doors or single doors that can improve alignment at a stage from which alignment can be set for operation henceforth. In the case of co-mounted doors, the adjustment can result from an alignment process including fitting the coupling or interlocking features of one door with those of the other door for self-adjusting at least one latch assembly. For a single door, such an adjustment can be utilized for final alignment of a single handle assembly component parts based upon door opening, or other installation specifications. Such adjustments may be conducted by an installer. For example, a door bore can be off-position or can be in one of multiple specified positions. The adjustments and mechanisms for doing so can accommodate such differences as specified or not. The following description is provided as applicable to an external door of a co-mounted door system with the full understanding that such could be provided instead to an internal door of a co-mounted system, or to any single door assembly that can include conventional door handles or levers on both sides of a single door.

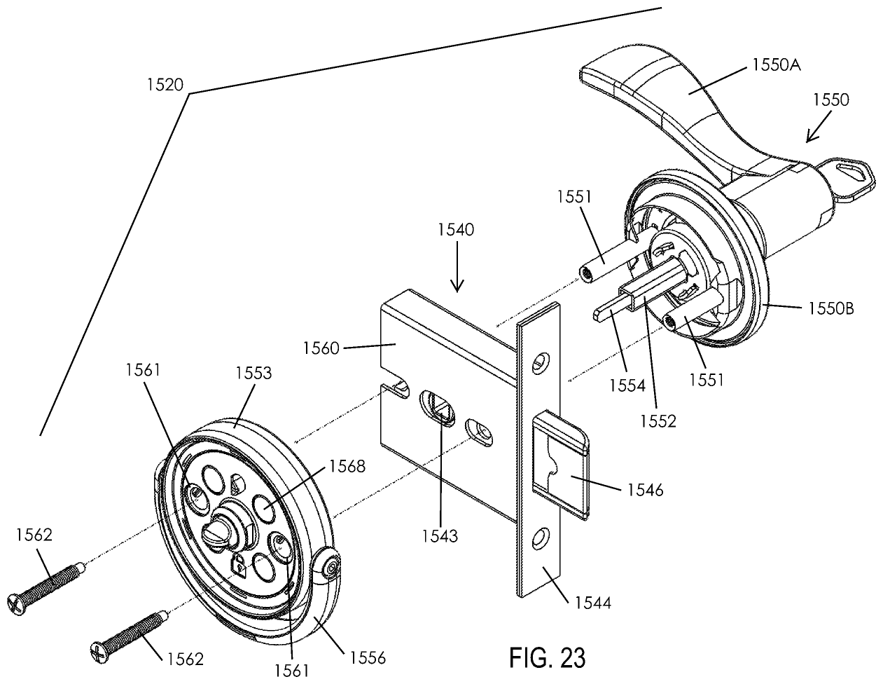

Referring now to FIG. 23, a handle assembly 1520 is illustrated in a partially exploded figure showing a leverset or handleset 1550 that is mounted to one side of a door and a coupling element housing 1564 to be mounted to a second side of the door in a manner as described above. A handle 1550A is rotatably mounted to the door and is surrounded by a rosette or annular ring 1550B that is mounted to the door surface to be non-movable to the door. A pair of elongate bosses 1551 are structurally connected with the annular ring 1550B to be non-rotational and to extend from a backside of the annular ring 1550B. The rotatable handle 1550A is operatively connected with a cam 1552 to rotate with the door handle 1550A. A spindle 1554 is also illustrated as part of a locking mechanism as described above, such as under the control of a key as shown. On the other side of the door, the coupling element housing 1564 is rotatably mounted to the door by way of a non-rotational chassis (not shown, but like chassis 58 described above) so that the coupling element housing 1564 can rotate with the door handle 1550A and the cam 1552 when assembled. A ring portion 1553 of the coupling element housing 1564 can be provided integrally or as a separate component to rotate with the coupling element housing 1564 and may be also connected with a handle 1554 to user operation from this side of the door.

A latch assembly 1540 is shown operatively positioned between the handle set 1550 and the coupling element housing 1564, which latch assembly is to be fitted within a side bore of the door, such as described above as bore 12F. Such a side bore is preferably shaped and sized to accommodate the shape and size of the latch assembly 1540 and to position a bore 1543 of the latch assembly 1540 in position within a central region of a door through-bore, such as described above at 12E. The bore 1543 accommodates passage of the shaped cam 1552, including the spindle 1554 within its hollow interior if provided. The cam 1552 is also operatively connected with the rotational coupling element housing 1564 in a manner as described above to rotate the coupling element housing 1564 relative to its chassis also as described above. The cam is preferably shaped to transfer rotational movement to the coupling element housing 1564 and also to rotate a rotatable component that is operatively supported within the latch assembly 1540 and through which the bore 1543 is provided, as such bore 1543 is preferably similarly shaped to the cam 1552. The rotatable component rotates to translate rotational motion into linear movement of a latch tongue 1546 in a conventional manner.

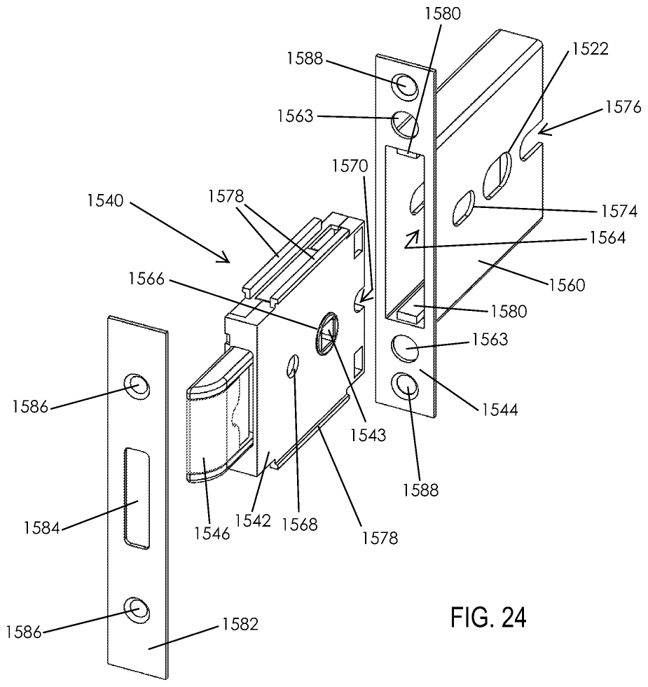

Referring now to FIG. 24, the latch assembly 1540 can comprise an outer housing 1560 that is fit within the door side bore 12F and that is fixedly connected with a latch plate 1544, such as by welding, spot welding, fasteners, other bonding techniques, metal deformation techniques, or the like. The latch plate 1544 preferably includes a first set of openings 1588 for mounting the latch plate 1544 to the side edge of the door for fixing the latch plate and outer housing 1560 to the door. Other ways of fixing the outer housing 1560 in place are also contemplated.

An internal channel 1564 of the outer housing 1560 accommodates the insertion of a latch case 1542 that is operatively similar to the latch case 42 described above having more of an elongate shape. As shown, the latch case 1542 includes an opening 1566 to provide access to the bore 1543 of the rotatable component within the latch case 1542 and to facilitate passage of the cam 1552. The latch case 1542 also includes an opening 1568 passing through the latch case 1542 and a slot 1570 also providing a passage through the latch case 1542. This opening 1568 and slot 5170 combination provides passage for a pair of assembly screws 1562 (see FIG. 23) that connect the non-rotational chassis (not shown) associated with the rotational coupling element housing 1564 with the internally threaded bosses 1551 of the annular ring 1550B to position and fix the handle assembly 1520 in position to the door. The bosses 1551 can extend sufficiently so that the bosses 1551 also extend through the opening 1568 and slot 1570 along with at least a portion of the screws 1562, or the bosses 1551 may extend sufficiently through the opening 1568 and slot 1570 such that screws 1562 can engage with bosses 1551 without any portion of the screws 1562 passing through the opening 1568 and slot 1570. The assembly screws 1562 and/or the bosses 1551 collectively provide fastening elements for connecting the handle assembly 1520 together and in place to the door. Holes 1561 provided through the coupling element housing 1564 accommodate passage of the screws 1562 to be secured with the chassis (not shown). Once these screws are tightened in place, the handle assembly 1520 is provided in a final operative position on the door.

The latch case 1542 is preferably sized and shaped to be slidably insertable within the outer housing 1560 by way of the internal channel 1564 and to be adjustable in the insertion or withdrawal direction, preferably in a linear direction defined by one or more guide surfaces of the outer housing 1560 as they slidably contact one or more guide surfaces of the latch case 1542. The outer housing also preferably includes an opening 1572 that provides access to the bore 1543 and another opening 1574 aligned with the opening 1568 of the latch case 1542 and a slot 1576 aligned with the slot 1570 of the latch case 1542. As such, the outer housing 1560 provides accommodation for the cam 1552 and the screws 1562 similarly as does the accommodations made to the latch case 1542 for the same purpose to securely mount the handle assembly 1520 in place.

Preferably, the latch case 1542 also includes guide rails 1578 that can be integral or separately provided components that can be sized and shaped to interact with slides 1580 that can be provided integrally or separately on internal surfaces of the outer housing 1560, such as provided within the internal channel 1564. Such rails 1578 and slides 1580 can be provided in any number of different manners and with any number of complimentary components to provide the internal guide surfaces of the outer housing 1560 that cooperate with external surfaces of the latch case 1542 to define the direction of movement and thus adjustment of the latch case 1542 to the outer housing 1560 as further facilitated below. Such rails 1578 and slides 1580 can be provided by an combination of guide surfaces of the latch case 1542 and the outer housing 1560 and need not provide any specific guide structure other than at least some guide surface of any portion of the latch case 1542 and some guide surface of any portion of the outer housing 1560 that together define a linear adjustability of the latch casing 1542 relative to the outer housing 1560 in the adjustment direction.

A latch cover 1582 is also shown in FIG. 24 that can be installed over the latch plate 1544 for aesthetic purposes and to cover portions of the latch case 1542. An opening 1584 is sized and shaped for passage of the latch tongue 1546 and openings 1586 can be provided for screws to mount the latch cover 1582, which screws would also pass through openings 1563 of the latch plate 1544 to further secure the latch plate 1544 and outer housing 1560 in place. It is also contemplated that the openings 1586 through the latch cover 1582 can be aligned with the openings 1588 so that screws could be used to attach the latch cover 1582 to the door by passing through openings 1586 and 1588. In this situation, the openings 1563, as described above, could instead be used to mounting the latch plate 1544 to a door side edge with the latch assembly 1540 within the opening (such as at 12F above) along the door side edge.

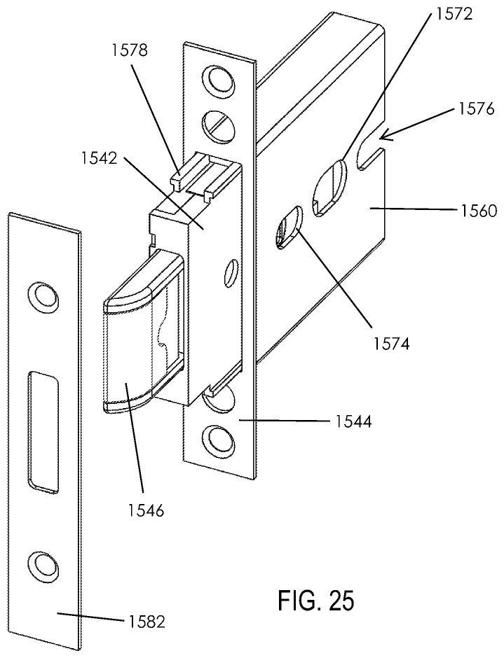

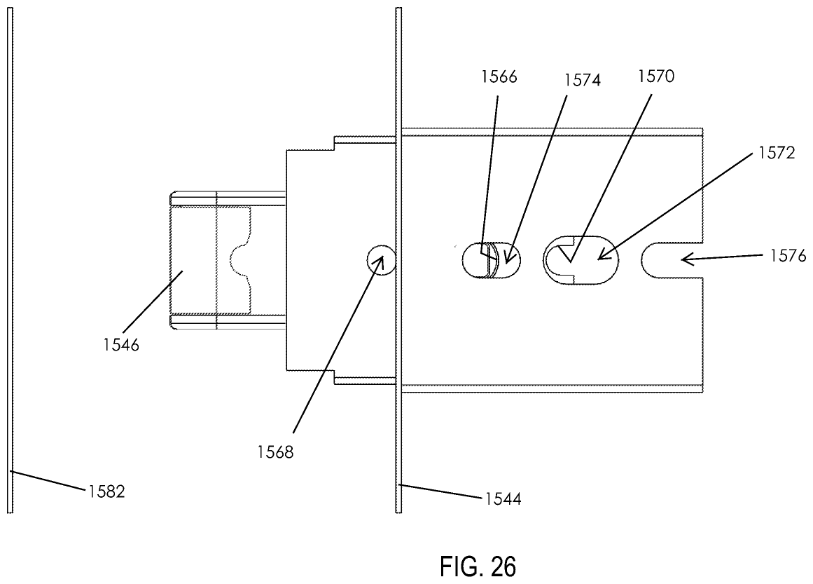

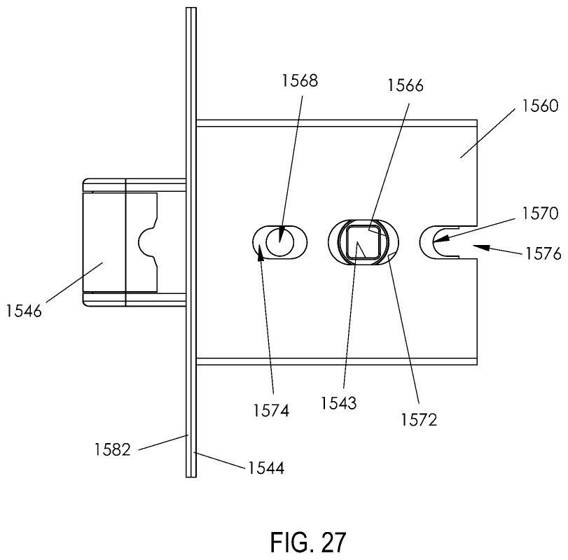

As noted above, an adjustment is preferably provided between the outer housing 1560 and the latch case 1542 in a defined adjustment direction. This defined adjustment direction is preferably horizontally when looking at an installed door as that direction is most likely to include a stack up of manufacturing tolerances. However, the defined adjustment direction can be otherwise, for example vertically or side-to-side provided that the outer housing 1560 is dimensioned to accommodate any other such adjustment direction. It is also contemplated that the latch case 1542 can be adjustable in more than one defined adjustment direction, again provided that the outer housing is appropriately designed to accommodate the adjustment movement. FIGS. 25 and 26 show the latch case 1542 partially inserted within the outer housing 1560 as may be facilitated by complimentary guides 1578 and slides 1580 to define an adjustment direction. Whereas the openings 1566, 1568, and slot 1570 of the latch case 1542 are preferably round, the corresponding openings 1572, 1574, and slot 1576 of the outer housing 1560 are preferably oversized, such as being elongate, for providing openings and slots to the outer housing 1560 that have a greater dimension in at least the adjustment direction than the openings and slots of the latch case 1542. The openings/slots 1574, 1576 can be oversized in any other dimension as well. Oversized means of greater size than is otherwise needed to accommodate passage of the screws 1562 and/or bosses 1551 or the size to accommodate entry of the cam 1552 into and through the bore 1543. Whereas each of these openings of the outer housing similarly facilitate passage of the screws 1562 or bosses 1551 and the cam 1552 like the openings of the latch case 1542, an adjustment accommodation or amount is defined by the greater opening dimensions of the openings of the outer housing 1560 in the adjustment direction. It is understood that the latch case could be provided with oversized or elongate openings as well, but it is preferable for the latch case 1542 openings/slots be sized to accommodate the screws/bosses 1562/1551 such that the screws/bosses 1562/1551 and latch case 1542 engage and support each other. With the outer housing 1560 fixed in position to the door during install, the latch case 1542 can be adjusted relative to the fixed housing 1560. FIG. 27 shows the latch case 1542 inserted within the outer housing 1560 and with the openings/slots provided to allow for adjustment in the adjustment direction is either linear way (to the right or to the left as illustrated).

During a door installation, for example of co-mounted doors, such a handle assembly 1520 can be provided to one or both doors. At least one of the latch assembly 1540 installation processes would include the steps of inserting an outer housing 1560 within an opening along a side edge of a door, inserting the latch case 1542 within the outer housing, and potentially positioning the screws 1562 in a loosened, semi-tightened, or snug condition through the chassis, outer housing 1560, latch case 1542, and into the bosses of the annular ring 1550B. The cam 1552 could also be operatively connected from the handle set 1550 to the coupling element housing 1564. The two doors could then be brought into close proximity to one another and to contact one another. The contact can thus cause the adjustment of the at least one latch assembly 1540 in the adjustment direction by the interaction of guide surfaces of the cooperating component of the two doors that, preferably as above, can include certain guiding features. It is also contemplated that any number of manipulations may be conducted by the installer for alignment purposes. For example, an added vertical adjustment can be provided between the outer housing 1560 and the door as positioned within the opening along the door side edge if slightly oversized in the vertical direction. Bringing the doors together can also cause a vertical self-alignment prior to fixing the outer housing in position such as by screws through openings 1588 and 1562. Once alignment is accomplished or any other adjustment for any reason is made, the screws through the handle assembly 1520 can be tightened to secure the handle assembly 1520 in place to one or both doors. If one of the handle assemblies 1520 or another were mounted and tightened in place to one door prior to bringing the co-mounted doors in contact with one another while the other handle assembly 1520 or another is more loosely mounted to the other door, the tightened handle assembly can cause a self-alignment of the looser handle assembly after which that handle assembly can be tightened in place as aligned.

For a single door installation, the process would be the same except without adjustment made by contact of one door with another, such as based on installer manipulations, which may accommodate installer adjustments for door or opening variations or the like.

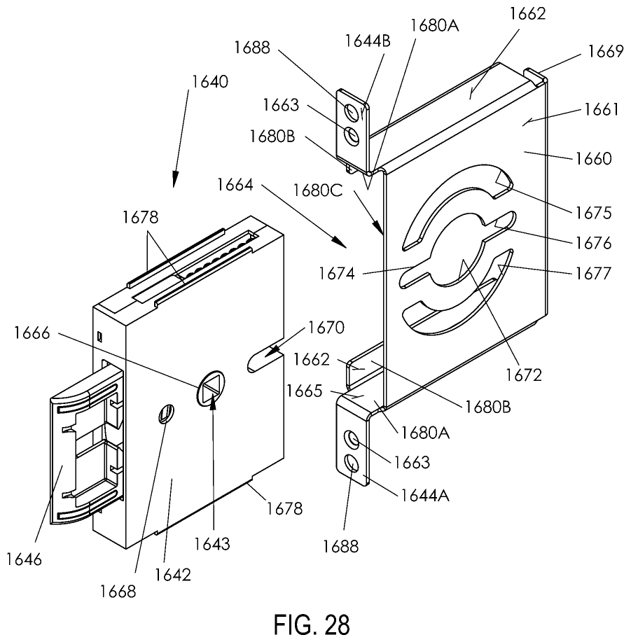

Another embodiment of a latch assembly 1640 is illustrated in FIG. 28 as comprising a latch case 1642 and an outer housing 1660. The outer housing 1660 provides an internal channel 1664 similarly as internal channel 1564 above, but with less structure of the outer housing 1660. Specifically, the outer housing 1660 is of a design that can be formed advantageously by a stamping operation from a sheet of material, such as metal or any other deformable material. The outer housing 1660 can be formed otherwise, such as by injection molding if a suitable material were used or machined, or assembled from components or by any other known or developed forming technique. The outer housing 1660, as illustrated, comprises a side wall 1661 that connects with a bottom wall 1665, a top wall 1662, and a back wall 1669. The top and bottom walls 1662, 1665 also further preferably connect with side wall portions 1667. Together, these walls 1661, 1662, 1665, 1667, and 1669 define a portion of a box-like volume and provide the internal channel 1664. As shown, a single plate of material can be sequentially bent as a stamping process to create the box-like volume having a front open for entry into the internal channel 1664 and with side wall portions 1667 providing sufficient structure as a mostly open second side wall that can contain the latch case 1642. The top wall 1662 also preferably is formed as connected with a top latch plate portion 1644B and the bottom wall 1665 preferably is formed as connected with a bottom latch plate portion 1644A; the latch plate portions 1644B and 1644A providing mounting openings 1663 and 1688 that are utilized as above with respect to openings 1563 and 1588 of the latch plate 1544 described above.

As above, the internal channel 1664 provides a sliding guidance for receiving the latch case 1642 by internal guide surfaces of the outer housing 1660. Specifically, the side wall 1661 can provide upper and lower guide surface portions as indicated at 1680C that can slidably engage upper and lower side edge portions of the latch case 1642. Likewise, the upper and lower side wall portions 1667 can provide similar guide surfaces. At least portions of internal surfaces of the top and bottom walls 1662, 1665 can provide guide surfaces as well. Each or any combination of such surfaces can work together to provide a generally linear movement in an adjustment direction. Preferably, the degree of extension of at least one guide surface of the latch case 1642 and at least one guide surface of the outer housing 1660 facilitates a degree of adjustability of the latch case 1642 relative to the outer housing 1660. More preferably, a combination of a plurality of guide surfaces of each of the latch case 1642 and the outer housing 1660 allow the desired degree of adjustability of the latch case 1642 relative to the outer housing 1660 in the adjustment direction. Such guide surfaces can include rails and slides as discussed above or other complimentary structures. Latch case 1642 is shown with slight rails 1678 that extend just past top and bottom edges of the latch case 1642 to reduce contact and thus friction during any adjustment in the adjustment direction. The back wall 1669 can provide a limit of the movement of the latch case 1642 within the internal channel 1664, which limit preferably allows a range of adjustment in the adjustment direction of the position of the latch case 1642 relative to the outer housing 1660 in accordance with the present invention.

The latch case 1642 is otherwise illustrated similarly as latch case 1542 above including an opening 1666 that provides access to the bore 1643, along with a combination of an opening 1668 and slot 1670 that accommodate screws 1562 or other fasteners. A latch tongue 1646 is operatively connected with the rotatable element providing the bore 1643 to extend and retract from the latch case 1642 upon rotation of the rotatable member by a cam as also described above.

The outer housing 1660 is shown with certain modified features to accommodate passage of screws 1562 for installation, as above, and to allow a predetermined amount of play to accommodate a desired amount of adjustability in an adjustment direction of the latch case 1642 relative to the outer housing 1660. In particular, instead of three openings, one to provide access to bore 1643 and two to accommodate passage of mounting screws 1562 (as could be an opening and a slot as described above), a single opening is provided as comprising a central opening portion 1672 to provide access to the bore 1643 with two opening extension portions 1674 and 676 that preferably at least extend in the desired direction of adjustability between the latch case 642 and the outer housing 1660. It is contemplated that one or more openings can be provided to allow the desired access to the bore 1643 and to accommodate the passage of any number of fasteners to pass through the latch assembly 1640. Openings 1675 and 1677 illustrate material saving openings that can be incorporated into the outer housing 1660 design as desired and in any shape or form.

It is also contemplated that the alignment and adjustment features described above as incorporated within handle assembly designs can also be applied to a deadbolt assembly, such as the deadbolt assemblies 350 and 370 described above (see FIGS. 15 and 18A,B) for co-mounted doors. As illustrated in FIG. 15, a deadbolt 358 can extend from or retract within a deadbolt case 354 similarly as the latch tongue 246 extends from or retracts within the latch case 242. In accordance with the present invention, such a deadbolt 358 is a specific type of latch tongue as presently described that extends or retracts from or within a deadbolt case 354 that is a specific type of latch case. Such a deadbolt case 354 can be modified in the same way as the latch case 242 is modified in the above examples of latch case 1542. An outer housing can likewise also be provided operatively positioned between the deadbolt case and a side door opening, such as opening 212H, within which the outer housing would be positioned. In an installation process for co-mounted doors, interaction between the operative connective components 366 and 386 of FIG. 15 could be used in the alignment process prior to final tightening of assembly screws. In the case of a single door with a deadbolt, such an adjustment in a defined adjustment direction can be utilized as part of a specified or otherwise desired adjustment during installation.

Another aspect of the present invention relates to the ability to provide adequate or a desired level of sealing against air and water through any portion of the door assembly. An arrangement of seals is typically required as provided for a door assembly, which arrangement includes specific design challenges when looking at co-mounted doors as described above and which also may arise in single mounted door applications.

As also noted above with reference to FIGS. 10 and 12, sealing material, e.g., foam, plastic, rubber, etc., may be attached or affixed to and along the end surfaces 217A1, 217B1 of the hinge-side and latch-side stops 217A, 217B respectively, as well as the corresponding end surface of the top-side stop, to form a seal between the major surface 212C of the door 212 and such stop surfaces when the door 212 is closed as illustrated in FIG. 10.

FIG. 12 shows, in particular, the latch-side jamb 214B provided with an integrated strike plate 215 having first and second plate sections 215A and 215B connected with one another as a single unit. Plate section 215C connects the plate sections 215A and 215B and partially covers a section of the latch-side stop surface 217B1. If a seal strip were provided continuously along latch-side stop surface 217B1, such a seal would need either to be cut away at the portion covered by plate section 215C or be compressed within a space provided underneath the plate section 215C. In either of these cases, an air/water barrier provided by a continuous seal would be interrupted and thus compromised in the area of the strike plate 215 if such strike plate 215 is provided as an integral unit with plate section 215C. As such, for the purpose of allowing a continuous and effective seal along the latch-side of the door 212, it is preferable in some cases to utilize two separate strike plates with a space between them for the seal to continue uninterrupted along the latch-side stop surface 217B1. In other cases, it is contemplated that an integrated strike plate 215 can be utilized but with a seal accommodation provided to create an effective seal with such an integrated strike plate. Various examples are described below.

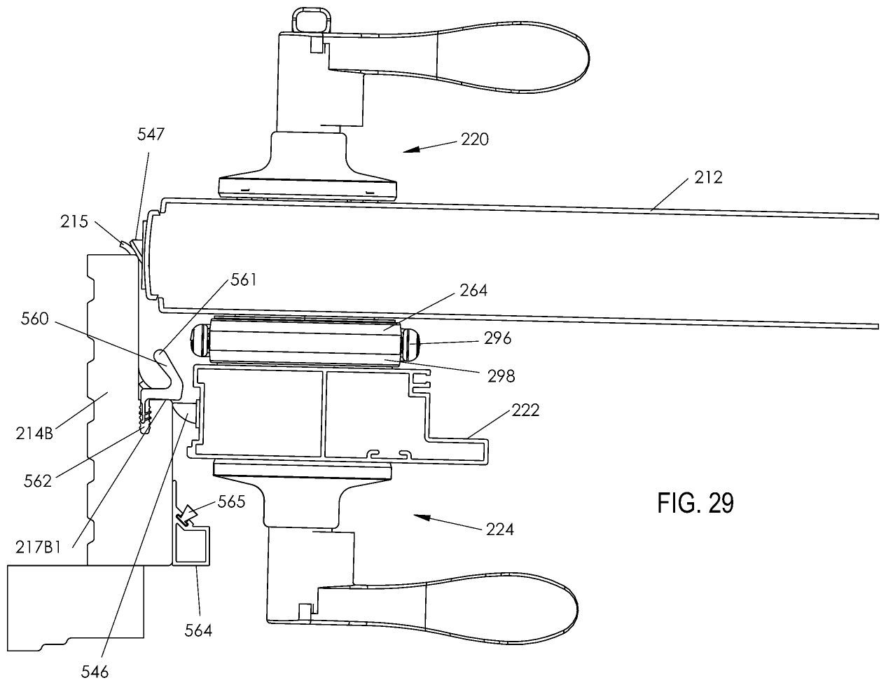

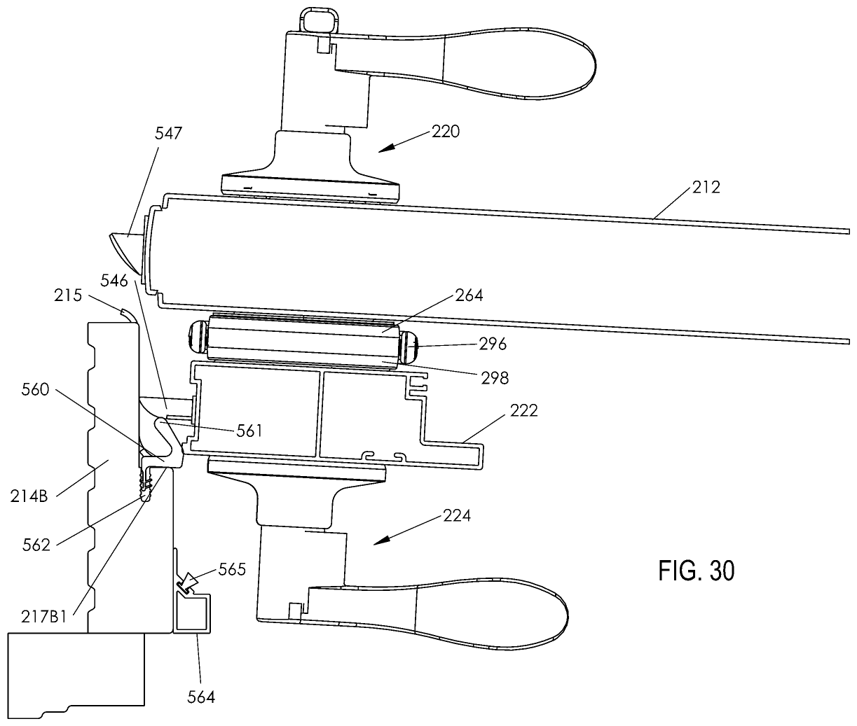

Whether provided as a continuous seal or with a seal accommodation at the strike plate 215 area, there is also an issue with a co-mounted door assembly, as described above, that can result over time from wear to the seal. With reference to FIGS. 29 and 30, an enlarged view of the latch-side of the door assembly is shown as a schematic cross section with a first door 212 provided with the handle assembly 220 and a second door 222 provided with the handle assembly 224. They are shown connected via coupler housings 264 and 298 to be openable and closeable together as described above. Rotation of either handle of handle assemblies 220, 224 can cause retraction of a first door latch tongue 547 and a second door latch tongue 546 so that the doors 212 and 222, respectively, can swing together in the same rotational direction.

When latch tongues 546, 547 are retracted at least sufficiently to disengage from the openings of the latch-side door jamb 214B and to be free of the latch plate(s) 215 the doors 212 and 222 can be swung together during which movement latch tongue 547 can ride along a surface of one strike plate portion (if not fully retracted into the door 212). Likewise, the latch tongue 546 can ride along a surface of a separated strike plate (if not fully retracted into the door 212).

In FIG. 29, a continuous weatherstrip or seal 560 is shown with a portion thereof fixed within a kerf 562 or slot cut that is preferably cut within the latch-side jamb 214B to extend along the latch-side stop surface 217B1. The seal 560 preferably includes a flexible portion 561 that engages with a portion of a major surface side 212C of the door 212 when door 212 is closed to provide an effective air/water seal around door 212. Such a seal 560 would be similarly provided across the top stop surface and the top-side jamb 214C and the hinge-side jamb 214A. The seal 560 is preferably run within the kerf 562 along the latch-side stop surface 217B1 as facilitated by a spacing between separately provided strike plates 215.

With the doors 212 and 222 positioned as shown in FIG. 29, further rotational movement of the doors in the opening rotational direction can cause the latch tongue 546 to ride over a portion of the seal 560 until the latch tongue passes the seal 560, such as shown in the door positions of FIG. 30. During such contact between the end of the latch tongue 546 and a surface of the seal 560, the seal 560 can be caused to deflect or deform in a specific zone of contact, hereinafter a contact zone. This situation is a unique to co-mounted doors because of the multiple latch tongues that must both pass door jamb structure. With it being preferable to effectively provide an air/water seal around each door, passage of an outermore latch tongue can come into contact with such a seal as co-mounted doors are opened together in an opening rotational direction. Even if the door 212 is previously opened fully as decoupled from door 222, the latch tongue 546 of door 222 can still contact the seal 560 when the door 222 is subsequently opened by itself in the same rotational direction in the same manner as described above. In the case of conventional door systems with a primary door and a secondary door, the primary door opens inwardly and the secondary door opens outwardly, so this would not occur. Preferably also, a secondary seal 562 can also be mounted along a secondary structural rail 564 to provide a continuous air/water seal around door 222 on the latch side and is preferably provided with top secondary structure and a seal and hinge side structure and a seal.

In addition to the potential for latch tongue 546 contact with the seal 560 during opening as above, a similar but reverse contact can occur during closing of at least the door 222. FIG. 30 can also represent positions of the doors 212 and 222 during closing with the latch tongue 546 coming into contact or abutment with an edge of the seal 560. The latch tongue 546 can ride as in contact with a surface of the seal 560 until the latch tongue 546 passes the seal 560, which can also be represented by the latch tongue 546 position shown in FIG. 29. As above, if the latch tongue 546 is fully retracted within the frame of the door 222, such contact can be avoided, but it is noted that door closing does not require rotation of either door handle like door opening. The latch tongue 547 from door 212 can ride over the shaped edge of the strike plate 215 during closing as conventionally known.

Repeated door opening and closing over time can wear on the surface of the seal 560 and even abrade the seal 560 over time. Such wear can affect the effectiveness of the seal 560 as providing an air/water seal fully around the door 212. The following examples provide alternatives for creating an effective seal in the strike plate 215 area and in particular to the contact zone where such a latch tongue 546 may contact a continuous seal, if so provided, during opening and closing of the door 222.

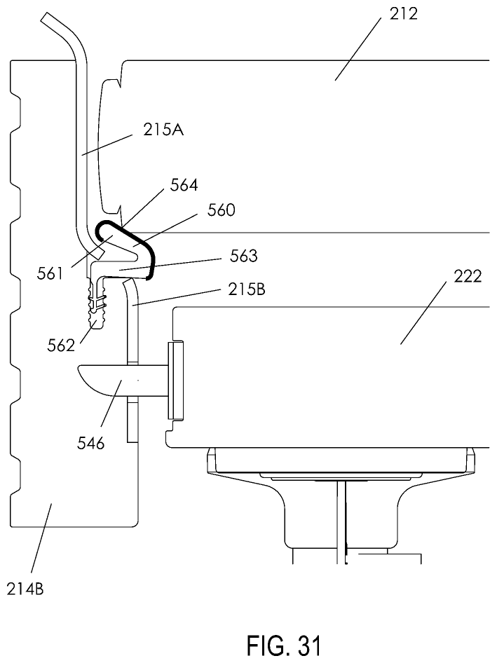

In FIG. 31, latch-sides of the doors 212 and 222 are shown in schematic cross section along with strike plates 215A and 215B as mounted to a latch side door jamb 214B. The latch tongue 546 is shown extended through a hole in strike plate 215B and schematically into an opening of the door jamb 214B. The seal 560 is connected with the latch-side door jamb 214B along the latch-side stop surface 217B1 preferably as a continuous seal extending along the latch-side door jamb 241B to engage a major surface portion along a portion of door 212 to provide an effective air/water seal. Both doors 212 and 222 are illustrated in their closed position with the latch tongue 546 extended. Contact of a surface portion of the door 212 with movable and flexible portion 561 of seal 560 preferably at least partially collapses the flexible portion 561 toward a stationary portion 563 of the seal 560 to provide a positive air/water seal between the door 212 and the latch-side door jamb 214B. FIG. 31 shows the seal 560 as it is situated within a space between strike plates 215A and 215B and within the contact zone of the seal 560 with the latch tongue 546 during movement of door 222.

In this embodiment, the seal 560 is preferably modified along at least a contact surface 564 thereof that the latch tongue 546 could contact with during a door opening or closing as described above. As above, such a seal 560 can comprise foam, plastic, rubber, etc. that is preferably flexible to be compressed structurally and/or as a material, durable to last over a desired time frame, and sufficiently compliant to provide a good air/water seal between the door 212 and latch-side door jamb 214B. Foam materials are preferred in some cases as such materials can include closed or open cells for insulation as well. A modification to a surface of any such material can be to increase durability as such material may be contacted and/or abraded over time. The surface modification is preferably at least provided to the contact surface 564 as defining the contact zone of the seal 560 as from the tip of the flexible portion 561, along the flexible portion 561, and partially along the stationary portion 563. The surface modification can extend over any additional portion or all of the surfaces defining the perimeter of the cross section of the seal 560. Likewise, the surface modification can extend any length along the extension of the seal 560 along the latch-side door jamb 214B.

A surface modification can include a surface treatment that can be done by subjecting the material to certain energies to cure, cross-link, or change any property of the contact surface 564, providing a coating to comprise the contact surface 564, adding a layer as the contact surface 564, or as otherwise known or developed. A coating can be applied by spray, by an applicator, by a liquid bath, or any other coating process known or developed. A layer can be added as an adhesive backed membrane, as an adhesive layer and another layer, any number of multilayers, or otherwise as known or developed. Preferably, the surface modification will increase the durability of the contact surface of the seal 560 within the contact zone. It is contemplated that the surface modification can also include a modification of more than just the contact surface, for example the entire thickness of the seal within the relevant area can be modified and/or made up of a different material than the rest of the seal 560. Any such surface modification will preferably also allow for sufficient flexibility, compressibility, and compliancy as otherwise desired for the flexible portion 561 to flex as needed over time.

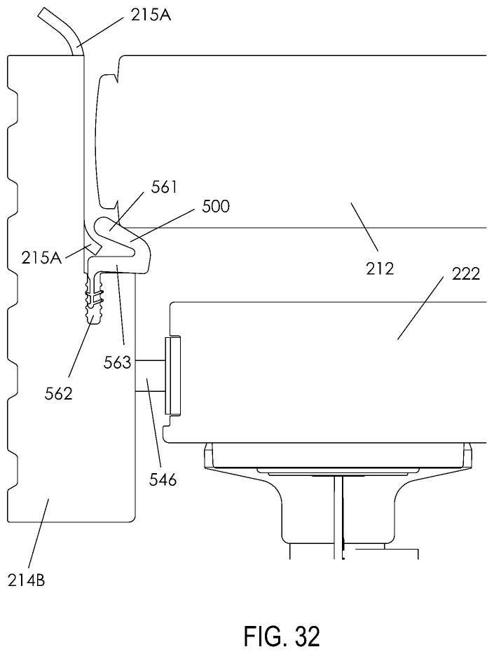

FIG. 32 shows a schematic cross section similar to FIG. 31, but above or below the latch tongue 546 along the latch-side door jamb 214B including the seal 560 as may be provided away from the contact zone. As above, the contact surface 564 can be modified at the contact zone for increased durability where specifically needed, but such modification can be done along any portion or even the entire length of the seal 560. FIG. 26 shows the seal 560 unmodified at an off position from the contact zone of the latch tongue 546 and the seal 560.

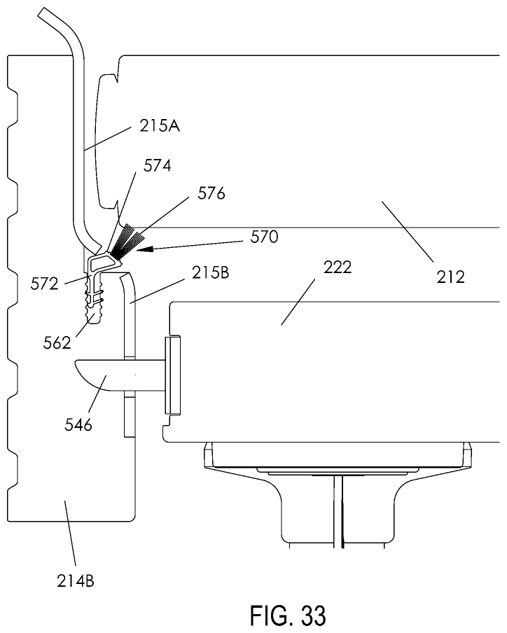

FIG. 33 shows an alternate seal 570 design that can be similarly applied like seal 560 to extend as a continuous seal along the latch-side door jamb 214B. Instead of a seal comprising a flexible portion 561, seal 570 comprises a pile or mohair type seal including brush filaments held together to extend directionally for engagement with a surface portion of the door 212. Specifically, a stationary brush holder portion 572 of the seal 570 fits to be mounted in the kerf 562 as extending along at least a portion of the latch-side door jamb 214B. The brush holder portion 572 is preferably shaped to provide a potting or otherwise supporting bridging surface 574 that not only directionally supports the filaments 576, but also preferably substantially bridges a gap between the opposing edges of the distinct strike plates 215A and 215B. The filaments can fan out from the bridging surface 574 toward door 212 and the bridging surface 574 can provide a surface between the strike plates 215A and 215B along which the latch tongue 546 can ride during door opening or closing as described above. An advantage of this type of seal in this arrangement is the increased flexibility and durability of such filaments as they can also allow easy passage of the latch tongue through and/or over them. It is contemplated that a leaf that extends in the direction of extension of the seal 570 can also be incorporated along with the filaments. A leaf could extend in a similar direction toward door 212, such as in a central location as viewed in cross section with filaments to each side. Such a leaf can provide more of a barrier to air/water passage through the filaments.

Such a pile or mohair type seal 570 can extend the entire extension of the latch-side door jamb 214B as mounted within the kerf 562 or may extend only partially along such extension. According to this embodiment, the seal 570 preferably is provided along at least the portion thereof proximate to the latch tongue's path of travel including at least the contact zone. It is also contemplated that either above, below, or both relative to the seal 570 in the contact zone, a seal such as shown and described above as seal 560 of FIG. 32 can be provided. Such an arrangement would provide increased flexibility and durability where needed to accommodate latch tongue 546 movement while providing a better air/water seal otherwise. If providing a combination of seal 570 in the contact zone and a seal 560 above and below, it is preferable for the seals 570 and 560 to interact or closely contact with one another to provide a continuous seal or at least as continuous as possible a seal effectively between the door 212 and latch-side door jamb 214B. It is contemplated that one or both of the adjacent seal portions could be slightly longer so as to create a slight interference between edges of the seal portions such that one or both edges can be slightly compressed to create a better continuous air/water seal.

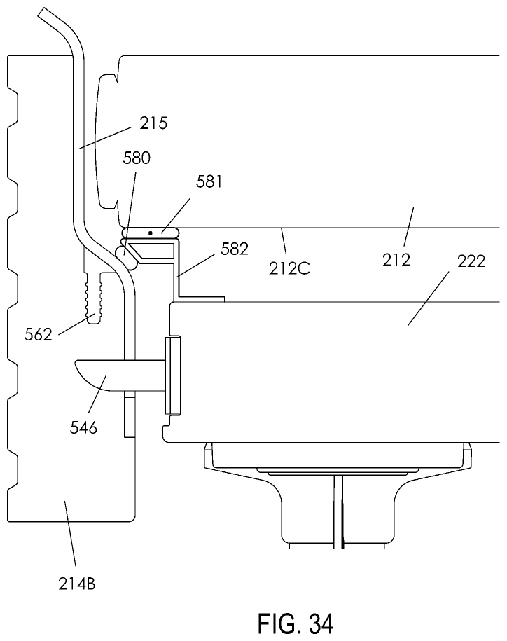

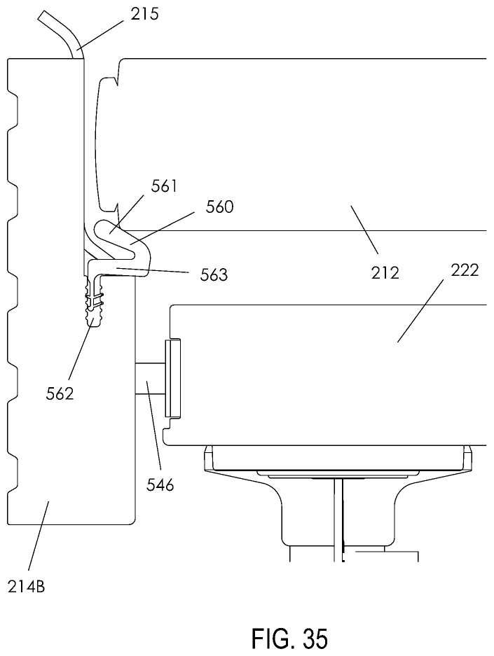

FIG. 34 illustrates an alternative approach for providing an effective seal within a portion of the latch-side door jamb 214B to accommodate passage of the latch tongue 546 during door opening and closing. In this embodiment, a seal 580 can be supported from door 222 by a structural support 582 that is connected with and preferably fixed in position along a door surface portion proximate the latch-side door edge. In this embodiment, an integrated strike plate 215 can be provided and the seal 580 can preferably be supported by the support 582 as both the support 582 and seal 580 extend along the height of the strike plate 215 in the direction of extension of the latch-side door jamb 214B. Preferably also, a second seal 581 can be provided with a similar extension as supported by support 582 to contact with a surface portion of door 212. The seals 580 and 581 preferably extend over a similar distance to one another and that is at least the height of the strike plate 215. Beyond the strike plate above, below, or both, a seal or plurality of seals 560 can extend as shown in FIG. 35. Seal portions of seal 560 can extend from the bottom and top edges of the strike plate 215 and preferably abut or engage with lower and upper edges, respectively, of seal 580 so that as continuous as possible air/water seal is provided. It is contemplated that one or both of the adjacent seal portions could be slightly longer so as to create a slight interference between edges of the seal portions such that one or both edges can be slightly compressed to create a better continuous air/water seal.

The seal arrangement including seal 580 and seal 581 can thus provide an effective air/water seal between the support 582 and the strike plate 215 and the door 212, respectively in the region of the strike plate 215. Note that the kerf 562 can be empty as not supporting a seal in the region of the strike plate 215, but a portion of a seal as may otherwise extend above or below the strike plate 215 can be within such kerf 562 if only a portion of such seal is removed during install. As above, such a portion of the seal 560 can be compressed in a space behind the strike plate 215 instead of being partially or completely removed in that region. It is contemplated that the seal arrangement including seals 580 and 581 can extend entirely along the latch-side door edge or to any lesser extent including at least the extension of the strike plate 215. Structural support 582 preferably includes surfaces to mount and position the seals 580 and 581 as desired for sealing contact. The seal 581 can be mounted to the structural support 582, as above, or can instead be mounted to the surface portion of the door 212 to contact with a surface of the structural support 582. Likewise, the seal 580 could be mounted to the strike plate 215 for contacting a surface of the structural support 582 . . . . The seals 580 and 581 can be of a same of different material and can include any of the materials discussed or suggested above.

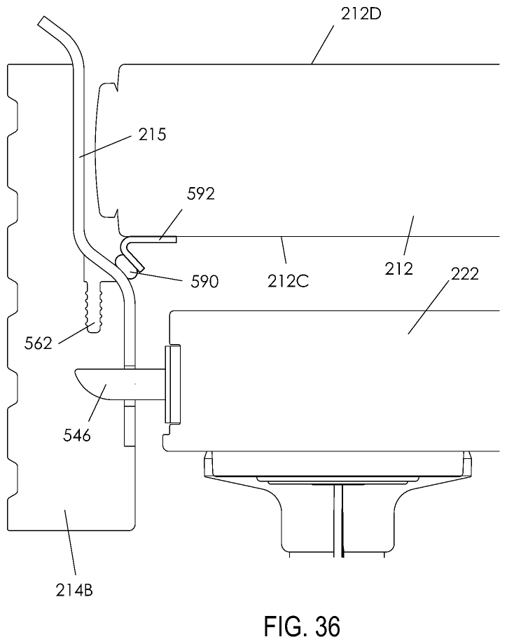

FIG. 36 shows another door-based seal arrangement that can be used to extend along at least a height of a strike plate 215 in the direction of extension of the latch-side door jamb 214B. A seal 590, as can be similar to the seal 580 described above can contact with a surface of the strike plate 215 as such seal is supported by a structural support 592 that is preferably fixedly mounted along at least a portion of the door 212. As with the previous embodiment, the seal arrangement including seal 590 and support 592 can extend any distance along the surface portion of door 212 proximate its latch-side edge. Likewise, a seal like seal 560 as shown in FIG. 35 and described above can be provided below, above, or both relative to seal 590 as extending over the strike plate 215. Also as above, the seal 590 preferably abuts at its top and bottom ends with seal 560 portions to make a continuous air/water seal along the latch-side door jamb 214B. It is contemplated that one or both of the adjacent seal portions could be slightly longer so as to create a slight interference between edges of the seal portions such that one or both edges can be slightly compressed to create a better continuous air/water seal.

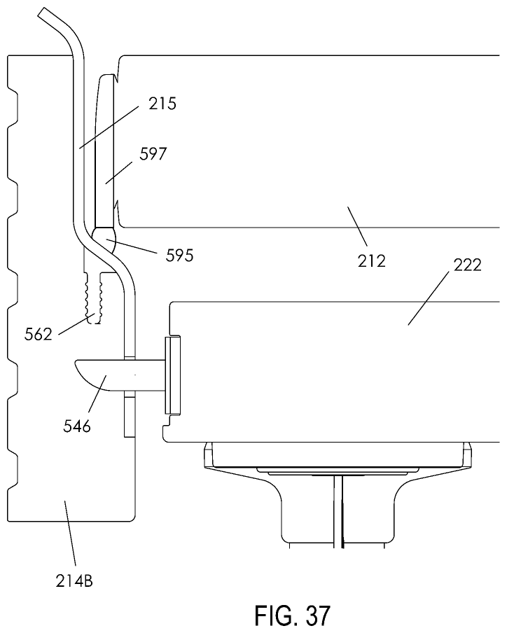

FIG. 37 provides yet another embodiment that is functionally similar to that of FIG. 36, but having a seal 595 that is supported by a structural support 597 that is mounted to and along a latch-side door edge surface of the door 212 instead of to and along a portion of the door major surface proximate to the latch-side door edge. A seal like seal 560 as shown in FIG. 35 and described above can be provided below, above, or both relative to seal 595 as extending over the strike plate 215. Also as above, the seal 595 preferably abuts at its top and bottom ends with seal 560 portions to make a continuous air/water seal along the latch-side door jamb 214B. It is contemplated that one or both of the adjacent seal portions could be slightly longer so as to create a slight interference between edges of the seal portions such that one or both edges can be slightly compressed to create a better continuous air/water seal.

In addition to the latch-side sealing solutions described and suggested above, hinge-side solutions are also contemplated for providing a continuous air/water seal along the hinge-side door jamb 214A with a hinge-side portion of door 212. In this regard, the hinge-side of a co-mounted door assembly provides certain challenges due to the provision of plural (preferably three) hinge assemblies 216 as mounted to the hinge-side door jamb 214A as described above with reference to FIGS. 11, 13, and 14D.

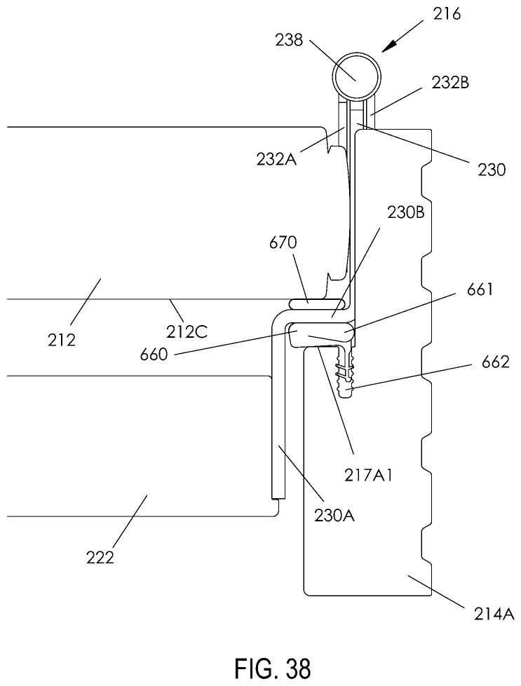

With reference to FIG. 38, one hinge assembly 216 is shown as comprising a first hinge plate 232A that is secured to a hinge-side door edge of door 212. A second hinge plate 230 is secured to a hinge-side door edge of door 222, which hinge plate 230 includes two parallel sections 230A and 230C that are connected by a third perpendicular section 230B as such is described above to fit around door 212 as co-mounted doors. A third hinge plate 232B is secured to a surface of the hinge-side door jamb 214A, also as described above. Each of the hinge plates 232A, 230, and 232B are pivotally connected together by hinge pin 238. In FIG. 38, the doors 212 and 222 are shown in closed positions with doors 212 and 222 limited from further rotation in the closing rotational direction.

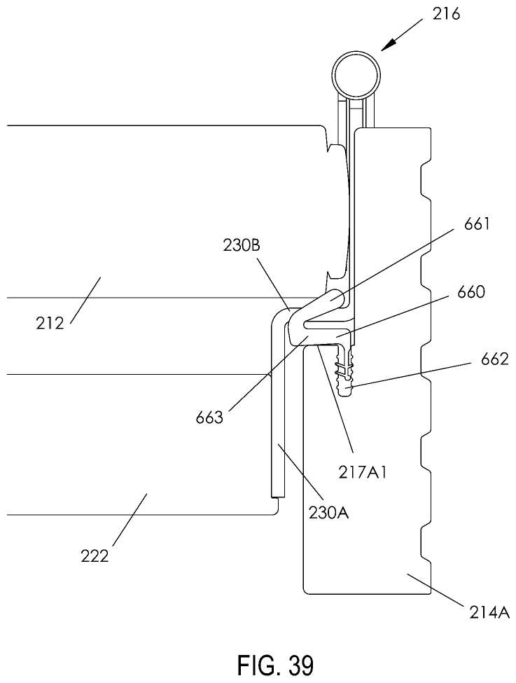

In this arrangement, it is also desirable to provide an effective air/water seal along the hinge-side door jamb 214A. Like on the latch-side door jamb 214B, a kerf 662 can be provided as a continuous slot extending along the hinge-side stop surface 217A1. As shown in FIG. 39, a seal 660 including a flexible portion 661 and a stationary portion 663 can be mounted by way of the kerf 662 to the hinge-side door jamb along the hinge-side stop surface 217A1. The flexible portion 661 can move toward the stationary portion 663 when the door 212 is closed as shown. This provides an effective air/water seal between the door 212 and the hinge-side door jamb 214A.

However, at each of the hinge assemblies 216, as shown in FIG. 38, the perpendicular portion 230B of hinge plate 230 can compress the seal 660 against the hinge-side stop surface 217A1 so that at each hinge assembly 216, the door 212 does not contact and thus create a seal with the hinge-side door jamb 214A. The compression of the seal 660 by the hinge assembly 216 can negatively affect the seal as well for a small degree above and below the hinge assembly 216.

One accommodation to create an effective seal at each hinge assembly 216 is to add a second seal 670 that can be mounted to a side portion of the major surface 212C or to a surface of the perpendicular portion 230B of hinge plate 230 that is facing the door 212. Mounted either way, the seal 670 adds an effective air/water seal in the zone of the hinge assembly 216 by preferably extending entirely along the surface of plate portion 230B in the direction of extension of the seal 660.

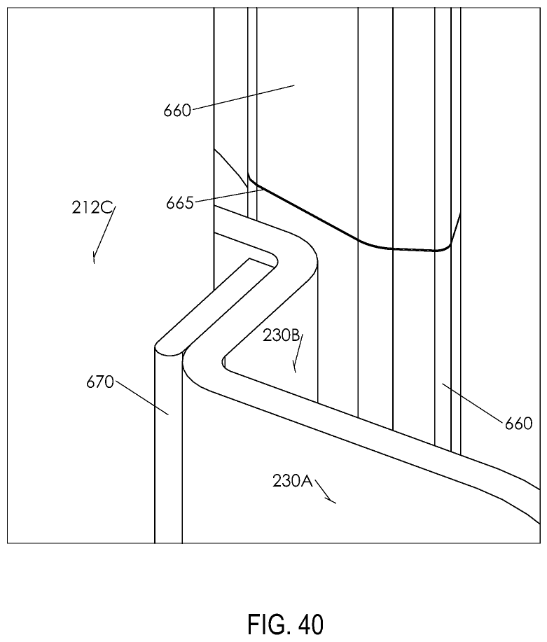

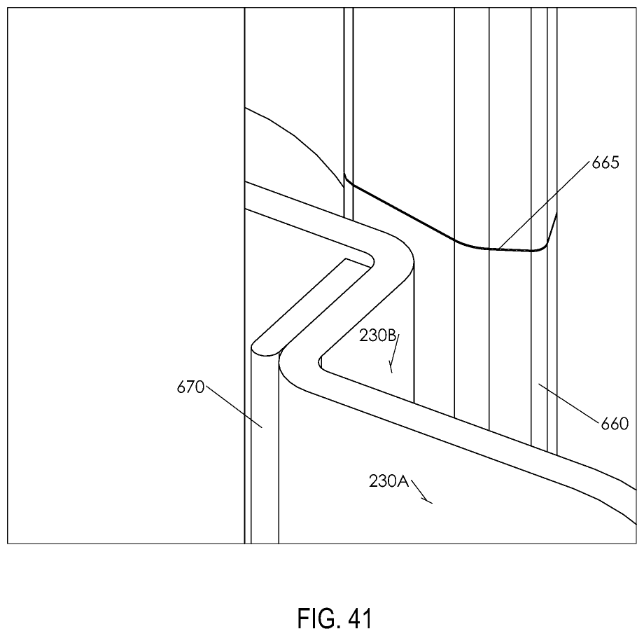

As a further accommodation, it is also preferable to cut the movable portion 661 of the seal 660 at the top and bottom edges of the hinge plate 230 by slits 665, as shown best in FIGS. 40-42. Thus, when the hinge plate 230 is positioned as shown in FIG. 38, the movable flexible portion 661 will be compressed at the engagement surface thereof with the plate portion 230C, but will be free to flex outward without significant restriction to contact with door 212 as shown in FIG. 39. FIG. 39 shows the seal 660 as it provides an air/water seal preferably at any and all locations except where the hinge plates 230 contact the seal 660 and compress the flexible portion 661. Seal 670, as above preferably extends over the extent of the hinge plate 230 height and even preferably slightly longer. If the seal 670 extends slightly longer than the edge of the hinge plate portion 230B at the top and bottom edges thereof, it will slightly interfere with or cause slight compression with cut edges of seal 660 above and below the slits 665 to create a better continuous air/water seal. FIG. 42 shows an upper edge 671 of the seal 670 in engagement with a lower edge 672 of a portion of seal 660 made by the slit 665.

The above description is primarily directed to co-mounted doors as such a door assembly provides unique features that can lead to the need for modified seal arrangements, such as the accommodation of a second latch tongue that passes along a seal in place or the accommodation of a complex hinge structure that can compress a seal undesirably in certain hinge regions. It is also understood that these same concepts discussed above for providing alternative seal arrangements can be applicable as well to single door assemblies, such as a single mounted inswing door. Weatherstrips and seals can be utilized along any number of door edges and can be combined in ways to improve sealing between a door and a door jamb on all sides. It is contemplated that other seal arrangements can lead to situations where one or more specific zones of a continuous seal would need to be interrupted to accommodate other door features or elements.

For example, looking at FIG. 36, it may be desirable to provide a seal along a surface of door 212, which can be provided as a single inswing door, proximate to the inside corner of the door where inside major surface 212D connects with the latch-side door edge. Such a seal can be provided along the latch-side door jamb in a kerf provided near that inside corner similar to seal 560 with an accommodation made for a latch tongue 547 (see FIG. 23) of door 212. A contact zone would be provided similarly as described above where the latch tongue 547 passes by such a seal. In that contact zone, a seal portion could be provided similar to the support 592 and seal 590 combination as mounted to a latch-side portion of the inside major door surface 212D. Such a door could also have a conventional seal along its outside edge as mounted in a kerf along a stop surface of the door jamb.

Looking at FIG. 38, it is contemplated that other door features or elements can be selectively provided to the hinge-side portion of the door major surface 212C similarly as the hinge portion 230B. Such a feature could be fixed to the surface 212C of the door or the side edge thereof. Any such structural feature on a single inswing door could have the same affect on a seal provided similarly as shown in FIGS. 38 and 39. Such a structural feature could come from a decorative element, or a functional element of a different hinge assembly, security feature, or the like.

In another arrangement, a seal might be provided between the door jamb 214A and the hinge-side door edge at a location adjacent to the hinge pin 238. Such a seal could be mounted within a kerf along the door jamb in a conventional manner except for where a hinge plate might be mounted to the door hinge-side edge creating a pinch zone similar to that described above and shown in FIG. 42. In such case, the provision of slits can accommodate the pinch zone which can also be supplemented with a seal strip similar to seal 670.

The following detailed description of another aspect of the present invention of the subject disclosure is different than the inventions of the detailed description and related drawings set out and referred to above. It is understood that similar Fig. numbers and numbers directed to the specific elements of the drawings may include Fig. numbers and element specific numbers that are the same as used in the above description of the subject invention and in the drawings. This section as follows and the related detailed description of the following invention below refer to the specific drawings following FIG. 42 in this application as filed and as discussed briefly just above. When reading the following detailed description, each reference to a specific figure should be read as referring to that number figure along with an X indicating the appended drawings related to the following invention.

This disclosure relates to various embodiments of security features for an inswing door, which door can be a single inswing door or one door of a pair of co-mounted doors. As above, a rotationally “inswing door” means a door that opens about a set of hinges with the hinges mounted to the inside frame portion of a door frame. As used herein, the term “co-mounted” refers to two conventional doors hingedly mounted along a common side of each to a door frame or door jamb of a residential, commercial or other building, such that the doors each open and close along a common side opposite that hingedly coupled to the door frame. The term “linked” as used herein means opposing portions of door handle assemblies mounted to each of the co-mounted doors, i.e., facing door handle assembly portions, are linked or coupled to one another and are held together by any affinity of materials, structural interaction, or attractive force that is sufficient to hold the door handle assemblies and co-mounted doors to one another when subjected to a separation force below a desired threshold level for selective user door separation. The term “field-coupled” as used herein, means opposing portions of door handle assemblies mounted to each of the co-mounted doors, i.e., facing door handle assembly portions, are coupled to one another and are held together by an attractive field, e.g., magnetic field established between magnets carried by each of the handle assembly portions or between at least one magnet carried by one of the handle assembly portions and at least one magnetically attractable structure, e.g., metal composite including one or more ferromagnetic materials, carried by the other handle assembly portion. The term “field coupleable,” as used herein, refers to opposing portions of door handle assemblies mounted to each of the co-mounted doors that are configured to be field-coupled to one another. The term “retaining” or the phrase “securing together field-coupled handle assemblies” and similar such terms and phrases, as used herein, means mechanically creating an interference coupling of the field-coupled door handle assemblies to one another by a retention assembly such that, when so mechanically coupled together, a force required to be applied to one or both of the door handle assemblies and/or to one or both of the doors themselves in order to separate the door handle assemblies (and thus the doors) from one another is greater than the separation force that is required to separate the door handle assemblies from one another when only linked or field-coupled to one another.

Referring now to FIGS. 1A-3B, a portion of a co-mounted door arrangement 10 as an example of an inswing door assembly is shown which includes two conventional doors 12, 14 hingedly mounted to a door frame (not shown). In this regard, U.S. Pat. No. 10,808,438 is hereby incorporated in its entirety by reference, which discloses a hinge assembly that allows co-mounted doors to swing together or apart in an inward rotational direction. Specifically, a first inward door can first swing inwardly followed the second door, or both doors can swing inwardly together. FIG. 8A illustrates co-mounted inswing doors that are together rotated inwardly about hinges to an open position of both doors. The hinge assembly provides for such rotational movements. Mechanisms for selectively connecting or disconnecting the doors are discussed as follows.

As shown, a door handle assembly 15 is mounted to the door 12, and another door handle assembly 21 is mounted to the door 14. As will be described in detail below with respect to FIGS. 6A-20, at least one of the door handle assemblies 15, 21 illustratively include certain security features for one of both doors 12, 14 to withstand a force applied to such door when locked to maintain a closed and locked door position.

The door handle assemblies 15 and 21 can utilize linkage elements 44 and 54 described in detail below that can comprise permanent magnets or electromagnets that are arranged to selectively attract to one another or repel from one another to link or unlink the doors 12 and 14 by way of the door handle assemblies 15 and 21. However, it is contemplated that the linkage elements 44 and 54 can comprise other elements than magnets that can be used similarly at least for linking to one another. For example, certain materials that are known to have levels of affinity to one another and thus can adhere with one another under certain conditions can be used so long as they release upon the application of a desired threshold force. Structural interaction of elements positioned together can be used such as including, for example, hook and loop mechanical fasteners or other micro-replicated structures.

It is also contemplated that in some embodiments no linkage elements need be utilized in addition to the retention assembly structures described herein. The purpose of the linkage elements is to rotationally link one handleset with another handleset so that they rotate together. Each of the retention assemblies and retention components thereof are provided, as described below, so as to maintain one handleset to the other handleset as the doors are moved together. Although the linkage elements would supplement the retention assemblies to prevent separation, they are not necessary for that purpose. Moreover, if rotational translation from one handset to the other handset is accommodated by the retention structure or additional structure at the interfaces of the handle assemblies, the linkage elements can be eliminated. Rotational connection for translation can be facilitated by such a structural component in one or both rotational directions.

The door handle assembly 15 includes a conventional handleset 16 operatively mounted to an inner face 12C of the door 12, a magnet assembly 18 operatively mounted to an outer face 12A of the door 12, and a conventional latch assembly 20 operatively mounted to a side surface 12B of the door 12 defined between the inner and outer faces 12C, 12A thereof. The handleset 16 and the magnet assembly 18 are operatively coupled to one another through a first bore (not shown) defined through the faces 12A, 12C of the door, and the latch assembly 20 is operatively coupled to the handleset 16 and to the magnet assembly 18 through a second bore (not shown) defined in the side surface 12B of the door 12 and intersecting the first bore, all in a conventional manner.

The handleset 16 of the handle assembly 15 includes a conventional lever 16A coupled to a conventional chassis (not shown) which extends into the first bore defined through the faces 12A, 12C of the door 12. The chassis is fixed in position relative to the door 12, and the lever 16A is rotatable relative to the chassis in a conventional manner. The latch assembly 20 includes a latch plate 28 mounted to the side surface 12B of the door 12, and a conventional latch tongue 30 extends through an opening in the latch plate 28. The lever 16A is operatively coupled to the latch assembly 20 via a shaft 48 (see, e.g., FIGS. 4A-4C) which extends through the chassis and the latch assembly 20 and into engagement with the magnet assembly 18 as will be described in greater detail below. Rotation of the lever 16A causes the shaft 48 to rotate which, in turn, causes the latch tongue 30 to retract within and extend from the latch plate 28. The door 12 can be opened when the lever 16A is rotated to retract the latch tongue 30 within the latch plate 28 as depicted by example in FIG. 2, and the door 12 can be closed and secured in the closed position when the lever 16A is rotated (or rotates under bias) to extend the latch tongue 30 from the latch plate 28, as depicted by example in FIG. 1B, so that it can be secured in a conventional manner to a strike plate (not shown) mounted to the door frame. A lock button or protrusion 17 is rotatably mounted to the lever 16A, as illustrated by example in FIGS. 1B-3B, and the lock button 17 is coupled to a locking spindle 49 (see, e.g., FIGS. 4A-4C) which extends through the chassis and the latch assembly 20 and into engagement with the magnet assembly as will be described in greater detail below. The lock button 17 and the locking spindle 49 rotate together relative to the lever 16A and relative to the chassis to which the lever 16A and the lock button 17 are operatively mounted.

The magnet assembly 18 includes a chassis 41 that is viewable from the rear as in FIG. 4C, which is affixed through the bore defined through the faces 12A, 12C of the door 12 to the chassis of the handleset 16 such that neither the chassis 41 nor the chassis of the handleset 16 rotates or otherwise moves with the lever 16A of the handleset 16 or with components carried within the chassis 41. In this regard, a cylindrical magnet housing 42 is positioned within a cylindrical opening of the chassis 41, and the magnet housing 42 is rotatably coupled to the lever 16A of the handleset 16 via the shaft 48 such that the lever 16A, the shaft 48 and the magnet housing 42 all rotate together relative to the door 12 and relative to the components of the handleset 16 affixed to the door 12. A ring portion 40 can be formed integrally with the magnet housing 42 or as a separate component connected to the magnet housing 42. A number of magnets 44 are mounted within openings defined axially through the cylindrical magnet housing 42, and the axial faces of the magnets 44 all define north or south magnetic poles. In the illustrated embodiment, the magnet housing 42 is configured to hold four magnets 44, although in alternate embodiments the magnet housing 42 may be configured to hold more or fewer magnets. In some alternate embodiments, the magnet housing 42 may instead be configured to hold one or more magnetically attractable structures rather than magnets, and in such embodiments the magnet assembly 24 of the door handle assembly 21 will carry one or more magnets which cooperate with the one or more magnetically attractable structures to field-couple the door handle assemblies 15, 21 together. In any case, any such magnet or magnets may be provided purely as (a) structural component(s) and/or as one or more conventional electromagnets.

In any case, the cylindrical magnet housing 42 further defines a central opening axially therethrough sized to receive a generally cylindrical lock receiver 46 therein. The lock receiver 46 is coupled to the lock button 17 of the lever 16A of the handleset 16 via the spindle 49 such that the lock button 17, the spindle 49 and the lock receiver 46 are all rotatable together relative to the lever 16A and relative to the cylindrical magnet assembly 42. Rotation of the lock button 17 causes the spindle 49 to rotate which, in turn, causes the latch assembly 20 to lock such that the latch tongue 30 cannot retract within the latch plate 28. A recessed pocket 46A of the lock receiver 46 is configured to engage a lock button 56 of the door handle assembly 21 (see, e.g., FIGS. 4A-4C) when the door handle assemblies 15, 21 are field-coupled together, such that locking operation of the door handle assembly 15 as just described is likewise carried out in the door handle assembly 21 and vice versa.

The door handle assembly 21 likewise includes a conventional handleset 22 operatively mounted to an outer face 14C of the door 14, a magnet assembly 24 operatively mounted to an inner face 14A of the door 14, and a conventional latch assembly 26 operatively mounted to a side surface 14B of the door 14 defined between the inner and outer faces 14A, 14C thereof. The handleset 22 and the magnet assembly 24 are operatively coupled to one another through a first bore (not shown) defined through the faces 14A, 14C of the door 14, and the latch assembly 26 is operatively coupled to the handleset 22 and to the magnet assembly 24 through a second bore (not shown) defined in the side surface 14B of the door 14 and intersecting the first bore, all in a conventional manner. The handleset 22 likewise includes a conventional lever 22A coupled to a conventional chassis (not shown) which extends into the first bore defined through the faces 14A, 14C of the door 14. The chassis is fixed in position relative to the door 14, and the lever 22A is rotatable relative to the chassis in a conventional manner. The latch assembly 26 includes a latch plate 32 mounted to the side surface 14B of the door 14, and a conventional latch tongue 34 extends through an opening in the latch plate 32. The lever 22A is operatively coupled to the latch assembly 26 via a shaft (not shown) which extends through the chassis and the latch assembly 26 and into engagement with the magnet assembly 24 through an opening 57 in a rear portion 59 of the magnet assembly 24 (see, e.g., FIGS. 4A-4C). Rotation of the lever 22A causes the shaft to rotate which, in turn, causes the latch tongue 34 to retract within and extend from the latch plate 32. The door 14 can be opened when the lever 22A is rotated to retract the latch tongue 34 within the latch plate 32 as depicted by example in FIG. 2, and the door 14 can be closed and secured in the closed position when the lever 22A is rotated (or rotates under bias) to extend the latch tongue 34 from the latch plate 32, as depicted by example in FIGS. 1A and 1B, so that it can be secured in a conventional manner to a strike plate (not shown) mounted to the door frame. A conventional key cylinder 23 is rotatably mounted to the lever 22A, as illustrated by example in FIG. 1A, and the key cylinder 23 is coupled to a locking spindle (not shown) which extends through the chassis and the latch assembly 26 and into engagement with the magnet assembly 24 as will be described in greater detail below. A keyway of the key cylinder 23 and the locking spindle rotate together relative to the lever 22A and relative to the chassis to which the lever 22A and the key cylinder 23 are operatively mounted.

The magnet assembly 24 includes a chassis 51 which is affixed through the bore defined through the faces 14A, 14C of the door 14 to the chassis of the handleset 22 such that nether the chassis 51 nor the chassis of the handleset 22 rotates or otherwise moves with the lever 22A of the handleset 22 or with components carried within the chassis 51. A cylindrical magnet housing 52 is positioned within a cylindrical opening of the chassis 51, and the magnet housing 52 is rotatably coupled to the lever 22A of the handleset 22 via the cam shaft described above such that the lever 22A, the cam shaft and the magnet housing 52 all rotate together relative to the door 14 and relative to the components of the handleset 22 affixed to the door 14. A number of magnets 54 are mounted within openings defined axially through the cylindrical magnet housing 52, and the axial faces of the magnets 54 all define north or south magnetic poles. In the illustrated embodiment, the magnet housing 52 is configured to hold four magnets 54, although in alternate embodiments the magnet housing 52 may be configured to hold more or fewer magnets. In some alternate embodiments, the magnet housing 52 may instead be configured to hold one or more magnetically attractable structures rather than magnets, and in such embodiments the magnet assembly 18 of the door handle assembly 15 will carry one or more magnets which cooperate with the one or more magnetically attractable structures to field-couple the door handle assemblies 15, 21 together.

The cylindrical magnet housing 52 further defines a central opening axially therethrough sized to receive a generally cylindrical lock button or protrusion 56 therethrough. The lock button 56 is coupled to the keyway of the key cylinder 23 of the lever 22A of the handleset 22 via the spindle described above such that the keyway of the key cylinder 23, the spindle and the lock button 56 are all rotatable together relative to the lever 22A and relative to the cylindrical magnet assembly 52. Rotation by a key of the keyway of the key cylinder 23 causes the spindle to rotate which, in turn, causes the latch assembly 26 to lock such that the latch tongue 34 cannot retract within the latch plate 32. The lock button 56 is configured to engage the interior pocket 46A of the lock receiver 46 of the door handle assembly 15 (see, e.g., FIGS. 4A-4C) when the door handle assemblies 15, 21 are field-coupled together, such that locking operation of the door handle assembly 21 as just described is likewise carried out in the door handle assembly 15 and vice versa.

A ring portion 50 is also preferably provided either integrally or as a separate component to rotate with the magnet housing 52. The ring portion 50 is further preferably operative connected to a handle 55. Whereas the ring portion 50 and the handle 55 are operatively connected to rotate together, the handle 55 can be used to rotate the magnet housing 52 and thus open door 14.

In the illustrated embodiment, the door 12 is, for example, a so-called “prime” door which serves as a main entrance door to a building. The face 12C is an “inner” face of the door 12 in that it is the surface of the door 12 that faces the interior of the building, and the face 12A is the “outer” face of the door 12 as it is the surface of the door 12 that faces the exterior of the building. The door 14 is, for example, a so-called storm door mounted to the door frame externally to the door 12 such that the door 14 is exposed to the outdoor environment and the door 12 is positioned between the door 14 and the interior of the building. The face 14A is the “inner” face of the door 14 in that it is the surface of the door 14 that faces the exterior surface of the door 12, and the face 14C is the “outer” face of the door 14 in that it is the surface of the door 14 that faces the exterior of the building to which the doors 12, 14 are mounted. It will be understood, however, that the door arrangement 10 just described is provided only by way of example, and that in alternate embodiments the door 14 may be the prime door and the door 12 may be the storm door. In other alternate embodiments, the “storm” door 14 (or 12) may instead be any other conventional door, examples of which include, but are not limited to, a security door, a screen door, a second prime door or the like. It will be further understood that whereas the attached figures depict one example mounting configuration of the doors 12, 14 as viewed from exterior as in FIG. 1, for example, i.e., left-handed mounting of the door hinges to the door frame and right-handed mounting of the door hardware, the concepts described herein are directly applicable to either left-handed or right-handed mounting of the doors 12, 14 and associated hardware.

The magnet assemblies 18, 24 of the door handle assemblies 15, 21 are mounted to the doors 12, 14 such that the magnets 44 carried by the magnet assembly 18 align with, and are of opposite polarity, than respective ones of the magnets 54 carried by the magnet assembly 24. As the doors 12, 14 are brought together, as illustrated by example in FIG. 2, the opposite-poled magnets 44, 54 magnetically couple to one another such that the magnet assemblies 18, 24, and thus the doors 12, 14, become field-coupled to one another. If one of the levers 16A, 22A of the handlesets 16, 22 is rotated in a direction to open the doors 12, 14, such rotation is transferred through the field-coupled magnet assemblies 18, 24 to rotate the other lever 16A, 22A, thereby causing both latch tongues 30, 34 to retract within their respective latch plates 28, 32 as illustrated by example in FIG. 2. Thus, if the lever 16A is rotated in a direction to open the door 12, such rotation is transferred through the shaft 48 to the cylindrical magnet housing 42 to cause it to rotate relative to the chassis 41. Because the magnets 44 carried by the magnet housing 42 are field-coupled to the magnets 54 carried by the magnet housing 52, rotation of the magnet housing 42 thus causes the magnet housing 52 to rotate in the same direction. Rotation of the magnet housing 52, in turn, causes the cam shaft coupled thereto to rotate in the door opening direction. Such rotation of the camshafts of the door handle assemblies 15, 21, in turn, causes the respective latch tongues 30, 34 to retract within their respective latch plates 28, 32. Rotation of the lever 22A in the direction to open the door 14 is likewise transferred to the handle assembly 15 to similarly cause the respective latch tongues 30, 34 to retract within their respective latch plates 28, 32 so that the doors 12, 14, while field-coupled together, can be together opened and closed. Moreover, while field-coupled together as illustrated by example in FIG. 2, the two door handle assemblies 15, 21 can be together and simultaneously locked and unlocked via actuation of the lock button 17 and/or actuation by a suitable key of the keyway of the key cylinder 23 as described in detail above.

In the illustrated embodiment, the door handle assembly 21 illustratively includes a mechanical stop which prevents rotation thereof in the direction opposite to the opening direction just described, or at least prevents rotation of the handle assembly 21 beyond a selected rotational angle of the handle assembly in the direction opposite to the opening direction. As the door handle assembly 15 is rotated in the direction opposite the opening direction (see, e.g., FIG. 3A) and the mechanical stop of the door handle assembly 21 is engaged, further rotation of the door handle assembly 15 in the same direction causes the faces of the field-coupled magnets 44, 54 to move radially away from one another. At some point, the magnetic fields established between the opposite-poled magnets 44, 54 are reduced by such rotation of the handle assembly 15 to a point at which the magnets 44, 54 are no longer field-coupled to one another and the magnet assemblies 18, 24 disengage from one another so that the doors 12, 14 can be separated from one another as illustrated by example in FIGS. 3A and 3B.

Further details relating to various embodiments of a co-mounted door arrangement of the type illustrated in FIGS. 1-3B and thus far described above can be found in granted U.S. Pat. No. 10,808,438, granted Oct. 20, 2020, which is owned by the applicant of the subject patent application, and which is published as international patent application WO 2017/181072, the disclosures of which are both incorporated herein by reference in their entireties. Other details relating to various embodiments of a co-mounted door arrangement also of the type illustrated in FIGS. 1-3B and thus far described above can be found in co-pending U.S. patent application Ser. No. 17/061,309, filed Oct. 1, 2020, which is owned by the applicant of the subject patent application, the disclosure of which is incorporated herein by reference in its entirety.

As briefly described above, the door handle assemblies 15, 21 illustratively include a retention assembly for further securing together the handle assemblies 15, 21 when field-coupled together as just described. Referring now to FIGS. 4A-5C, an embodiment of such a retention assembly 58 is shown. The retention assembly 58 illustratively includes two components; one component 60 mounted to the magnet assembly 18 of the door handle assembly 15, and another component 70 mounted to the magnet assembly 24 of the door handle assembly 21. As depicted in FIGS. 4A and 4B (FIG. 4A shows the magnet assembly 18 with a cover plate 47 mounted over the outwardly-facing axial face of the cylindrical magnet housing 42, and FIG. 4B shows the magnet assembly 17 with the cover plate 47 removed), the retention assembly component 60 is illustratively provided in the form of a retention clip having a closed end 64 secured to the axial face of the cylindrical magnet housing 42, upper and lower retention legs 62A, 62B each extending laterally away from the closed end 64 and over the recessed pocket 46A of the lock receiver 46, and spring legs 66A, 66B each extending laterally away from a respective one of the retention legs 62A, 62B. The retention clip 60 is illustratively a spring structure with the spring legs 66A, 66B biased toward one another. A spring leg positioning block 68 is attached to the front face of the magnet housing 42 on an opposite side of the lock receiver 46 at which the closed end 64 of the retention clip 60 is secured. The block 68 defines a top surface 68A which supports the spring leg 66A and a bottom surface 68B, opposite the top surface 68A, which supports the spring leg 66B. The spring legs 66A, 66B are biased against the top and bottom surfaces 68A, 68B of the positioning block 68, and the block 68 further operates to position of the retention legs 62A, 62B over and relative to the recessed pocket 46A of the lock receiver 46.

As further depicted by example in FIG. 4C, the retention assembly component 70 is illustratively provided in the form of a frustoconical retention ring having a smaller opening 72A sized to be received on the cylindrical shaft portion 56A of the lock button 56 and a larger opening 72B abutting the magnet housing 52 about the lock button 56. The retention component 70 preferably extends radially outward from the opening 72A to the opening 72B in the shape of a conical portion. A slot 74A is formed in and along a top surface of the retention ring 70, and another slot 74B is formed in and along a bottom surface of the retention ring 70 opposite the slot 74A. The slots 74A, 74B are illustratively oriented to run horizontally relative to a resting position of the magnet assembly 24 (i.e., with the lever 22A of the handleset 22 not being rotated in either direction), as are the retention legs 62A, 62B of the retention clip 60 relative to the resting position of the magnet assembly 18. The slots 74A, 74B are sized to receive a respective one of the retention legs 62A, 62B axially therein.

The retention legs 62A, 62B of the retention clip 60 are illustratively positioned relative to the lock receiver 46 such that the retention leg 62A contacts the retention ring 70 below the slot 74A and the retention leg 62B contacts the retention ring 70 above the slot 74B as the magnet assemblies 18, 24 are brought into contact with one another as the handle assemblies 15, 21 are being field-coupled to one another as described above. As the lock button 56 is forced into the pocket 46A of the lock receiver 46, the retention legs 62A, 62B ride upwardly along the outer, frustoconical surface 75 of the retention ring 70 toward the respective slots 74A, 74B, forcing the release legs 66A, 66B to separate from the top and bottom surfaces 68A, 68B of the positioning block 68 as the outer surface of the retention ring 70 expands the distance between the retention legs 62A, 62B. As the retention legs 62A, 62B are forced higher on the frustoconical outer surface of the retention ring 70, the legs 62A, 62B eventually reach the slots 74A, 74B and are received therein. The bias of the release legs 66A, 66B toward one another forces the retention legs 62A, 62B into the slots 74A, 74B, as illustrated by example in FIG. 5A, to secure the retention clip 60 to the retention ring 70 and thus secure the magnet assembly 18 to the magnet assembly 24. The interaction of the retention legs 62A, 62B within the slots 74A, 74B thus creates a physical interference holding the magnet housing 42 to the magnet housing 52 in an axial direction of the shaft 48. In some embodiments, the forward edges or sides 74A1, 74B1 of the slots 74A, 74B are formed at an acute angle relative to vertical. In such embodiments, the acute angle is illustratively selected so as to normally maintain the retention legs 62A, 62B within the slots 74A, 74B yet allow the retention legs 62A, 62B to exit the slots 74A, 74B if a force greater than a threshold force acts on the handle assemblies 15, 21 in a direction to separate them. Illustratively, the threshold force in such embodiments is selected to be less than that which may damage or break one or more components of the door handle assemblies 15, 21.

In the illustrated embodiment, the retention assembly 58 is configured to secure the field-coupled magnet assemblies 18, 24 together as just described in their at rest states (i.e., with neither lever 16A, 22A rotated in either direction as illustrated in FIGS. 2-3B). When either magnet housing 42, 52 is rotated relative to the respective chassis 41, 51 in a direction which causes the latch tongues 30, 34 to retract within the respective latch plates 28, 32, (i.e., when opening the doors 12, 14 as illustrated in FIG. 2), the magnet housings 18, 24 rotate together as described above and the retention legs 62A, 62B are maintained within the slots 74A, 74B as the retention clip 60 and the retention ring 70 likewise rotate relative to the respective chassis 41, 51, as illustrated by example in FIG. 5B. Conversely, when the magnet housing 42 is rotated in the opposite direction and the magnet housing 52 is prevented from rotating therewith by the mechanical stop of the door handle assembly 21, the retention clip 60 rotates relative to the retention ring 70 and the radial motion of the retention clip 60 relative to the retention ring 70 causes the retention legs 62A, 62B to radially exit the slots 74A, 74B onto the outer surface 75 of the retention ring 70 as illustrated by example in FIG. 5C. This forces the release legs 66A, 66B further away from the top and bottom surfaces 68A, 68B of the positioning block 68 as also illustrated by example in FIG. 5C. The inward bias of the release legs 66A, 66B toward one another forces the retention legs 62A, 62B axially along the outer surface 75 of the retention ring 70 away from the slots 74A, 74B and toward the opening 72A as the inward bias of the release legs 66A, 66B forces the legs 66A, 66B toward one another and thereby separates the retention legs 62A, 62B and thus the retention clip 60 from the retention ring 70. Eventually, the release legs 66A, 66B contact the top and bottom surfaces 68A, 68B of the positioning block 68 which repositions the retention legs 66A, 66B to their pre-contact positions illustrated in FIGS. 4A and 4B.

The following description relates to security features that can be incorporated within the co-mounted door assembly described above or to any one inswing door. These security features described below are intended to increase the strength and security of a closed inswing door in an opposite rotational direction from the inswing rotational direction, an outswing rotational direction. In particular, structural features of the present invention are designed to withstand a force in the outswing direction of the door to prevent the inswing door from being significantly damaged or failing from the application of a force in the outswing rotational direction. Such an outward force may be applied from the inside of the subject inswing door as a pushing force or from the outside of the door as a pulling force. It is desirable that an inswing door of the present invention can withstand an outward force of greater than fifteen hundred pounds, and more preferably greater than two thousand pounds.

For example, with a single inswing door, a pushing force can result from an unexpected or accidental impact on the inside of the door or from an intentional push with the door locked. From outside, a pulling force can be applied while the door is locked where the lock and door are desired to remain locked and to withstand the applied force. With a co-mounted door assembly, such a pushing force from inside of the door can be applied selectively to either one of the two doors, such as when both doors are closed or when an inside door is open and an outside door, such as a storm door, is closed and locked. Likewise, a pulling force can be applied to the outside door when the inside door is closed or open. It is also contemplated that a pushing force can be applied to an outside door of a co-mounted door assembly from a space between the two doors when both closed from within the space by way of any access through either door or another part of the door assembly. An object of the present invention is to increase inswing door security in any of the above noted or suggested arrangements to withstand a force in the outswing direction and to maintain door structural integrity and workability when subject to such a force. When such an inswing door is locked, a further object is to maintain the door in a locked state when subject to such a force.

FIGS. 6A-20 show the incorporation of certain security features into the above described co-mounted door assembly. Specifically, these security features are illustrated and described as they are provided to an outer inswing door 14, which if provided without an inswing inner door 12 would be another example of certain security features provided to a single inswing door. The security features of the present invention increase a door's ability to withstand a force that may be applied to a closed door while in a closed position. For an inswing door, the object is to withstand outward forces to the door when in a closed position. The following security features are described as applicable to an inswing door as that is the case with a co-mounted door. It is understood that each of the features discussed below can also be applied in a reversed orientation of the features and components for added security to an outswing door subject to an inward force against the door when in a closed position.

With reference to FIG. 6A, an inner inswing door 12 is shown positioned in a coupling position with an outer inswing door 14. FIG. 6A is a schematic cross-sectional view in a horizontal plane passing through the centers the door handle assemblies 15 and 21. Specifically, magnet housing 42 of the door handle assembly 15 of the door 12 is shown partially nested within magnet housing 52 of the door handle assembly 21 of door 14. In this position, magnets as described above can be aligned in an attraction manner so that the inner door 12 is magnetically coupled with the outer door 14.

Upon rotation of either handle set 16 or 22, latch tongues 30 and 34 of the inner and outer doors 12 and 14, respectively, can be retracted and the doors 12 and 14 rotationally swung inwardly while they are coupled. Latch tongue 30 in a rest position as illustrated is positioned within a door cavity 80 of a door frame 81, which preferably includes a strike plate 83 (see also FIG. 8B) for added integrity. Latch tongue 34 at rest is similarly positioned within a cavity 82 also of the door frame 81. A strike plate 84 is preferably provided as shown about the cavity 82 for added integrity of the cavity 82.

A structural rail member 86 is also shown as such is secured against the frame 81 to be rigidly fixed thereto and to provide a latch-side stop surface 88, the purpose of which is to provide an outward limiting element to define the extent of door closure. A flexible weatherstrip 90 preferably extends from a channel of the structural rail member 86 and the latch-side stop surface toward the outer door surface for engagement therewith in a closed outer door position. A second flexible weatherstrip 92 is also preferably connected with the door frame 81 so as to extend to contact a surface of the inner door in its closed position. Weatherstrips themselves are well known to be constructed of many different materials for flexibility, resiliency, and to create a seal with the door surfaces. The resilient nature of the weatherstrips 90 and 92 tend to keep the outer door surface portion adjacent the latch-side stop surface 88 slightly away from the latch-side stop surface and to position both the latch tongues 30 and 34 within cavities 80 and 82, respectively, as desired.

FIG. 6B shows an enlarged area of FIG. 6A with outer door 14 in a closed position and with the latch tongue 34 extended within a central portion of the cavity 82 and extending through an opening of the strike plate 84 without obstruction. In this position, rotation of either handle set 16 or 22 can cause retraction of the latch tongues 30 and 34.

Latch tongue 34 is also shown with a notch 94 that can be preferably provided along an axial extent of a portion of the latch tongue 34 that extends from the door 14 side edge with the latch assembly 26 at a rest or non-torqued position. Moreover, the notch 94 is preferably open toward an edge defining the opening in the strike plate 84 in the direction of the outer door 14 closing. FIGS. 8A and 8B illustrate the position of both latch cavities 80 and 82 and strike plates 83 and 84 mounted to the door frame 81. The strike plate 83 includes an opening 95 and the strike plate 84 includes an opening 96. The strike plate 83 is shown secured to the door frame 81 to be rigid therewith. As shown, an edge 97 of the strike plate 84 that defines the opening 96 and that faces the notch 94 of the latch tongue 34 preferably includes a tab 98 extending within the opening 96 away from edge 97. The tab 98 is preferably sized and shaped to fit within the notch 94. As shown in FIGS. 7A and 7AB, notch 94 is preferably sized and shaped by a bottom surface 99 and plural side portions that define the notch 94 within the volume of the latch tongue 34.

The structure described above including the notch 94 and tab 98 can provide a security feature in accordance with the present invention when an outward force is applied to the outer door 14 either directly or indirectly by way of the inner door 12. FIG. 6C illustrates an interaction between the notch 94 and the tab 98 when such an outward force is applied. Whereas the tab 98 is aligned to fit within the notch 94 upon a further closing movement of the outer door 14, such further movement will relatively shift the tab 98 from a non-blocking position (allowing the latch tongue 34 to be freely retracted) to a blocking position at least partially within the depth of the notch 94. Movement of the latch tongue 34 with the door 14 under an outward force cause the shift of the tab 98 within the notch 94. At least a partial capture of the tab 98 within the notch 94 will not only prevent latch tongue retraction, such engagement can prevent further movement of the door 14 relative to the frame 81. A positive stop can also be created by engagement of an edge 100 of the tab 98 with the bottom of the notch 99, although it is not necessary that the edge 100 and tab 98 engage to prevent further movement of the door 14 relative to the frame 81. It is noted that limited movement of the door 14 in the closure direction can be facilitated by collapse, at least in part, by the weatherstrip 90. As also shown in FIG. 6C, a portion of the door side surface can engage with the latch-side stop surface 88 at approximately the same point that the tab surface 100 engages the notch bottom 99 to provide a greater ability for the structure to withstand an outward force.

A similar effectiveness for preventing latch tongue retraction and for limiting movement of the door 14 relative to the frame 81 can be provided by an outward protrusion positioned along the surface of the latch tongue 34 instead of a notch 94. A protrusion could be positioned at a similar location as the notch 94 is shown and can provide a similar surface such as provided by the tip-most inward surface of the notch 94. Such a protrusion would capture the tab 98 by any slight movement of the door 14 under an outward force like in FIG. 6C, except that the tab 98 would be positioned between the protrusion and the side edge of the door 14 thus preventing retraction of the latch tongue 34. The protrusion would extend sufficiently to engage upon such an outward force to the door 14, but to extend and retract without interference during normal extension and retraction of the latch tongue 34 under normal operating conditions.

FIGS. 9A-10B illustrate another embodiment of a security feature as provided to an outer door 14 so as to increase the ability of the door 14 to withstand an outward force and prevent movement of the door 14 relative to the frame 81. Instead of the notch 94 engaging with a tab 98 of the strike plate 84, as described above, a notch 94 of the latch tongue 34, when moved in the direction of door closure such as by an applied outward force, will engage with a tab 198 that can be formed as an extension of a structural rail member 186. FIG. 9C shows the notch 94 moved slightly in the direction of the arrow such that the tab 198 is positioned within the notch 94.

The tab 198 can be created as an integral portion of the rail member 186, which rail member is secured to the door frame 81 to be rigid therewith. The rail member 186 can comprise an extrusion of metal, such as aluminum or steel, with the tab 198 machined to extend from an edge of the extrusion. The tab 198 can be made using other conventional metal fabrication techniques, including being integrated with a metal extrusion, such as by welding. In any case, the tab 198 extends over a side edge portion of the cavity 82 of the door frame 81 to act similarly to the tab 98 of the strike plate 84 described above.

FIGS. 11A-12B illustrate another embodiment of a security feature as provided to an outer door 14 so as to increase the ability of the door 14 to withstand an outward force and prevent movement of the door 14 relative to the frame 81. This embodiment is similar to the FIGS. 9A-10B embodiment described just above, except that a tab 298 is provided relative to the door frame 81 as a separate element. The tab 298 is provided to extend over a side edge portion of the cavity 82 to act similarly as the tab 198 of the rail member 186 or tab 98 of the strike plate 84, as described above.

As shown in FIG. 11A, the rail member 286 can be similar to the rail member 86 of FIG. 6A without the extension portion creating tab 198 of FIG. 9A. The tab 298 can be rigidly fixed in position to the door frame 81 by any number of ways. For example, an end of the tab 298 can be inserted within a recess of the door frame 81 provided within the cavity 82. The tab 298 can have other structural portion(s) that can be used to secure the tab 298 within the cavity 82, such as by screws or other fasteners. The tab 298 can be bonded in position. As shown in FIG. 12, the tab 298 can be fitted behind a portion of the rail member 286. In any case, the tab 298 extends inside of a side edge portion of the cavity 82 of the door frame 81 to act similarly to the tab 98 of the strike plate 84 described above and to the tab 198 of the rail member 186 also described above.

It is contemplated that any manner of creating a tab that is operatively directly or indirectly connected to the door frame 81 can be utilized. Such a tab in the above embodiments should be positioned to provide for engagement with at least a portion of the tab with at least a portion of the notch 94 upon further movement of a closed door subject to a force in the closing direction to limit further movement of the door relative to the door frame 81.

FIGS. 13A-15B illustrate yet another embodiment of a security feature as provided to an outer door 14 so as to increase the ability of the door 14 to withstand an outward force and prevent movement of the door 14 relative to the frame 81. In this embodiment, a latch tongue 334 that is un-notched can be utilized, as shown in FIG. 14B with a strike plate 384 that does not include a tab, such as tab 98, as shown in FIG. 15B. Instead of engagement of a latch tongue notch and tab as in the previous embodiments, an outward force can be withstood by a security feature arranged to act between an external surface of the door 14 and a structural rail member 386.

Specifically, the external surface of the door 14 can be provided with a rib 399 that extends at least partially along the side edge of the door 14 but spaced slightly inward from the side edge. Such a rib 399 can be formed as an integral portion of the door 14 or can be integrated along the door's external surface by other conventional techniques. The rail member 386 preferably includes a channel 387 that can be formed as an extrusion with the rest of the rail member 386 by a flange portion 398 that extends at least partially along the rail member 386. The channel 387 is preferably positioned to open toward the external surface of the door 14 and more specifically to receive the rib 399. As shown in FIG. 13B, the rib 399 can partially extend within the channel 387 when the door 14 is closed and at a rest state. When an outward force is applied to the door 14, the rib 399 will move more so within the channel 387 and may also move slightly away from the door frame 81 as shown by the arrow. Since the door 14 actually moves rotationally about its hinges when such an outward force is applied, such a slight movement away from the door frame 81 will occur as such is exaggerated in FIG. 13C (earlier figures show the arrow with only a vector component of the actual movement). As shown by FIG. 13C engagement of the rib 399 and the flange portion 398 along side surfaces can secure the door 14 with the door frame 81 by way of the rail member 386 that is rigidly secured to the door frame 81.

FIGS. 16A-17B illustrate yet another embodiment of a security feature as provided to an outer door 14 so as to increase the ability of the door 14 to withstand an outward force and prevent movement of the door 14 relative to the frame 81. This embodiment is similar to the FIGS. 13A-15B embodiment described just above as having a security feature arranged to act between an external surface of the door 14 and a structural rail member 486.

Instead of creating a rib to extend at least partially along an external surface of the door 14, a plate 497 can be conventionally secured to a portion of the door's external surface, such as to surround the handle set 22 as shown in FIG. 17B. It is contemplated that such a separately provided element as plate 497 can extend only partially along the side edge of the door 14, and the plate 497 can be rigidly secured to the door 14 by any number of conventional techniques including the use of mechanical fasteners, chemical bonding, welding, or the like. The plate 497 as shown can be provided with a rib 499 extending at least partially along an edge of the plate 497.

The plate 497 is spaced slightly from the side edge of the door 14 so as to at least partially be received by a channel 487 that can be formed with the structural rail member 486 that is rigidly secured to the door frame 81, as above. The channel 487 can extend along the entire length of the rail member 486, such as if formed as an extrusion, but need not. The plate 497 can be positioned in any position along the door side edge so long as it's positioned so that the rib 399 can be received by the channel 487. It is also noted that plural such plates can be used as positioned similarly along the door edge. In any case, the rib 499 can engage with the flange portion 498 under an outward application of a force as shown by the arrow in FIG. 16C from the position shown in FIG. 16B. As above, such movement can include a slight movement of the door 14 away from the frame 81 as a component of rotational movement. Such action will prevent movement of the door 14 relative to the frame 81 for increased security.

FIGS. 18A-19B illustrate yet another embodiment of a security feature as provided to an outer door 14 so as to increase the ability of the door 14 to withstand an outward force and prevent movement of the door 14 relative to the frame 81. This embodiment is similar to the FIGS. 13A-15B embodiment described above and the FIGS. 16A-17B embodiment described just above as having a security feature arranged to act between an external surface of the door 14 and a structural rail member 586.

In this embodiment, a structural rail member 586 can be rigidly fixed to the door frame 81 as above, and can include a flange portion 598 extending at least partially from the rest of the rail member 586. The flange portion 598 can be similar to flange portion 498 described above to create channel 487, but preferably extends further in an inward direction of movement of the door 14. As shown in FIG. 18B, the flange portion 598 preferably aligns with a groove 599 provided to extend at least partially along the side edge of the door 14, but spaced slightly away from the side edge of the door. In the rest position of FIG. 18B, the flange portion may extend partially within the groove 599, but need not. When the door 14 is urged outward by an outward force as shown by the arrow, the flange portion 598 can move into the groove 599 and engage with a surface portion defining the groove 599. As above, such movement may include a slight movement of the door 14 away from the frame 81 as a component of rotational movement. Such action will prevent movement of the door 14 relative to the frame 81 for increased security.

These just above three embodiments are all examples of the use of a combination of ribs, flanges, or extended portions, generically elongate protrusions, with flanges, grooves, or channels, generically elongate recesses in order to create inter-engaging security features of the present invention. Such protrusions and recesses may be applied to any surface of the door including interior and exterior major surfaces as well as to edge surfaces. In any case, at least one of the protrusions or recesses is operatively connected with any surface of the door, while at least one of the other of the protrusions or recesses is operatively connected with the door frame. They are preferably arranged to engage with one another when a door in a closed state withstands a force in the closing direction.

In each of the embodiments described above, a structural rail member provides a latch-side stop surface and defines a closed position of the door. Such a structural rail member could also be provided in the case of an outswing door to define the closed position. The structural rail member can be a distinct component that is secured to the door frame 81 as illustrated in the figures, or it can be a structural portion of the door frame 81 as an integral component.

FIG. 20 illustrates yet another embodiment of a security feature as provided to an outer door 14 so as to increase the ability of the door 14 to withstand an outward force and prevent movement of the door 14 relative to the frame 81. In this case, a structural rail member 686 can be rigidly fixed to the door frame 81 as above. As compared with the illustrations of the previous embodiments, the structural rail member 686 of this embodiment is preferably enlarged in size and shape so as to create an increased surface area of a latch-side stop surface 688 for engagement with an increased surface area portion of the external surface of door 14. Such engagement can be along the entire length of the rail member 686. In any case, an outward force applied to the door 14 can compress the weatherstrip 90 until the portion of the external surface of the door engages the latch-side stop surface 688. The greater the surface area to surface area contact, the greater the ability to withstand such an outward force. It is also contemplated that the structural rail member 686 can include other structural features designed to reinforce its structural integrity when subject to such an outward force. Internal ribs, alternative materials, additional or enhanced fasteners, and the like can be provided for such purpose.

It is also contemplated that another security feature can be independently provided along or in combination with any of the security features described in the various embodiments above. For example, a deadbolt as conventionally known can also be added to the door 14. If the door 14 is a secondary and outer door to door 12 as a primary and inner door, both the inner and outer doors 12 and 14 can include a deadbolt. An example of a deadbolt assembly that can operate with a pair of co-mounted doors is shown and described within U.S. patent application Ser. No. 17/061,169, filed Oct. 1, 2020, the contents of which are entirely incorporated herein by reference.

It is also contemplated that with such a deadbolt assembly alone or in combination with the security features described above, the bolt of the deadbolt of one or both doors can include security features. For example, the bolt can include a notch similar to notch 94, described above, that can engage with a tab of a strike plate or a tab provided by a separate element or as an extension from a structural component.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. Those skilled in the art will recognize that any modifications to one or more of the structures illustrated and described herein for any such alternate embodiment would be a mechanical step in view of the concepts illustrated and described in detail herein.

1. A latch assembly for a closure to be mounted within a side edge of a closure, the latch assembly comprising:
an outer housing having an internal channel that is open from at least one side of the outer housing, the internal channel being at least partially defined by a first guide surface extending in a first direction;
a latch case including a latch tongue to extend from or be at least partially retracted within the latch case, the latch case being sized and shaped to fit within the internal channel of the outer housing and including at least a second guide surface for movement along the first guide surface in the first direction.

2. The latch assembly of claim 1, further comprising a rotatable component that is operatively connected with the latch tongue so that the latch tongue is extended and retracted based on rotation of the rotatable component, wherein the latch case includes a first opening to provide access to the rotatable component for rotation thereof, and the outer housing includes a second opening to provide access to the rotatable component of the latch case when inserted within the outer housing.

3. The latch assembly of claim 2, wherein the latch case and the outer housing each include at least one additional open area that are aligned with one another and that are provided for allowing passage of a fastener component during installation of the latch assembly and for securing the latch case and outer housing in position to one another and to a door.

4. The latch assembly of claim 3, wherein the latch case is adjustably supported within the internal channel of the outer housing along the first direction and at least one of the first and second openings is oversized as compared with a shaped bore of the rotatable component in at least a dimension of the at least one of the first and second openings extending in the first direction to provide a degree of adjustability of the latch case relative to the outer housing in an adjustment direction.

5. The latch assembly of claim 4, wherein the degree of adjustability of the latch case relative to the outer housing is facilitated by a length of at least one of the first and second guide surfaces.

6. The latch assembly of claim 5, wherein plural guide surfaces of the latch case slidingly engage with plural guide surfaces of the outer housing allowing adjustment of the latch case relative to the outer housing in the adjustment direction.

7. The latch assembly of claim 4, wherein the at least one additional opening of at least one of the latch case and the outer housing is also oversized in a dimension as compared to the size needed for passage of the fastener element in the first direction to also provide a degree of adjustability of the latch case relative to the outer housing.

8. The latch assembly of claim 1, further comprising a latch plate fixed with the outer housing for attachment to a side edge of a door for securing the outer housing in place.

9. The latch assembly of claim 1, wherein the first guide surface comprises a slide element provided along an internal surface of the internal cavity extending in the first direction and the second guide surface comprises a guide element extending in the first direction and provided along a surface of the latch case to engage with and slide along the slide of the outer housing for adjustability of the latch case to the outer housing.

10. The latch assembly of claim 3, wherein the at least one additional open area of the outer housing comprises a slot that extends from the second opening of the outer housing.

11. A method of installing a latch assembly to a door within a side opening of the door provided along a door side edge, the method comprising the steps of:
positioning an outer housing at least partially within the side opening of the door, the outer housing having an internal channel that is open from the door side edge, the internal channel being at least partially defined by a first guide surface extending in a first direction
inserting a latch case at least partially within the internal channel of the outer housing, the latch case including a latch tongue to extend from or be at least partially retracted within the latch case, the latch case being sized and shaped to fit within the internal channel of the outer housing and including at least a second guide surface for movement along the first guide surface in the first direction, and
adjusting the position of the latch case relative to the outer housing in the first direction.

12. The method of claim 11, further comprising the steps of inserting at least one fastener component through a first opening provided through the outer housing and a second opening provided through the latch case, and tightening the fastener component after the adjustment step for securing the latch case and outer housing in place to one another.

13. The method of claim 12, further comprising a step of fixedly mounting the outer housing to the door prior to the tightening step.

14. The method of claim 12, wherein the adjusting step also comprises aligning a portion of the latch assembly relative to the door.

15. The method of claim 14, wherein the latch assembly further comprises a rotatable component that is operatively connected with the latch tongue so that the latch tongue is extended and retracted based on rotation of the rotatable component, and further wherein the latch assembly is a part of a handle assembly that is secured to the door by the installation of the latch assembly with the fastener connecting a first door handle component on one side of the door with a second door handle component on the other side of the door, the first door handle component rotatably supporting a first rotatable member and the second door handle component rotatably supporting a second rotatable member, and the first and second door handle components are operatively connected to transfer rotation from one to the other by way of a cam element that passes through a shaped cam bore of the rotatable component within the latch case and through a third opening of the outer housing and an aligned fourth opening of the latch case.

16. The method of claim 15, wherein the first and third openings are oversized as compared to dimensions of the passing fastener component and the cam element to define a range of adjustability of the latch case relative to the outer housing and the adjusting step comprises moving the latch case relative to the outer housing within the range of adjustability while the fastener component and cam element pass through the first, second, third, and fourth openings, respectively, but prior to the tightening step.

17. The method of claim 16, wherein a second handle assembly is also mounted to a second door of a co-mounted door assembly by installing a second latch assembly to the second door, and further comprising a step of moving the second door so as to bring a portion of the second handle assembly into contact with a portion of the first handle assembly thereby causing an alignment of the first and second handle assemblies.

18. The method of claim 17, wherein the second latch assembly is installed to the second door in the manner of the first latch assembly but with the tightening step of the second latch assembly being done prior to the step of aligning the first and second handle assemblies.

19. The method of claim 18, wherein the step of tightening the fastener component for the first latch assembly is done after the aligning step.

20.-52. (canceled)
